(19) United States
(12) Patent Application Publication
(10) Pub. No.: US 2013/0117770 A1
(43) Pub. Date: May 9, 2013

(54) SERVER OPERATIONAL EXPENSES COLLECTING METHOD, AND APPARATUS THEREFOR

(71) Applicants: Toru Mineyama, Kanagawa (JP); Yuki Kimura, Kanagawa (JP)

(72) Inventors: Toru Mineyama, Kanagawa (JP); Yuki Kimura, Kanagawa (JP)

(73) Assignee: Sony Corporation, Tokyo (JP)

(21) Appl. No.: 13/627,300

(22) Filed: Sep. 26, 2012

(30) Foreign Application Priority Data
Oct. 10, 2000 (JP) 2000-309796

(51) Int. Cl. H04N 21/2547; H04N 9/79

(52) U.S. Cl. CPC H04N 21/2547; H04N 9/79
USPC 725/5; 386/297

(57) ABSTRACT

Disclosed are server operational expenses collecting method and apparatus for a server which transmits via the Internet an electronic program guide to a terminal apparatus operated by a user. The server generates customer analysis information on the basis of personal information of said user inputted from said terminal apparatus and program viewing log information about a program viewed by said user on said terminal apparatus. The server generates a second electronic program guide by reorganizing a first electronic program guide in accordance with the preference of said user on the basis of the generated customer analysis information. The server provides said generated customer analysis information to an advertiser who practices an advertising campaign to said terminal apparatus. The server, in response to the provision of said customer analysis information to said advertiser, collects the expenses, in a predetermined amount, for the provision of said customer analysis information from said advertiser.

### BACKGROUND OF THE INVENTION

The present invention relates generally to server operational expenses collecting method and apparatus for collecting the service operational expenses in services for providing via the Internet the program information about programs to be broadcast.

In the digital multichannel broadcasting, programs are provided over several tens to several hundreds of channels. This increases the number of user options while making the program selecting operations by users extremely complicating. To overcome this problem, the digital multichannel broadcasting practices the program information providing services based on EPG (Electronic Program Guide) which provides program guides and information about the contents of each individual program.

The above-mentioned EPG provided by the digital multichannel broadcasting is generated and managed by a DMC (Digital Multi Channel) provider. In addition to the EPG generation and management, the DMC provider integrally performs the management of users of digital multichannel broadcasting, the management of channels to be provided for the users, the advertisement of programs, and so on.

For a user to use a digital multichannel broadcast service, a STB (Set Top Box), which is an customer premises equipment unit for controlling the reception of an EPG and programs, must be connected to the user's television receiver. The STB receives an EPG having schedule information such as channel numbers in which programs are to be broadcast, the names of the channels and programs, and broadcast date, for example, displaying the received EPG on a screen such as the television receiver. The user can operate the STB by means of its controller to perform channel selection and preset viewing for example.

Generally, in using a service based on the digital multichannel broadcasting, the user registers him/herself with the DMC provider and pays a predetermined service fee, upon which the user can receive an EPG and desired channels via the STB.

Meanwhile, services have been proposed in which the above-mentioned digital multichannel broadcast is received by a PC (Personal Computer) having television receiver capabilities. In this case, an EPG can be transmitted via the Internet by use of PC's communication capabilities.

The EPG transmission services via the Internet are supported by a server (hereinafter also referred to as an EPG providing server) which purchases the EPGs provided by a DMC provider, converts each purchased DMC into a format which can be transmitted via the Internet, and performs the user management, the management of channels to be provided for users, and program advertisement, which have hitherto been performed by DMC providers.

This EPG providing server covers its server operating expenses by collecting advertisement charges in accordance with the number of times a user clicks a banner advertisement for example inserted in a program to be broadcast or an EPG or in accordance with the number of times a banner advertisement is exposed, by collecting the money or intermediate margin for independent products or products associated with a program sold on a network, or by collecting the membership registration fees from users at certain intervals.

The EPG providing server which transmits EPGs via the Internet and provides the digital multichannel broadcast programs is capable of providing various new services in addition to those described above in the methods of providing EPGs to users, preset recording of programs, and placing advertisements.

### SUMMARY OF THE INVENTION

It is therefore an object of the present invention to provide server operational expenses collecting method and apparatus for an EPG providing server of making profits to be derived from the service provision by the EPG providing server by use of the Internet.

In carrying out the invention and according to one aspect thereof, there is provided a server operational expenses collecting method for a server which transmits via the Internet an electronic program guide to a terminal apparatus operated by a user, the above-mentioned server generating customer analysis information on the basis of personal information of the user inputted from the terminal apparatus and program viewing log information about a program viewed by the user on the terminal apparatus; generating a second electronic program guide by reorganizing a first electronic program guide in accordance with the preference of the user on the basis of the generated customer analysis information; providing the generated customer analysis information to an advertiser who practices an advertising campaign to the terminal apparatus; and in response to the provision of the customer analysis information to the advertiser, collecting the expenses, in a predetermined amount, for the provision of the customer analysis information from the advertiser.

In carrying out the invention and according to another aspect thereof, there is provided a server operational expenses collecting method for a server which transmits via the Internet an electronic program guide to a terminal apparatus operated by a user, the above-mentioned server generating a second electronic program guide by reorganizing a first electronic program guide in accordance with the preference of the user; generating a third electronic program guide obtained by inserting an advertisement program into the second electronic program guide; in response to a command issued by the user from the terminal apparatus via the Internet, transmitting one of the second electronic program guide and the third electronic program guide; and collecting an advertisement program insertion reject charge in a predetermined amount in accordance with the rejection of inserting the advertisement program from the user who requested the reception of the second electronic program guide.

In carrying out the invention and according to still another aspect thereof, there is provided a server operational expenses collecting method for a server which transmits via the Internet an electronic program guide to a terminal apparatus operated by a user, the above-mentioned server generating a second electronic program guide by reorganizing a first electronic program guide in accordance with the preference of the user; setting preset recording of a program listed in the second electronic program guide to the terminal apparatus via the Internet; and in accordance with the setting of preset recording of the program, collecting preset recording setting expenses in a predetermined amount from the user.

In carrying out the invention and according to yet another aspect thereof, there is provided a server operational expenses collecting method for a server which transmits via the Internet an electronic program guide to a terminal apparatus operated by a user, the above-mentioned server generating a second electronic program guide by reorganizing a first electronic program guide in accordance with the preference of the user; generating a third electronic program guide obtained by inserting an advertisement program into the generated second electronic program guide; in response to a command issued by the user from the terminal apparatus via the Internet, setting preset recording of a program listed in one of the second electronic program guide and the third electronic program guide; and collecting an advertisement program insertion reject charge in a predetermined amount in accordance with the rejection of inserting the advertisement program from the user who requested the setting of preset recording of the program listed in the second electronic program guide.

In carrying out the invention and according to a separate aspect thereof, there is provided a server operational expenses collecting method for a server which transmits via the Internet an electronic program guide to a mobile terminal apparatus operated by a user wherein: the above-mentioned user sets via the Internet the preset recording of a program listed in the electronic program guide from the mobile terminal to a remote terminal apparatus; and the above-mentioned server, in response to the setting of preset recording of the program, collects a predetermined preset recording setting fee from the user.

In carrying out the invention and according to a still separate aspect thereof, there is provided a server operational expenses collecting method for a server which transmits via the Internet an electronic program guide to a mobile terminal apparatus operated by a user, the above-mentioned server generating a second electronic program guide by inserting an advertisement program into a first electronic program guide; in response to a command issued by the user from the mobile terminal apparatus via the Internet, setting the preset recording of a program listed in one of the first electronic program guide and the second electronic program guide to a terminal apparatus; and collecting an advertisement program insertion reject charge in a predetermined amount in accordance with the rejection of inserting the advertisement program from the user who requested the setting of preset recording of the program listed in the first electronic program guide.

In carrying out the invention and according to a yet separate aspect thereof, there is provided a server operational expenses collecting method for a server which transmits via the Internet an electronic program guide to a mobile terminal apparatus operated by a user, the above-mentioned server generating a second electronic program guide by reorganizing a first electronic program guide in accordance with the preference of the user; generating a third electronic program guide by inserting an advertisement program into the generated second electronic program guide; in response to a command issued by the user from the mobile terminal apparatus via the Internet, setting the preset recording of a program listed in one of the second electronic program guide and the third electronic program guide to a terminal apparatus; and collecting an advertisement program insertion reject charge in a predetermined amount in accordance with the rejection of inserting the advertisement program from the user who requested the setting of preset recording of the program listed in the second electronic program guide.

In carrying out the invention and according to a different aspect thereof, there is provided a server operational expenses collecting method for a server which transmits via the Internet an electronic program guide to a terminal apparatus operated by a user, the above-mentioned server, in response to displaying an address indicative of a location on the Internet of program-associated information, which is information associated with a program listed in the electronic program guide, collecting a predetermined address placement fee from an advertiser who provides the program-associated information and practices an advertisement campaign to the terminal apparatus.

In carrying out the invention and according to a still different aspect thereof, there is provided a server operational expenses collecting apparatus for a server which transmits via the Internet an electronic program guide to a terminal apparatus operated by a user, the above-mentioned server generating customer analysis information on the basis of personal information of the user inputted from the terminal apparatus and program viewing log information about a program viewed by the user on the terminal apparatus; generating a second electronic program guide by reorganizing a first electronic program guide in accordance with the preference of the user on the basis of the generated customer analysis information; providing the generated customer analysis information to an advertiser who practices an advertising campaign to the terminal apparatus; and in response to the provision of the customer analysis information to the advertiser, collecting the expenses, in a predetermined amount, for the provision of the customer analysis information from the advertiser.

In carrying out the invention and according to a yet different aspect thereof, there is provided a server operational expenses collecting apparatus for a server which transmits via the Internet an electronic program guide to a terminal apparatus operated by a user, the above-mentioned server generating a second electronic program guide by reorganizing a first electronic program guide in accordance with the preference of the user; generating a third electronic program guide obtained by inserting an advertisement program into the second electronic program guide; in response to a command issued by the user from the terminal apparatus via the Internet, transmitting one of the second electronic program guide and the third electronic program guide; and collecting an advertisement program insertion reject charge in a predetermined amount in accordance with the rejection of inserting the advertisement program from the user who requested the reception of the second electronic program guide.

In carrying out the invention and according to another aspect thereof, there is provided a server operational expenses collecting apparatus for a server which transmits via the Internet an electronic program guide to a terminal apparatus operated by a user, the above-mentioned server generating a second electronic program guide by reorganizing a first electronic program guide in accordance with the preference of the user; setting preset recording of a program listed in the second electronic program guide to the terminal apparatus via the Internet; and in accordance with the setting of preset recording of the program, collecting preset recording setting expenses in a predetermined amount from the user.

In carrying out the invention and according to still another aspect thereof, there is provided a server operational expenses collecting apparatus for a server which transmits via the Internet an electronic program guide to a terminal apparatus operated by a user, the above-mentioned server generating a second electronic program guide by reorganizing a first electronic program guide in accordance with the preference of the user; generating a third electronic program guide obtained by inserting an advertisement program into the generated second electronic program guide; in response to a command issued by the user from the terminal apparatus via the Internet, setting preset recording of a program listed in one of the second electronic program guide and the third electronic program guide; and collecting an advertisement program insertion reject charge in a predetermined amount in accordance with the rejection of inserting the advertisement program from the user who requested the setting of preset recording of the program listed in the second electronic program guide.

In carrying out the invention and according to yet another aspect thereof, there is provided a server operational expenses collecting apparatus for a server which transmits via the Internet an electronic program guide to a mobile terminal apparatus operated by a user wherein: the above-mentioned user sets via the Internet the preset recording of a program listed in the electronic program guide from the mobile terminal to a remote terminal apparatus; and the above-mentioned server, in response to the setting of preset recording of the program, collects a predetermined preset recording setting fee from the user.

In carrying out the invention and according to a separate aspect thereof, there is provided a server operational expenses collecting apparatus for a server which transmits via the Internet an electronic program guide to a mobile terminal apparatus operated by a user, the above-mentioned server generating a second electronic program guide by inserting an advertisement program into a first electronic program guide; in response to a command issued by the user from the mobile terminal apparatus via the Internet, setting the preset recording a program listed in one of the first electronic program guide and the second electronic program guide to a terminal apparatus; and collecting an advertisement program insertion reject charge in a predetermined amount in accordance with the rejection of inserting the advertisement program from the user who requested the setting of preset recording of the program listed in the first electronic program guide.

In carrying out the invention and according to a still separate aspect thereof, there is provided a server operational expenses collecting apparatus for a server which transmits via the Internet an electronic program guide to a mobile terminal apparatus operated by a user, the above-mentioned server generating a second electronic program guide by reorganizing a first electronic program guide in accordance with the preference of the user; generating a third electronic program guide by inserting an advertisement program into the generated second electronic program guide; in response to a command issued by the user from the mobile terminal apparatus via the Internet, setting the preset recording of a program listed in one of the second electronic program guide and the third electronic program guide to a terminal apparatus; and collecting an advertisement program insertion reject charge in a predetermined amount in accordance with the rejection of inserting the advertisement program from the user who requested the setting of preset recording of the program listed in the second electronic program guide.

In carrying out the invention and according to yet separate aspect thereof, there is provided a server operational expenses collecting apparatus for a server which transmits via the Internet an electronic program guide to a terminal apparatus operated by a user, the above-mentioned server, in response to displaying an address indicative of a location on the Internet of program-associated information, which is information associated with a program listed in the electronic program guide, collecting a predetermined address placement fee from an advertiser who provides the program-associated information and practices an advertisement campaign to the terminal apparatus.

### BRIEF DESCRIPTION OF THE DRAWINGS

These and other objects of the invention will be seen by reference to the description, taken in connection with the accompanying drawings, in which:

FIG. 1 is a schematic diagram illustrating an exemplary configuration of a program service providing apparatus practiced as one embodiment of the invention;

FIG. 2 is a schematic diagram illustrating an exemplary configuration of a virtual program guide providing system practiced as one embodiment of the invention;

FIG. 3 illustrates program viewing tendency information in the above-mentioned virtual program guide providing system;

FIG. 4 is a first flowchart describing a virtual program guide generating operation in the above-mentioned virtual program guide providing system;

FIG. 5 is a second flowchart describing the above-mentioned virtual program guide generating operation;

FIG. 6 is a third flowchart describing the above-mentioned virtual program guide generating operation;

FIG. 7 is a fourth flowchart describing the above-mentioned virtual program guide generating operation;

FIG. 8 is a fifth flowchart describing the above-mentioned virtual program guide generating operation;

FIG. 9 is a sixth flowchart describing the above-mentioned virtual program guide generating operation;

FIG. 10 is a seventh flowchart describing the above-mentioned virtual program guide generating operation;

FIG. 11 is an eighth flowchart describing the above-mentioned virtual program guide generating operation;

FIG. 12 is a ninth flowchart describing the above-mentioned virtual program guide generating operation;

FIG. 13 illustrates a process of arranging program information on a virtual program guide in the above-mentioned virtual program guide providing system;

FIG. 14 illustrates another process of arranging program information on the virtual program guide in the above-mentioned virtual program guide providing system;

FIG. 15 illustrates still another process of arranging program information on the virtual program guide in the above-mentioned virtual program guide providing system;

FIG. 16 illustrates yet another process of arranging program information on the virtual program guide in the above-mentioned virtual program guide providing system;

FIG. 17 illustrates a different process of arranging program information on the virtual program guide in the above-mentioned virtual program guide providing system;

FIG. 18 illustrates the virtual program guide generated in the above-mentioned virtual program guide providing system;

FIG. 19 is a schematic diagram illustrating an exemplary configuration of a program recording system practiced as one embodiment of the invention;

FIG. 20 is a flowchart describing a program preset recording script in the above-mentioned program recording system;

FIG. 21 illustrates a program guide for ordinary channels in the above-mentioned program recording system;

FIG. 22 illustrates one example of how to cancel programs organized in virtual channels in the above-mentioned program recording system;

FIG. 23 illustrates one example of how to organize programs organized in ordinary channels into virtual channels in the above-mentioned program recording system;

FIG. 24 illustrates a program guide listing preference channels in the above-mentioned program recording system;

FIG. 25 illustrates one example of how to select a recording apparatus on which programs are to be recorded in the above-mentioned program recording system;

FIG. 26 illustrates one example of a script of program preset recording by program in the above-mentioned program recording system;

FIG. 27 illustrates one example of a script of program preset recording on a bulk basis in the above-mentioned program recording system;

FIG. 28 is a schematic diagram illustrating an exemplary configuration of a program preset recording system practiced as a first embodiment of the invention;

FIG. 29 is a first flowchart describing a program preset recording script generating operation in the above-mentioned program preset recording system;

FIG. 30 is a second flowchart describing the above-mentioned program preset recording script generating operation;

FIG. 31 illustrates a program guide which is provided to a mobile terminal apparatus via a Web browser in the above-mentioned program preset recording system;

FIG. 32 illustrates an exemplary screen for preset recording confirmation which is presented to the mobile terminal apparatus via the Web browser in the above-mentioned program preset recording system;

FIG. 33 illustrates an exemplary screen for selecting a recording apparatus on which a program to be presented to the mobile terminal apparatus via the Web browser is recorded in the above-mentioned program preset recording system;

FIG. 34 illustrates one example of how an icon of a recording apparatus selected for preset recording is displayed in a program guide which is presented to the mobile terminal apparatus via the Web browser in the above-mentioned program preset recording system;

FIG. 35 illustrates an exemplary screen for selecting a program of which preset recording setting is to be canceled from among programs preset for recording which are to be presented to the mobile terminal apparatus via the Web browser in the above-mentioned program preset recording system;

FIG. 36 is a third flowchart describing the above-mentioned program preset recording script generating operation in the above-mentioned program preset recording system;

FIG. 37 illustrates an exemplary electronic mail message attached with a URL for program preset recording setting, the URL being transmitted from a program information providing apparatus to a mobile terminal apparatus, in the above-mentioned program preset recording-system;

FIG. 38 illustrates an exemplary electronic mail message attached with a URL for moving to a mode for canceling program preset recording setting, the URL being transmitted from the program information providing apparatus to the mobile terminal apparatus, in the above-mentioned program preset recording system;

FIG. 39 is a fourth flowchart describing the above-mentioned program preset recording script generating operation;

FIG. 40 illustrates an exemplary electronic mail message attached with a URL for moving to a mode for changing recording apparatuses on which programs are to be recorded, the URL being transmitted from the program information providing apparatus to the mobile terminal apparatus, in the above-mentioned program preset recording system;

FIG. 41 illustrates an exemplary electronic mail message attached with a URL for selecting a program for which its recording apparatus is to be changed, the URL being transmitted from the program information providing apparatus to the mobile terminal apparatus, in the above-mentioned program preset recording system;

FIG. 42 illustrates an exemplary electronic mail message attached with a URL for changing recording apparatuses on which a program is to be recorded, the URL being transmitted from the program information providing apparatus to the mobile terminal apparatus, in the above-mentioned program preset recording system;

FIG. 43 illustrates an exemplary electronic mail message attached with a URL for moving to a mode for canceling program preset recording setting, the URL being transmitted from the program information providing apparatus to the mobile terminal apparatus, in the above-mentioned program preset recording system;

FIG. 44 illustrates an exemplary electronic mail message attached with a URL for selecting a program of which preset recording setting is to be canceled, the URL being transmitted from the program information providing apparatus to the mobile terminal apparatus, in the above-mentioned program preset recording system;

FIG. 45 illustrates an exemplary electronic mail message for telling that the preset recording setting has been canceled, the mail message being transmitted from the program information providing apparatus to the mobile terminal apparatus in the above-mentioned program preset recording system;

FIG. 46 is a schematic diagram illustrating a program preset recording system practiced as a second embodiment of the invention;

FIG. 47 is a flowchart describing an electronic mail message transmission operation from a server apparatus to a mobile terminal apparatus in the above-mentioned program preset recording system;

FIG. 48 illustrates an exemplary electronic mail message received at the mobile terminal apparatus in the above-mentioned program preset recording system;

FIG. 49 is a flowchart describing an operation of inputting a password from the mobile terminal apparatus in the above-mentioned program preset recording system;

FIG. 50 illustrates a password input prompting screen shown on the display section of the mobile terminal apparatus in the above-mentioned program preset recording system;

FIG. 51 is a flowchart describing an operation in which a server apparatus 120 authenticates a password inputted in the mobile terminal apparatus in the above-mentioned program preset recording system;

FIG. 52 illustrates a menu selection screen shown on the display section of the mobile terminal apparatus in the above-mentioned program preset recording system;

FIG. 53 is a flowchart describing an operation to be performed by the server apparatus when executing a menu selected by the mobile terminal apparatus in the above-mentioned program preset recording system;

FIG. 54 illustrates an exemplary program guide to be shown on the display section of the mobile terminal apparatus in the above-mentioned program preset recording system;

FIG. 55 illustrates an exemplary program guide to be shown on the display section of the mobile terminal apparatus in the above-mentioned program preset recording system;

FIG. 56 illustrates an exemplary program guide to be shown on the display section of the mobile terminal apparatus in the above-mentioned program preset recording system;

FIG. 57 illustrates an exemplary screen to be shown on the mobile terminal apparatus when determining the setting of program preset recording in the above-mentioned program preset recording system;

FIG. 58 illustrates an exemplary list of programs which are set for preset recording, the list being shown on the display section of the mobile terminal apparatus in the above-mentioned program preset recording system;

FIG. 59 illustrates an exemplary screen to be shown on the display section of the mobile terminal apparatus when canceling the setting of program preset recording in the above-mentioned program preset recording system;

FIG. 60 is a flowchart describing an operation of the server apparatus when generating an operation script in the above-mentioned program preset recording system;

FIG. 61 is a first flowchart describing an operation of the mobile terminal apparatus to be executed when downloading the operation script generated by the server apparatus in the above-mentioned program preset recording system;

FIG. 62 is a second flowchart describing the operation of the mobile terminal apparatus to be executed when downloading the operation script generated by the server apparatus in the above-mentioned program preset recording system;

FIG. 63 illustrates the operation script generated by the server apparatus in the above-mentioned program preset recording system;

FIG. 64 illustrates the operation script generated by the server apparatus in the above-mentioned program preset recording system;

FIG. 65 is a third flowchart describing the operation of the mobile terminal apparatus to be executed when downloading the operation script generated by the server apparatus in the above-mentioned program preset recording system;

FIG. 66 is a flowchart describing an operation of the server apparatus to be executed when receiving a result of the downloading of the operation script transmitted from the mobile terminal apparatus in the above-mentioned program preset recording system;

FIG. 67 is a flowchart describing an operation of the server apparatus to be executed when receiving the information about a program preset for recording, the information being transmitted from the mobile terminal apparatus, in the above-mentioned program preset recording system;

FIG. 68 is a flowchart describing an operation of the server apparatus to be executed when receiving the information about a program recorded to a recording medium, the information being transmitted from the mobile terminal apparatus, in the above-mentioned program preset recording system;

FIG. 69 is a schematic diagram illustrating an exemplary configuration of a program-associated information providing system practiced as one embodiment of the invention;

FIG. 70 illustrates an exemplary program preset recording script transmitted from a program-associated information providing apparatus in the above-mentioned program associated-information providing system;

FIG. 71 is a flowchart describing operations of presetting the recording of a program, recording the program, and reproducing the recorded program in the above-mentioned program-associated information providing system;

FIG. 72 is a flowchart describing an operation of displaying a program-associated information URL in the above-mentioned program-associated information providing system;

FIG. 73 is a flowchart describing an operation of displaying a program-associated information URL in the above-mentioned program-associated information providing system; and

FIG. 74 is a schematic diagram illustrating an exemplary configuration of the above-mentioned program-associated information providing system with a mobile terminal apparatus added.

### DETAILED DESCRIPTION OF PREFERRED EMBODIMENTS

This invention will be described in further detail by way of example with reference to the accompanying drawings.

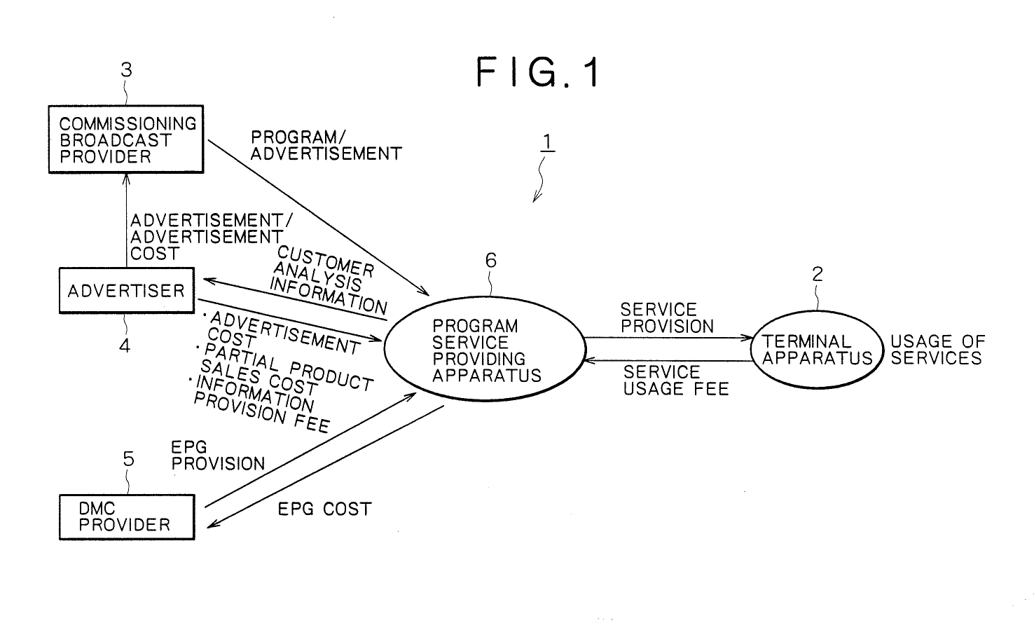

The present invention is applied to a program service providing system 1 as shown in FIG. 1.

The program service providing system 1 comprises a terminal apparatus (operated by a user) 2, a commissioning broadcast provider 3, an advertiser 4, a DMC (Digital Multi Channel) provider 5, and a program service providing apparatus 6.

The terminal apparatus 2 is a PC (Personal Computer) for example operated by the user and has a display section, not shown, for displaying text information and image information and an input section through which the user inputs predetermined text information and commands for example. The terminal apparatus 2 is also connected to a network to transfer/receive information with the outside via the network.

The terminal apparatus 2 also receives service information from the program service providing apparatus 6 and pays a service usage charge for the usage of the received service information to the program service providing apparatus 6 via the network.

It should be noted that the terminal apparatus 2 has different configurations depending on the services provided by the program service providing apparatus 6, which will be described later with detail. It should also be noted that, in the following descriptions, the terminal apparatus 2 has different configurations for different services and the terminal apparatus 2 has all of these configurations.

The commissioning broadcast provider 3 creates programs to be provided to the user via the terminal apparatus 2 and commissions the created programs to contract broadcast providers. The commissioning broadcast provider 3 creates the programs by the advertisement costs paid by the advertiser 4 and inserts an advertisement desired by the advertiser 4 into a predetermined time zone during the broadcasting of a created program. Also, during the broadcasting of a program, the commissioning broadcast provider 3 may use a product which the advertiser 4 wants to advertise. For example, if a program is a drama, products to be advertised may be presented as properties, settings, or costumes.

The advertiser 4 produces, sells, or mediates products which the advertiser 4 wants to provide to the user via the terminal apparatus 2, advertising these products via the programs created by the commissioning broadcast provider 3. The advertiser 4 provides the advertisement costs to the commissioning broadcast provider 3 in compensation for the insertion of the advertisements in programs.

The DMC provider 5 totally administers the broadcasting of the programs created by the commissioning broadcast provider 3, the advertisements to be inserted in the programs, and broadcast time management. In order to totally manage the programs created by the commissioning broadcast provider 3, the DMC provider 5 generates an EPG (Electronic Program Guide). The DMC provider 5 provides the generated EPG to the program service providing apparatus 6 for a predetermined amount of money.

The program service providing apparatus 6 pays the predetermined amount of money to the DMC provider 5 to get the EPG. The program service providing apparatus 6 provides the following services to the user by use of the provided EPG.

The services to be provided by the program service providing apparatus 6 include a service for reorganizing the services based on the EPG generated by the DMC provider 5 into a more user-friendly, virtual program guide (this server will be hereinafter referred to as a service using a virtual program guide), a service for setting the preset recording of programs from a remote terminal apparatus to a predetermined terminal apparatus (this service will be hereinafter referred to as a remote preset recording service), and a service for providing the program-associated information which is associated with the programs provided by the commissioning broadcast provider 3 (this service will be hereinafter referred to as a service associated with program-associated information). These services are provided to the user at the terminal apparatus 2 via the network.

At the same time, the program service providing apparatus 6 collects the service usage charges from the user in accordance with the services provided to the user. The profits obtained by the use of the program service providing system 1 by the advertiser 4 are partially returned to the program service providing apparatus 6. These profits include those which are made due to the increase in the sale of advertised products, for example.

The following describes the details of the services to be provided to the user at the terminal apparatus 2 by the program service providing apparatus 6 and methods of collecting the profits incurred from the provision of the services by the program service providing apparatus 6.

First, a method of profits collection in the service using a virtual program guide.

The following describes a virtual channel and a virtual program guide.

In television broadcasting, every program is carried on a radio having a predetermined frequency band transmitted from a ground broadcast station, a BS (Broadcasting Satellite), or a CS (Communications Satellite). Each frequency band is numbered for identification, which provides an ordinary channel.

On the other hand, a virtual channel, which is not presented by a number assigned to a particular real frequency band, is obtained by selecting programs broadcast in an ordinary channel on the basis of user preference and arranging the selected programs with predetermined rules, thereby making each program appear as if it were being broadcast in a particular ordinary channel. In other words, a virtual channel is capable of taking all the frequency bands that an ordinary channel has, thereby apparently changing frequency bands for different programs.

A virtual program guide is a list of programs organized into virtual channels as arranged in a time-dependent manner for each virtual channel to visually present the time and channel of the broadcasting to the user.

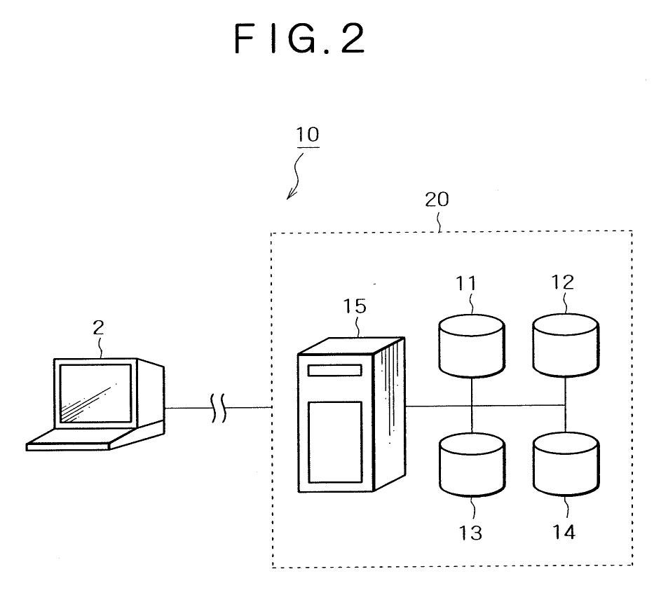

In order to generate a virtual channel and a virtual program guide and provide them to the user, the program service providing apparatus 6 has a virtual program guide generating apparatus 20 for generating virtual channels and program guides as shown in FIG. 2. The virtual program guide generating apparatus 20 and the terminal apparatus 2 constitute a virtual program guide providing system 10.

The virtual program guide providing system 10 comprises the virtual program guide generating apparatus 20 for transmitting a virtual program guide generated on the basis of a virtual channel and the terminal apparatus 2 for receiving the virtual program guide received from the virtual program guide generating apparatus 20.

The virtual program guide generating apparatus 20 comprises a database 11, a database 12, a database 13, a database 14, and a controller 15.

The database 11 stores the program information listed in Table 1, which is the attribute information about the programs provided by the commissioning broadcast provider 3.

TABLE 1

| Date | Day | Start Time | Time | Title | Category | keyword |
|---|---|---|---|---|---|---|
| 2000.09.01 | Friday | 19:30:00 | 0:30:00 | Quiz BB | 7 | Arimura |
| 2000.09.01 | Friday | 20:00:00 | 0:30:00 | News/Stock Price | 6 | Sato |
| | | | | Commentary | | |
| 2000.09.01 | Friday | 20:00:00 | 0:30:00 | AA News | 6 | Nakamura |
| 2000.09.01 | Friday | 20:00:00 | 0:30:00 | DD Music | 4 | Kitayama |
| 2000.09.01 | Friday | 20:00:00 | 2:00:00 | CC Japanese Movie | 1 | Yamada |
| | | | | Theater | | |
| 2000.09.01 | Friday | 20:00:00 | 1:00:00 | DD Quiz | 7 | Maeda |
| 2000.09.01 | Friday | 20:00:00 | 1:00:00 | BB Count Down | 4 | Kitagawa |
| 2000.09.01 | Friday | 20:00:00 | 0:30:00 | CC Angler DD | 8 | Suzuki |
| 2000.09.01 | Friday | 20:00:00 | 1:00:00 | CC Challenge | 7 | Takada |
| 2000.09.01 | Friday | 20:00:00 | 1:00:00 | AA Featuring | A | Murakami |
| 2000.09.01 | Friday | 20:00:00 | 1:00:00 | DD Professional | 3 | Funaki |
| | | | | Wrestling | | |
| 2000.09.01 | Friday | 20:30:00 | 0:30:00 | BB Introduction | 9 | Hara |
| 2000.09.01 | Friday | 20:30:00 | 0:30:00 | News & Sports BB | 6 | Harada |
| 2000.09.01 | Friday | 20:30:00 | 0:30:00 | Olympics EE | 3 | Takahashi |
| 2000.09.01 | Friday | 20:30:00 | 0:30:00 | AA Science | A | Suzuki |
| 2000.09.01 | Friday | 21:00:00 | 1:00:00 | EE Great Nature | A | Sakamoto |
| 2000.09.01 | Friday | 21:00:00 | 1:00:00 | Friday Drama BB | 5 | Katsura |
| 2000.09.01 | Friday | 21:00:00 | 1:00:00 | Ruins BB Exploration | B | Shima |
| 2000.09.01 | Friday | 21:00:00 | 1:00:00 | New Car Information DD | 8 | Matsubayashi |
| | | | | featuring | | |
| 2000.09.01 | Friday | 21:00:00 | 1:00:00 | World AA Soccer | 2 | Tanaka |
| 2000.09.01 | Friday | 21:00:00 | 0:30:00 | BB Sword | 9 | Murata |
| 2000.09.01 | Friday | 21:00:00 | 2:00:00 | BB Foreign Movie | 0 | Yodogawa |
| | | | | Theater | | |
| 2000.09.01 | Friday | 21:00:00 | 1:00:00 | CC Theater | 5 | Inagaki |
| 2000.09.01 | Friday | 21:00:00 | 2:00:00 | AA Theater | 0 | Tsuchiya |
| 2000.09.01 | Friday | 21:30:00 | 0:30:00 | DD 2/4 | 9 | Ikeda |
| 2000.09.01 | Friday | 22:00:00 | 2:00:00 | French Movie BB | 0 | Makino |
| 2000.09.01 | Friday | 22:00:00 | 1:00:00 | Overseas Travel AA | 8 | Inoue |
| | | | | Information | | |
| 2000.09.01 | Friday | 22:00:00 | 0:30:00 | Let's Use Digital | 8 | Yamashita |
| | | | | Video AA % | | |
| 2000.09.01 | Friday | 22:00:00 | 1:00:00 | Yesterday's BB | 5 | Mikami |
| 2000.09.01 | Friday | 22:00:00 | 1:00:00 | NY AA | 5 | Kimura |
| 2000.09.01 | Friday | 22:00:00 | 1:00:00 | 22AA Drama | 5 | Yamaguchi |
| 2000.09.01 | Friday | 22:00:00 | 1:00:00 | LA2NextWeek | 5 | George |
| 2000.09.01 | Friday | 22:00:00 | 0:30:00 | Bowling CC | 8 | Nishida |
| 2000.09.01 | Friday | 22:30:00 | 0:30:00 | News BB | 6 | Yamamura |
| 2000.09.01 | Friday | 22:30:00 | 0:30:00 | Cute Angel Kent | 0 | Kent |
| 2000.09.01 | Friday | 23:00:00 | 1:00:00 | Space Time NASA | B | Tsuchiya |
| 2000.09.01 | Friday | 23:00:00 | 1:00:00 | Music E | 4 | Hase |
| 2000.09.01 | Friday | 23:00:00 | 1:00:00 | Cook BB | 7 | Chin |

The program information includes, as attribute information, date and day on which a program will be broadcast, program broadcast start and end times (which may be replaced by a program broadcast time length), program category, program keyword, a channel number on which the program will be broadcast, channel name, and a brief explanation of the program to be broadcast, for example.

Table 1 lists the date and day on which programs will be broadcast, program broadcast start time, program broadcast time length, program category, and program keyword from among the above-mentioned attribute information items, each of the listed items being described below.

The Date box indicates a date on which a program will be broadcast, in the Christian era; for example, “2000.09.08.”

The Day box indicates a day of the week on which a program will be broadcast; for example, “Friday.” The Start Time box indicates a time at which the program will be broadcast; for example, “19:30:00.”

The Time box indicates a length of time of a program; for example, “0:30:00” for a 30 minutes program.

The Title box indicates a program title; for example, “Quiz BB.”

The Category box indicates a program category in a number listed in Table 1; for example “7.” The program category denotes a genre of a program; for example, the programs are classified into 15 categories as shown in Table 2.

TABLE 2

| Number | Category |
|---|---|
| 0 | Foreign movie |
| 1 | Japanese movie |
| 2 | Sports 1 |
| 3 | Sports 2 |
| 4 | Music |
| 5 | Drama/Theater |
| 6 | News/Report |
| 7 | Variety |
| 8 | Leisure/Hobby |
| 9 | Child/Education |
| A | Culture/Documentary |
| B | Overseas broadcast |
| C | Adult-oriented |
| D | Digital radio |
| E | Others |
| F | — |

The 15 categories are hexadecimally expressed in 0 through E. The categories may be further divided in Table 2 as required to classify the programs in further detail. It should be noted that category F denotes a reserved category.

The database 12 stores a program viewing log which indicates which programs the user has viewed. The controller 15, upon viewing of a program by the user, stores, as a program viewing log, date and day on which the program was broadcast, program start time, program title, program category, and program keyword into the database 12.

The following describes first and second methods for confirming that the user has viewed a program.

In the first method, how long the user has viewed a particular program is obtained and the length is compared with a predetermined threshold, thereby determining whether the user has viewed that program. For example, let the broadcast length of time of a particular program be L, the threshold be T, and the length of time the user has viewed the program be M. Then, if viewing time M satisfies relation T((M/L), then it is determined that the user has viewed that program. The threshold T may be constant for all programs or variable for different programs. For example, the threshold for dramas or movies for example which become more entertaining as they approach to their ends may be set to a higher level, while the threshold for news for example which present most important information at the beginning is set to a lower level.

In the second method, the viewing of a particular program is recognized when the user has accessed it from a virtual program guide presented to the terminal apparatus 2. In the second method, the access to the program information by the user is registered with the database 12 as a program viewing log regardless whether the user has actually viewed the program or not.

Meanwhile, viewing by the user of a particular program denotes that the user is interested in that program, so that the program viewing log stored in the database 12 may be considered to reflect the user's preference.

Consequently, the controller 15 generates user program viewing tendency information from the program viewing log stored in the database 12 by title, category, and keyword and stores the generated information into the database 12.

The user program viewing tendency information includes a title list defined by program title, a category list defined by program category, and a keyword list defined by program keyword, each list having a value indicative of the number of times the user has viewed the program. A set of the user program viewing tendency information consists of a category list, a title list, and a keyword list. The user program viewing tendency information can be set on 1 hour basis and on 1 week basis Monday through Sunday. For example, various modes can be set. One mode has a set of user program viewing tendency information on 1 hour basis for every day of the week. Another mode has a set of user program viewing tendency information for week days Monday through Friday and another set for a week end Saturday and Sunday, a total of 2 sets in 1 week. Still another mode has a set to user program viewing tendency information from Monday to Sunday.

In each of the following descriptions, the mode having a set of the user program viewing tendency information on one hour basis for each day of the week. For example, in this mode, 24 sets of user program viewing tendency information are created, amount to a total of 168 (24×7) in one week.

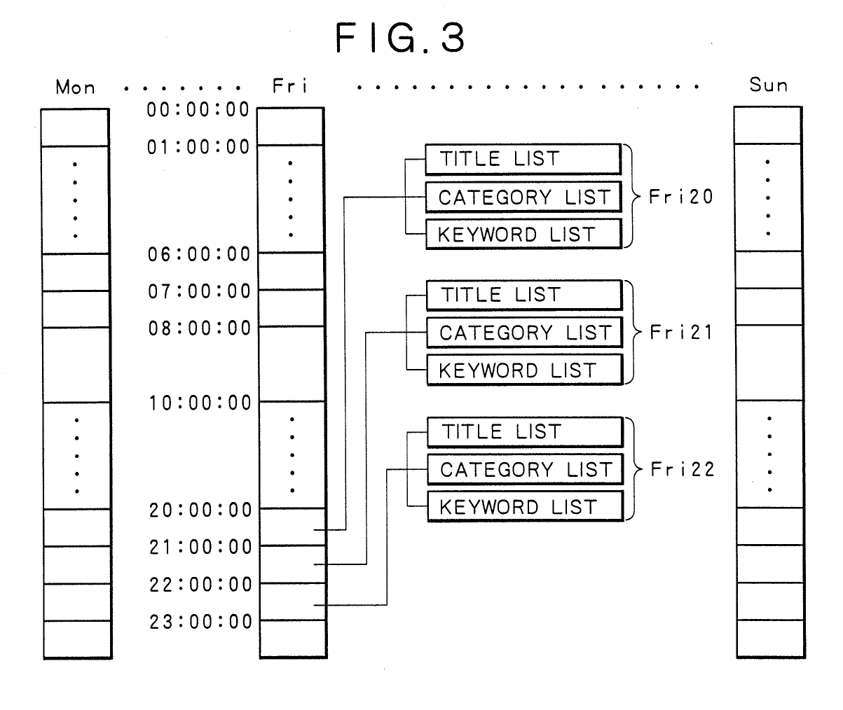

As shown in FIG. 3, if three hours from 20:00 to 23:00 on Friday for example are taken, then there are three sets of user program viewing tendency information. These sets are referred to as Fri20, which is from 20:00 to 21:00, Fri21, which is from 21:00 to 22:00, and Fri30, which is from 22:00 to 23:00.

The title list of Fri20 is shown in Table 3, its category list in Table 4, and its keyword list in Table 5. It should be noted that each list includes the top three programs in the descending order of their values.

TABLE 3

| Day | Time | Title | Value |
|---|---|---|---|
| Friday | 20:00:00 | News/Stock Price Commentary | 10 |
| Friday | 20:30:00 | AA Science | 7 |
| Friday | 20:00:00 | AA News | 2 |

TABLE 4

| Day | Time | Category | Value |
|---|---|---|---|
| Friday | 20:00:00 | News/Report (6) | 12 |
| Friday | 20:00:00 | Culture/Documentary (A) | 7 |
| Friday | 20:00:00 | Music (4) | 1 |

TABLE 5

| Day | Time | Keyword | Value |
|---|---|---|---|
| Friday | 20:00:00 | Sato | 15 |
| Friday | 20:30:00 | Suzuki | 7 |
| Friday | 20:00:00 | Kitayama | 2 |

The title list shown in Table 3 includes information such as the day of the week on which a program is broadcast, the program start time, the program title, and the value. For example, the program having the highest value in the title list of Table 3 has a title “News/Stock Price Commentary” which starts at 20:00, its value being 10.

The category list shown in Table 4 includes information such as the day of the week on which a program is broadcast, the program start time, the program category, and the value. For example, the category having the highest value in the category list of Table 4 has a title “News/Report” having value 12.

The keyword list shown in Table 5 includes information such as the day of the week on which a program is broadcast, the program start time, the program keyword, and the value.

The keyword of a program is a personal name for example as shown in Table 5. This personal name indicates the name of a person who appears on that program. For example, the keyword may be the name of person who regularly appears on that program or the name of a guest who characterizes that program. For example, the keyword having the highest value in the keyword list in Table 5 is “Sato” having value 15.

A method of counting values, or how the length of viewing time of a program is counted as a value will be described later in detail.

The title list of Fri21 is shown in Table 6, the category list in Table 7, and the keyword list in Table 8. The title list of Fri22 is shown in Table 9, the category list in Table 10, and the keyword list in Table 11.

TABLE 6

| Day | Time | Title | Value |
|---|---|---|---|
| Friday | 21:00:00 | World AA Soccer | 9 |
| Friday | 21:00:00 | BB Foreign Movie Theater | 4 |
| Friday | 21:00:00 | Ruins BB Exploration | 1 |

TABLE 7

| Day | Time | Category | Value |
|---|---|---|---|
| Friday | 21:00:00 | Sports 1 (2) | 10 |
| Friday | 21:00:00 | Foreign Movie (0) | 4 |
| Friday | 21:00:00 | Overseas Broadcast (B) | 1 |

TABLE 8

| Day | Time | Keyword | Value |
|---|---|---|---|
| Friday | 21:00:00 | Tanaka | 9 |
| Friday | 21:00:00 | Yodogawa | 4 |
| Friday | 21:00:00 | Shima | 1 |

TABLE 9

| Day | Time | Title | Value |
|---|---|---|---|
| Friday | 22:00:00 | LA2NextWeek | 8 |
| Friday | 23:00:00 | Cute Angel Kent | 5 |
| Friday | 22:00:00 | Bowling CC | 2 |

TABLE 10

| Day | Time | Category | Value |
|---|---|---|---|
| Friday | 22:00:00 | Drama/Theater (5) | 8 |
| Friday | 22:00:00 | Foreign Movie (0) | 5 |
| Friday | 22:00:00 | Leisure/Hobby (8) | 3 |

TABLE 11

| Day | Time | Keyword | Value |
|---|---|---|---|
| Friday | 22:00:00 | George | 7 |
| Friday | 22:30:00 | Kent | 5 |
| Friday | 22:00:00 | Nishida | 1 |

The database 13 stores the personal information of the user.

The personal information includes age, gender, marital status, occupation, and so on. The personal information is inputted through the terminal apparatus 2 for registration before receiving services in the virtual program guide providing system 10, for example.

Also, the database 13 stores the broadcasting dates of programs which the user wants to view without failure at organizing virtual channels, their broadcast times, and their titles. Let the programs which the user wants to view without failure be an absolute viewing program group, then it is organized first into virtual channels. As with the above-mentioned personal information, the user inputs the absolute viewing program group through the terminal apparatus 2 to be described later.

The database 14 stores group information about a group determined on the basis of the user personal information stored in the database 13.

In order to obtain the group information, grouping is first made on the basis of the personal information stored in the database 13. For example, the grouping is made on the basis of the personal information such as age, occupation, and marital status for example. Obviously, the grouping may be made in more detail or less detail than mentioned above.

After the grouping, the group's program viewing tendency information is newly created by use of the personal program viewing log stored in the database 12. This group viewing tendency information is stored in the database 14 for each group.

For example, assume user X who uses the virtual program guide providing system 10. Assume that user X, as he uses the virtual program guide providing system 10, input from the terminal apparatus 2 the personal information that age is 30, marital status is single, and occupation is engineer. From this personal information, the virtual program guide generating apparatus 20 generates through the controller 15 a group, which is group A for the convenience of description. The controller 15 then inputs the viewing logs of all users belonging to group A into the database 14 to newly create the program viewing tendency information of the group. The group program viewing tendency information is stored, for each program title, program category, and program keyword, into the database 14 along with values indicative of the number of times the programs have been viewed, as with the user program viewing tendency information.

As with the user program viewing tendency information, a set of group program viewing tendency information consists of a category list, a title list, and a keyword list. The group program viewing tendency information can be set on 1 hour basis and on 1 week basis Monday through Sunday. For example, various modes can be set. One mode has a set of group program viewing tendency information on 1 hour basis for every day of the week. Another mode has a set of group program viewing tendency information for week days Monday through Friday and another set for a week end Saturday and Sunday, total of 2 sets in 1 week. Still another mode has a set to group program viewing tendency information from Monday to Sunday.

In what follows, the mode having one set of group program viewing tendency information on 1 hour basis for every day of the week is applied. For example, in this mode, 24 sets of user program viewing tendency information are created, amount to a total of 168 (24×7) in one week.

As with the user program viewing tendency information, if three hours from 20:00 to 23:00 on Friday for example are taken, then there are three sets of group program viewing tendency information. These sets are referred to as GFri20, which is from 20:00 to 21:00, GFri21, which is from 21:00 to 22:00, and Gfri22, which is from 22:00 to 23:00.

The title list of GFri20 is shown in Table 12, its category list in Table 13, and its keyword list in Table 14. It should be noted that each list includes the top three programs in the descending order of their values.

TABLE 12

| Day | Time | Title | Value |
|---|---|---|---|
| Friday | 20:00:00 | DD Professional Wrestling | 8 |
| Friday | 20:00:00 | AA News | 4 |
| Friday | 20:00:00 | DD Quiz | 3 |

TABLE 13

| Day | Time | Category | Value |
|---|---|---|---|
| Friday | 20:00:00 | Sports 2 (3) | 12 |
| Friday | 20:00:00 | News/Report (6) | 6 |
| Friday | 20:00:00 | Variety (7) | 2 |

TABLE 14

| Day | Time | Keyword | Value |
|---|---|---|---|
| Friday | 20:00:00 | Funaki | 5 |
| Friday | 20:00:00 | Nakamura | 3 |
| Friday | 20:00:00 | Takahashi | 1 |

The title list shown in Table 12 includes information such as the day of the week on which a program is broadcast, the program start time, the program title, and the value. For example, the program having the highest value in the title list of Table 12 has a title “DD Professional Wrestling” which starts at 20:00, its value being 8.

The category list shown in Table 13 includes information such as the day of the week on which a program is broadcast, the program start time, the program title, and the value. For example, the category having the highest value in the category list of Table 13 is a title “Sports 2” having value 12.

The keyword list shown in Table 14 includes information such as the day of the week on which a program is broadcast, the program start time, the program keyword, and the value. For example, the keyword may be the name of person who regularly appears on that program or the name of a guest who characterizes that program as shown in Table 14. For example, the keyword having the highest value in the keyword list in Table 14 is “Funaki” having value 5.

The values of each list are computed from the viewing logs of all users belonging to each group and updated at predetermined intervals.

The title list of GFri21 is shown in Table 15, the category list in Table 16, and the keyword list in Table 17. The title list of GFri22 is shown in Table 18, the category list in Table 19, and the keyword list in Table 20.

TABLE 15

| Day | Time | Title | Value |
|---|---|---|---|
| Friday | 21:00:00 | BB Foreign Movie Theater | 9 |
| Friday | 21:00:00 | Friday Drama BB | 6 |
| Friday | 21:00:00 | EE Great Nature | 4 |

TABLE 16

| Day | Time | Category | Value |
|---|---|---|---|
| Friday | 21:00:00 | Foreign Movie (0) | 9 |
| Friday | 21:00:00 | Drama/Play (5) | 6 |
| Friday | 21:00:00 | Culture/Documentary (A) | 5 |

TABLE 17

| Day | Time | Keyword | Value |
|---|---|---|---|
| Friday | 21:00:00 | Yodogawa | 9 |
| Friday | 21:00:00 | Tsuchiya | 5 |
| Friday | 21:00:00 | Katsura | 3 |

TABLE 18

| Day | Time | Title | Value |
|---|---|---|---|
| Friday | 22:00:00 | LA2NextWeek | 5 |
| Friday | 22:00:00 | Overseas Travel AA Information | 3 |
| Friday | 22:00:00 | 22AA Drama | 1 |

TABLE 19

| Day | Time | Category | Value |
|---|---|---|---|
| Friday | 22:00:00 | Drama/Theater (5) | 5 |
| Friday | 22:00:00 | Leisure/Hobby (8) | 4 |
| Friday | 22:00:00 | News/Report (6) | 2 |

TABLE 20

| Day | Time | Keyword | Value |
|---|---|---|---|
| Friday | 22:00:00 | George | 5 |
| Friday | 22:00:00 | Yamaguchi | 4 |
| Friday | 22:00:00 | Kimura | 3 |

As described above, the user program viewing tendency information and the group program viewing tendency information are generated not only on the basis of the program viewing logs of the users stored in the database 12, but also on the basis of program rating. If a user determines that a program the user viewed is good, this rating is reflected onto the user program viewing tendency information and the group program viewing tendency information, thereby incrementing the values of the title, category, and keyword of that program.

For example, a button “Good” for inputting user's program rating is arranged in each program information box of the virtual program guide generated by the virtual program guide generating apparatus 20. If the user determines that the program just viewed is good, the user checks the “Good” button at the terminal apparatus 2, upon which the values of the titles, categories, and keywords of the user program viewing tendency information and group program viewing tendency information are incremented, thereby reflecting the user's program rating onto the user program viewing tendency information and the group program viewing tendency information.

The controller 15 totally controls the database 11, the database 12, the database 13, and the database 14 and generates a virtual program guide, which is transmitted to the terminal apparatus 2.

The terminal apparatus 2 is a personal computer for example, which receives the virtual program guide from the virtual program guide generating apparatus 20 and has a display section, for example a CRT (Cathode Ray Tube) or LCD (Liquid Crystal Display), on which the received virtual program guide is displayed. The terminal apparatus 2 also has an input section, for example a keyboard and a mouse, for inputting the personal information and the information for changing the virtual program guide for example, the inputted information being transmitted to the virtual program guide generating apparatus 20.

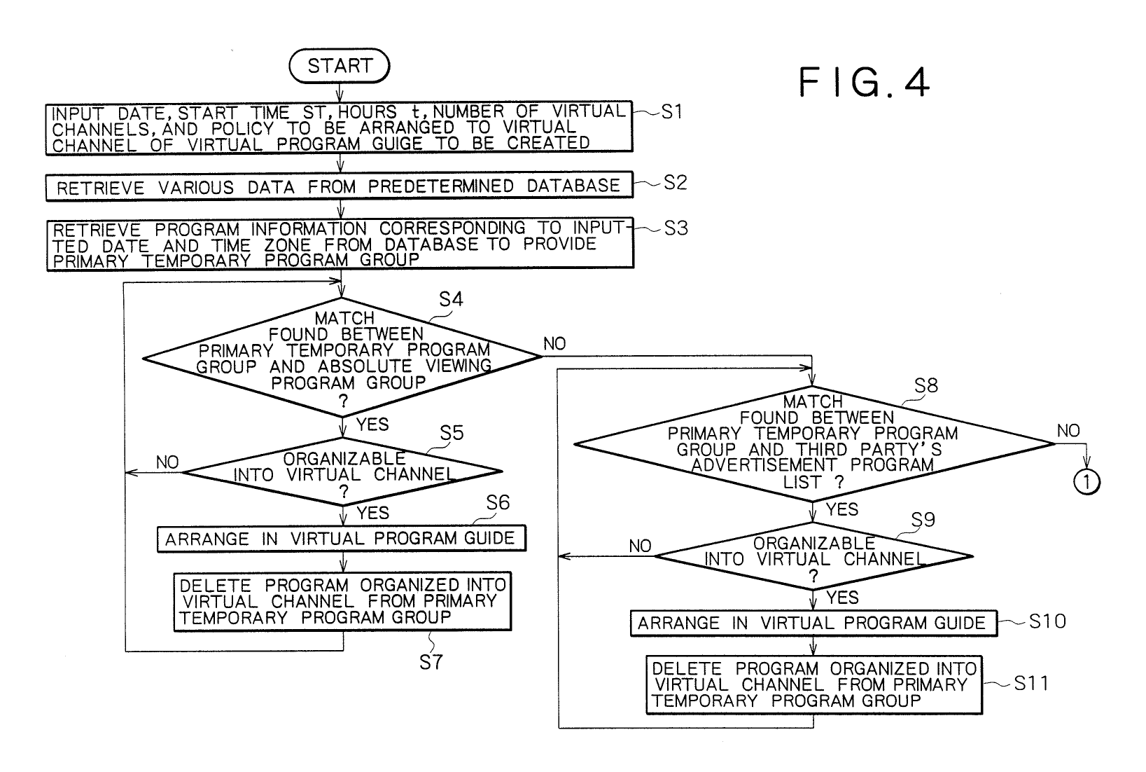

The following describes the operation of generating a virtual program guide in the virtual program guide providing system 10 with reference to the flowcharts shown in FIGS. 4 through 12.

Steps S1 through S11 will be described with reference to FIG. 4.

In step S1, the user inputs the day of the week of a virtual program guide to be created at the terminal apparatus 2, start time ST of the virtual program guide, and time t thereof.

If the number of virtual channels to be generated has not been determined and if the number of virtual channels can be set by the user, the user also inputs the number of virtual channels. Also, the number of virtual channels may be computed by presetting the upper limit of the number of virtual channels which can be generated and multiplying the number of real channels available to the user by an coefficient. For example, let the upper limit of the number of virtual channels be Vₘₐₓ, the number of real channels be R_{c}, the number of virtual channels be V_{c}, and the coefficient be k, then the number of virtual channels is computed by V_{c}=k×R_{c}. However, if computed V_{c} is V_{c}≧Vₘₐₓ, then V_{c}=Vₘₐₓ.

In step S1, it is assumed that the user who wants to create the virtual program guide be user X and the day of the week and time of the virtual program guide to be created be Friday and 20:00 to 23:00, for example. The number of virtual channels to be generated can be inputted by the user, the number of virtual channels being 4, VC-1, VC-2, VC-3, and VC-4, for example.

Next, the user inputs from the terminal apparatus 2 a policy value for determining the priority between user program viewing tendency information and group program viewing tendency information and the priority between the title lists, category lists, and keyword lists of user program viewing tendency information and group program viewing tendency information.

The policy value is of a time count mode in which the number of virtual channels to be generated is multiplied by a time count to compute a total time count, for which an adoption ratio is specified and a program count mode in which an adoption ratio is specified for the number of programs to be organized into virtual channels.

First, the time count mode will be described. In the time count mode, the policy values are inputted like 70% for user program viewing tendency information and 30% for group program viewing tendency information, for example. These policy values denote that the programs equivalent to a time count 75% of the total time count computed by multiplying the number of virtual channels to be generated by the time count are organized into the virtual channels on the basis of the user program viewing tendency information and programs equivalent to a time count 30% of the total time count are organized into the virtual channels on the basis of the group program viewing tendency information.

For example, if the total time count obtained by multiplying the number of generated virtual channels by the time count is 100 hours, then the broadcast time or the programs which can be organized by use of the user program viewing tendency information amounts to a total of 70 hours and the broadcast time of the programs which can be organized by use of the group program viewing tendency information amounts to a total of 30 hours.

Likewise, it is assumed that the policy values of the title lists, category lists, and keyword lists of the user program viewing tendency information and the group program viewing tendency information be 50%, 30%, and 20% respectively. If the user program viewing tendency information is used, the time of the number of programs which can be arranged is a total of 70 hours, so that programs of 35 hours on the basis of the title list, programs of 21 hours on the basis of the category list, and programs of 14 hours on the keyword list are selected. The same holds if the group program viewing tendency information is used.

When programs are organized into virtual channels, the programs are organized in the descending order of their policy values. In the above-mentioned policy values, the title list of the user program viewing tendency information is used preferentially, followed by the category list and the keyword list in this order. When the program organization by the user program viewing tendency information has been completed, then the title list, category list, and keyword list of the group program viewing tendency information are used in this order.

It should be noted that, although any value may be inputted for policy values, a fractional number may result depending on combinations of a time in which virtual channels can be arranged and a time of program broadcasting. If this happens, a program is selected so that it is closest to each policy value.

The following describes the program count mode. In the program count mode, the number of programs which can be organized into virtual channels is set as a program count which provides reference for specifying an adoption ratio in the number of programs. For example, if one program can be organized in each channel every hour and if programs are organized into virtual channels in units of one hour on the basis of user program viewing tendency information and group program viewing tendency information, the number of virtual channels provides the reference for the number of programs. For example, if the number of virtual channels to be generated is 20, then the reference number of programs is 20.

In the program count mode, policy values are inputted as 70% for the user program viewing tendency information and 30% for the group program viewing tendency information for example as with the time count mode.

These values denote that 70% of the above-mentioned reference number of programs were selected on the basis of the user program viewing tendency information and 30% were selected on the basis of the group program viewing tendency information. For example, if the number of virtual channels to be generated is 20, then the number of programs which can be organized by use of the user program viewing tendency information is 20×0.7=14 and the number of programs which can be organized by use of the group program viewing tendency information is 20×0.3=6.

Likewise, it is assumed that the policy values of the title lists, category lists, and keyword lists of the user program viewing tendency information and the group program viewing tendency information be 50%, 30%, and 20% respectively. As described above, if the user program viewing tendency information is used, the number of programs which can be organized is 14, so that 14×0.5=7 programs are selected on the basis of title list, 14×0.3=4.2 programs on the basis of category list, and 14×0.2=2.8 programs on the basis of keyword list. If a fractional number results as with the case of the number of programs selected on the basis of category list and keyword list, the number of programs is corrected such that it is closest to each policy value. For example, 4.2 is corrected to 4 in the category list and 2.8 is corrected to 3 in the keyword list. In the program count mode, if an appropriate free area for organizing programs into virtual channels exists after the execution of the above-mentioned processing, the same processing is repeated to organize programs into virtual channels.

In the case of group program viewing tendency information, the above-mentioned processing is also repeated to organize programs into virtual channels as with user program viewing tendency information.

When organizing programs into virtual channels in the program count mode, the programs are organized in the descending order of their policy values like the time count mode. In the case of the above-mentioned policy values, the title list of the user program viewing tendency information is used preferentially, followed by the category list and the keyword list in this order. When the program organization by the user program viewing tendency information has been completed, then the title list, category list, and keyword list of the group program viewing tendency information are used in this order.

In step S2, in response to the input from the terminal apparatus 2, the controller 15 of the virtual program guide generating apparatus 20 retrieves the user program viewing tendency information of user X from the database 12, the absolute viewing program group from the database 13, and the group program viewing tendency information of the group, group A in this example, to which user X belongs, from the database 14. Since a virtual program guide desired by user X is that covering 20:00 to 23:00 of Friday, the controller 15 retrieves Fri20 shown in Tables 9 through 11, Fri21 shown in Tables 6 through 8, and Fri22 shown in Tables 9 through 11 of the user program viewing tendency information and GFri20 shown in Tables 12 through 14, GFri21 shown in Tables 15 through 17, and GFri22 shown in Tables 18 through 20 of the group program viewing tendency information.

In step S3, the controller 15 retrieves all program information corresponding to the time zones for which a virtual program guide is created from the database 11 to provide one program group. In this example, the program information from 20:00 to 23:00 of Friday is retrieved. If the program information is that shown in Table 1 for example, the start time box and the time box in the table are referenced to extract programs which start after 20:00 and end before 23:00.

In Table 1, “Quiz BB” of which start time is 19:30:00, “French Movie BB” of which broadcast end time exceeds 23:00 because its start time is 22:00:00 and its time is 2:00:00, “Space Time NASA” of which start time is 23:00:00, “Music E,” and “Cook BB” are excluded, the program information about the other programs being organized as a program group. This program group is referred to as a primary temporary program group in this example. The primary temporary program group is shown in Table 21.

TABLE 21

| | | Start | | | | |
|---|---|---|---|---|---|---|
| Date | Day | Time | Time | Title | Category | keyword |
| 2000.09.01 | Friday | 20:00:00 | 0:30:00 | News/Stock Price | 6 | Sato |
| | | | | Commentary | | |
| 2000.09.01 | Friday | 20:00:00 | 0:30:00 | AA News | 6 | Nakamura |
| 2000.09.01 | Friday | 20:00:00 | 0:30:00 | DD Music | 4 | Kitayama |
| 2000.09.01 | Friday | 20:00:00 | 2:00:00 | CC Japanese Movie | 1 | Yamada |
| | | | | Theater | | |
| 2000.09.01 | Friday | 20:00:00 | 1:00:00 | DD Quiz | 7 | Maeda |
| 2000.09.01 | Friday | 20:00:00 | 1:00:00 | BB Count Down | 4 | Kitagawa |
| 2000.09.01 | Friday | 20:00:00 | 0:30:00 | CC Angler DD | 8 | Suzuki |
| 2000.09.01 | Friday | 20:00:00 | 1:00:00 | CC Challenge | 7 | Takada |
| 2000.09.01 | Friday | 20:00:00 | 1:00:00 | AA Featuring | A | Murakami |
| 2000.09.01 | Friday | 20:00:00 | 1:00:00 | DD Professional | 3 | Funaki |
| | | | | Wrestling | | |
| 2000.09.01 | Friday | 20:30:00 | 0:30:00 | BB Introduction | 9 | Hara |
| 2000.09.01 | Friday | 20:30:00 | 0:30:00 | News & Sports BB | 6 | Harada |
| 2000.09.01 | Friday | 20:30:00 | 0:30:00 | Olympics EE | 3 | Takahashi |
| 2000.09.01 | Friday | 20:30:00 | 0:30:00 | AA Science | A | Suzuki |
| 2000.09.01 | Friday | 21:00:00 | 1:00:00 | EE Great Nature | A | Sakamoto |
| 2000.09.01 | Friday | 21:00:00 | 1:00:00 | Friday Drama BB | 5 | Katsura |
| 2000.09.01 | Friday | 21:00:00 | 1:00:00 | Ruins BB | B | Shima |
| | | | | Exploration | | |
| 2000.09.01 | Friday | 21:00:00 | 1:00:00 | New Car | 8 | Matsubayashi |
| | | | | Information DD | | |
| | | | | Featuring | | |
| 2000.09.01 | Friday | 21:00:00 | 1:00:00 | World AA Soccer | 2 | Tanaka |
| 2000.09.01 | Friday | 21:00:00 | 0:30:00 | BB Sword | 9 | Murata |
| 2000.09.01 | Friday | 21:00:00 | 2:00:00 | BB Foreign Movie | 0 | Yodogawa |
| | | | | Theater | | |
| 2000.09.01 | Friday | 21:00:00 | 1:00:00 | CC Theater | 5 | Inagaki |
| 2000.09.01 | Friday | 21:00:00 | 2:00:00 | AA Theater | 0 | Tsuchiya |
| 2000.09.01 | Friday | 21:30:00 | 0:30:00 | DD 2/4 | 9 | Ikeda |
| 2000.09.01 | Friday | 22:00:00 | 1:00:00 | Overseas Travel AA | 8 | Inoue |
| | | | | Information | | |
| 2000.09.01 | Friday | 22:00:00 | 0:30:00 | Let's Use Digital | 8 | Yamashita |
| | | | | Video AA % | | |
| 2000.09.01 | Friday | 22:00:00 | 1:00:00 | Yesterday's BB | 5 | Mikami |
| 2000.09.01 | Friday | 22:00:00 | 1:00:00 | NY AA | 5 | Kimura |
| 2000.09.01 | Friday | 22:00:00 | 1:00:00 | 22AA Drama | 5 | Yamaguchi |
| 2000.09.01 | Friday | 22:00:00 | 1:00:00 | LA2NextWeek | 5 | George |
| 2000.09.01 | Friday | 22:00:00 | 0:30:00 | Bowling CC | 8 | Nishida |
| 2000.09.01 | Friday | 22:30:00 | 0:30:00 | News BB | 6 | Yamamura |
| 2000.09.01 | Friday | 22:30:00 | 0:30:00 | Cute Angel Kent | 0 | Kent |

In step S4, the controller 15 compares the primary temporary program group with the program information about the absolute viewing program group of user X retrieved from the database 13 in step S2 to see if there is any matching program. If a matching program is found, the controller 15 reads its program information, upon which the procedure goes to step S5; otherwise, the procedure goes to step S8.

Table 22 lists one example of the absolute viewing program group of user X.

TABLE 22

| | | Start | | | Cate- | |
|---|---|---|---|---|---|---|
| Date | Day | Time | Time | Title | gory | Keyword |
| 2000.09.01 | Friday | 20:30:00 | 0:30:00 | AA | A | Suzuki |
| | | | | Science | | |
| 2000.09.01 | Friday | 22:30:00 | 0:30:00 | Cute | 0 | Kent |
| | | | | Angel | | |
| | | | | Kent | | |

For example, first, the controller 15 compares “AA Science” of which start time is 20:30:00, earliest among the absolute viewing programs listed in Table 22, with the primary temporary program group listed in Table 21 to see if there is any matching program. When the controller 15 finds “AA Science” in the primary temporary program group listed in Table 21, then the controller 15 reads its program information, upon which the procedure goes to step S5.

In step S5, the controller 15 computes a free area for virtual channels and compares the obtained free area with a program broadcast time obtained from the program information retrieved in step S4 to determine whether programs can be organized into virtual channels. If the decision is yes, the procedure goes to step S6; otherwise the procedure returns to step S4.

For example, if none of the programs has been organized into virtual channels, the controller 15 computes the free area for the virtual channels to be 4 channels×3 hours=12 hours. Since the broadcast length of time of “AA Science” of which program information was retrieved in step S4 is 30 minutes, the controller 15 determines that “AA Science” can be organized into any one of virtual channels VC-1 through VC-4, upon which the procedure goes to step S6.

In step S6, the controller 15 organizes programs into virtual channels and arranges the program information about the organized programs in the virtual program guide. The programs are organized in the ascending order of virtual channel numbers. To be more specific, given the four virtual channels VC-1, VC-2, VC-3, and VC-4, the programs are organized starting with VC-1.

For example, because no program has been organized in the virtual channels, the controller 15 organizes “AA Science” whose start time is 20:30:00 into VC-1 at the position of 20:30, arranging the program information of this program in the virtual program guide.

In step S7, the controller 15 deletes, from the primary temporary program group, the program information of the program organized into a virtual channel in step S6. For example, the program information about “AA Science” is deleted from the primary temporary program group listed in Table 21.

When the process of step S7 has been completed, the procedure returns to step S4. Because the absolute viewing program group listed in Table 22 includes “Cute Angel Kent” whose start time is 22:30:00 and this program can also be organized into a virtual channel, the controller 15 organizes this program into VC-1 at the position of 22:30 and arranges its program information in the virtual program guide.

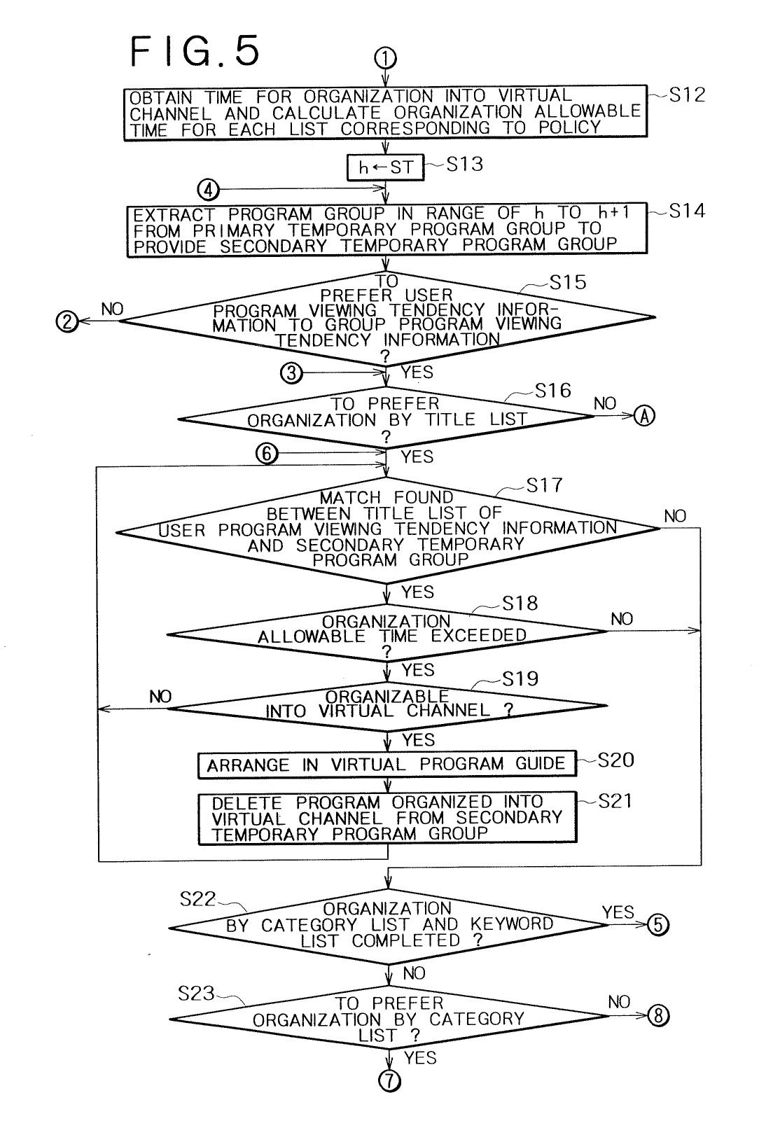

In step S8, the controller 15 compares the primary temporary program group with a third party's advertisement program list stored in a storage section, not shown. If a matching program is found, the controller 15 retrieves it, upon which the procedure goes to step S9; otherwise, the procedure goes to step S12 of FIG. 5.

The following describes the above-mentioned third party's advertisement program list. This list is a collection of the program information about the programs selected by a person or an organization other than user X, for example, the server administrator operating the program service providing apparatus 6 or the advertiser 4. With or without permission by user X, the server administrator may insert advertisement programs selected by the server administrator into virtual channels. If the server administrator charges user X every time a virtual channel is generated, the server administrator may discount the fee charge in compensation for the advertisement made by advertisement programs inserted in programs viewed by user X. If programs selected by the advertiser 4 are organized into virtual channels, those programs which use products which the advertiser 4 wants to advertise or are inserted with the commercials of such products, for example, are organized into virtual channels. With or without permission by user X, the advertiser 4 may pay all or part of the virtual channel service usage fee to be paid by user X to the server administrator, in compensation for the organization of such programs into virtual channels. Thus, the third party's advertisement program list is a collection of programs having third party's intentions. Often, these programs are nothing to do with user, 's preference. However, those advertisement programs which fit user's or group's preferences may be selected.

For example, the controller 15 compares the third party's advertisement program list with the primary temporary program group shown in Table 21. If “Let's Use Digital Video AA %” of which start time 22:00:00 is found matching, the controller 15 retrieves the program information of this program.

A third party who organizes this program into a virtual channel of user X is a maker or a dealer of digital video cameras or digital VCRs for example.

In step S9, the controller 15 computes a virtual channel free area and compares the obtained free area with the program's broadcast length of time obtained from the program information retrieved in step S8, thereby determining whether this program can be organized into a virtual channel. If the program is found organizable into a virtual channel, the procedure goes to step S10; otherwise, the procedure returns to step S8 of FIG. 4.

In step S10, the controller 15 organizes the program into a virtual channel and arranges its program information into the virtual program guide. The controller 15 makes this organization in the ascending order of the virtual channel numbers.

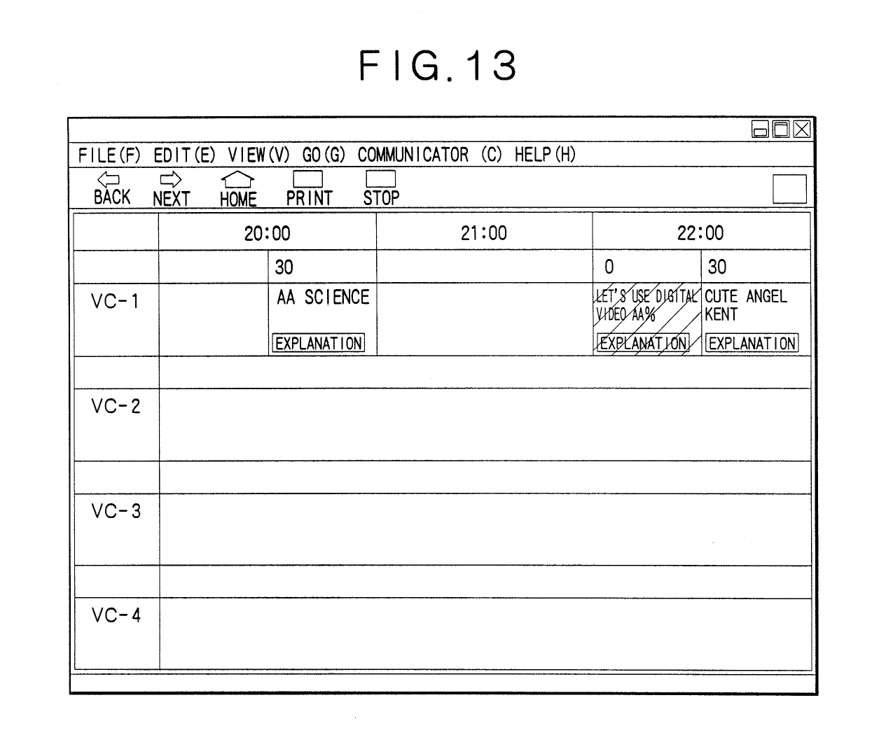

For example, “Let's Use Digital Video AA %” of which start time is 22:00:00 is organized into VC-1 at the position of 22:00, its program information being arranged into the virtual program list as shown by a hatched portion in FIG. 13. For example, when user X clicks “Explanation” button placed in the program information box of the virtual program guide shown in FIG. 13, a browser starts, displaying a brief explanation of the contents of that program.

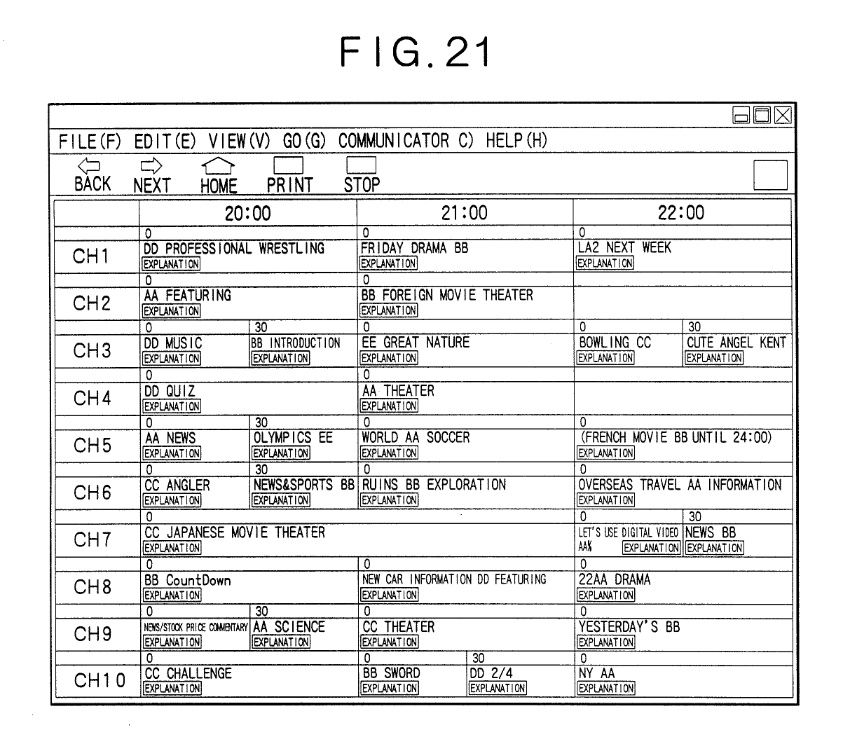

In step S11, the controller 15 deletes the program information of the program organized into a virtual channel in step S10 from the primary temporary program group. For example, the program information of “Let's Use Digital Video AA %” in the primary temporary program group shown in FIG. 21 is deleted.

Upon completion of the process of step S11, the procedure returns to step S8.

Processes of steps S12 through S23 are shown in FIG. 5.

In step S12, the controller 15 obtains the number of hours in which a virtual program guide to be created can be organized into virtual channels and computes an organization allowable time providing the upper limit for the organization from the policy values inputted by user X in step S1 and on the basis of the user program viewing tendency information and the group program viewing tendency information.

For example, if there are four virtual channels and a virtual program guide covering a time zone from 20:00 to 23:00 is to be created, the virtual channels have an organization allowable time of 4 (channels)×3 (hours)×60 (minutes)=720 minutes. If VC-1 is organized with 30-minute “AA Science,” 30-minute “Let's Use Digital Video AA %,” and 30-minute “Cute Angel Kent,” then the organization allowable time of the virtual program guide is 720−30×3=630 minutes.

If the policy values of user program viewing tendency information and group program viewing tendency information are 70% and 30% respectively, then the organization allowable times are 630×(7/10)=441 minutes and 630×(3/10)=189 minutes, respectively. These organization allowable times denote that a maximum of 441 minutes of programs can be arranged in a virtual channel on the basis of the user program viewing tendency information and a maximum of 189 minutes of programs can be arranged in a virtual channel on the basis of the group program viewing tendency information.

Further, if the policy values of the title list, category list, and keyword list of the user program viewing tendency information and the group program viewing tendency information are 50%, 30%, and 30% respectively, then the organization allowable times are 441×(5/10)=220.5 minutes, 441×(3/10)=132.3 minutes, and 441×(2/10)=88.2 minutes in the case of the user program viewing tendency information. In the case of the group program viewing tendency information, the organization allowable times are 189×(5/10)=94.5 minutes, 189×(3/10)=56.7 minutes, and 189×(2/10)=37.8 minutes respectively. However, since each program is composed on a 120, 60, or 30 minutes basis, the organization allowable time should be an integral multiple of the length of broadcast time of each program to eliminate the waste of time, thereby reflecting the user program viewing tendency information and the group program viewing tendency information onto the virtual channel organization job more properly.

For example, if the organization allowable times by title list, category list, and keyword list computed as described above are corrected to an integral multiple of 30 minutes because the shortest broadcast time of the programs belonging to the primary temporary program group is 30 minutes, the organization allowable times become 240 minutes, 120 minutes, and 90 minutes respectively in the case of the user program viewing tendency information. Likewise, in the case of the group program viewing tendency information, the organization allowable times become 90 minutes, 60 minutes, and 30 minutes respectively.

It should be noted that, in step S12 and on, the time count mode is applied in which an adoption ratio is specified for a total number of hours obtained by multiplying the number of channels to be generated by the time. In step S12, the time for programs to be organized into virtual channels is obtained to compute the organization allowable time of each list in accordance with the policy values. Alternatively, the number of programs which can be organized into virtual channels in accordance with each policy value may be computed to apply the program count mode for specifying an adoption ratio to the number of programs to be organized into virtual channels in the subsequent steps.

For example, if the number of virtual channels to be generated is 4 and the time zone of these channels is from 20:00 to 23:00, then the number of programs which provides reference for specifying an adoption ratio by the number of program is 4 for each hour. If the policy values of user program viewing tendency information and the group program viewing tendency information are 70% and 30% respectively, 4×0.7=2.8 programs are organized in virtual channels by the user program viewing tendency information and 4×0.3=1.2 programs is organized into virtual channels by the group program viewing tendency information. It should be noted that the computed values are corrected to 3 in the user program viewing tendency information and 1 in the group program viewing tendency information so that these values become most close to the policy values.

If the policy values of the title list, the category list, and the keyword list are set to 50%, 30%, and 20% respectively, then the number of programs in the title list of the user program viewing tendency information is 3×0.5=1.5, the number of programs in the category list is 3×0.3=0.9, and the number of programs in the keyword list is 3×0.2=0.6. The computed values are corrected to 1 in the title list, 1 in the category list, and 1 in the keyword list or 2 in the title list, 1 in the category list, and 0 in the keyword list for example, thereby providing the number of programs corresponding to each policy value.

In the case of the group program viewing tendency information, only one program is allocated, so that the title list having the highest policy value is given to priority, the organization into virtual channels based on the title list being executed in the following steps.

As described, in the following steps, the program count mode may be applied instead of the time count mode to organize programs into virtual channels or a combination of the time count mode and the program count mode may be applied to organize programs into virtual channels. In this case, the organization allowable time in the time count mode and the reference number of programs in the program count mode are computed in step S12.

In step S13, the controller 15 replaces start time ST of the virtual program guide to be created by h. This operation is for executing a loop, which will be described later, in the flowcharts shown in FIGS. 4 through 12. For example, if start time ST inputted in step S1 is 20:00, then h=20:00.

In step S14, the controller 15 extracts the 1-hour programs from h o'clock to h+1 o'clock from the primary temporary program group obtained in step S3 to provide a secondary temporary program group.

For example, given h=20:00, then the controller 15 extracts the program information of the programs belonging to time zone from 20:00 to 21:00 from the primary temporary program group to provide a secondary temporary program group. The secondary temporary program group from 20:00 to 21:00 in the primary temporary group shown in Table. 21 is shown in Table. 23.

TABLE 23

| Date | Day | Start Time | Time | Title | Category | keyword |
|---|---|---|---|---|---|---|
| 2000.09.01 | Friday | 20:00:00 | 0:30:00 | News/Stock Price | 6 | Sato |
| | | | | Commentary | | |
| 2000.09.01 | Friday | 20:00:00 | 0:30:00 | AA News | 6 | Nakamura |
| 2000.09.01 | Friday | 20:00:00 | 0:30:00 | DD Music | 4 | Kitayama |
| 2000.09.01 | Friday | 20:00:00 | 2:00:00 | CC Japanese | 1 | Yamada |
| | | | | Movie Theater | | |
| 2000.09.01 | Friday | 20:00:00 | 1:00:00 | DD Quiz | 7 | Maeda |
| 2000.09.01 | Friday | 20:00:00 | 1:00:00 | BB Count Down | 4 | Kitagawa |
| 2000.09.01 | Friday | 20:00:00 | 0:30:00 | CC Angler DD | 8 | Suzuki |
| 2000.09.01 | Friday | 20:00:00 | 1:00:00 | CC Challenge | 7 | Takada |
| 2000.09.01 | Friday | 20:00:00 | 1:00:00 | AA Featuring | A | Murakami |
| 2000.09.01 | Friday | 20:00:00 | 1:00:00 | DD Professional | 3 | Funaki |
| | | | | Wrestling | | |
| 2000.09.01 | Friday | 20:30:00 | 0:30:00 | BB Introduction | 9 | Hara |
| 2000.09.01 | Friday | 20:30:00 | 0:30:00 | News & Sports BB | 6 | Harada |
| 2000.09.01 | Friday | 20:30:00 | 0:30:00 | Olympics EE | 3 | Takahashi |

It should be noted that, when extracting the secondary temporary program group from the primary temporary program group, the program start time is used as the reference of classification for those programs of which length of broadcast time is 2 hours starting at 21:00, such as “BB Foreign Movie Theater.” Therefore, “BB Foreign Movie Theater” is classified into the secondary temporary program group in time zone 21:00 to 22:00.

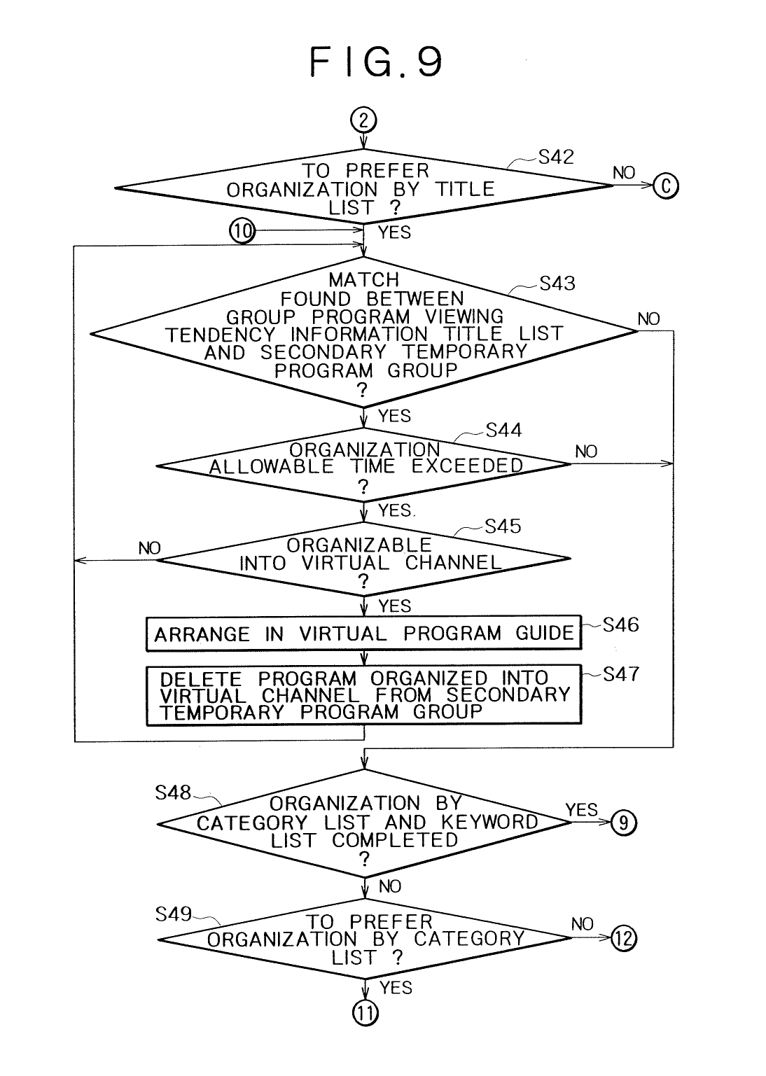

In step S15, when organizing programs into virtual channels on the basis of user program viewing tendency information and group program viewing tendency information, the controller 15 determines whether to give priority to the user program viewing tendency information over the group program viewing tendency information. If the user program viewing tendency information is given priority, the procedure goes to step S16; otherwise the procedure goes to step S42 of FIG. 9. To which of the user program viewing tendency information and the group program viewing tendency information priority is given is determined by the policy values inputted in step S1, priority being given to the information having the higher values.

For example, if the policy values of the user program viewing tendency information and the group program viewing tendency information are 70% and 30% respectively, then the user program viewing tendency information is given priority, upon which the procedure goes to step S16.

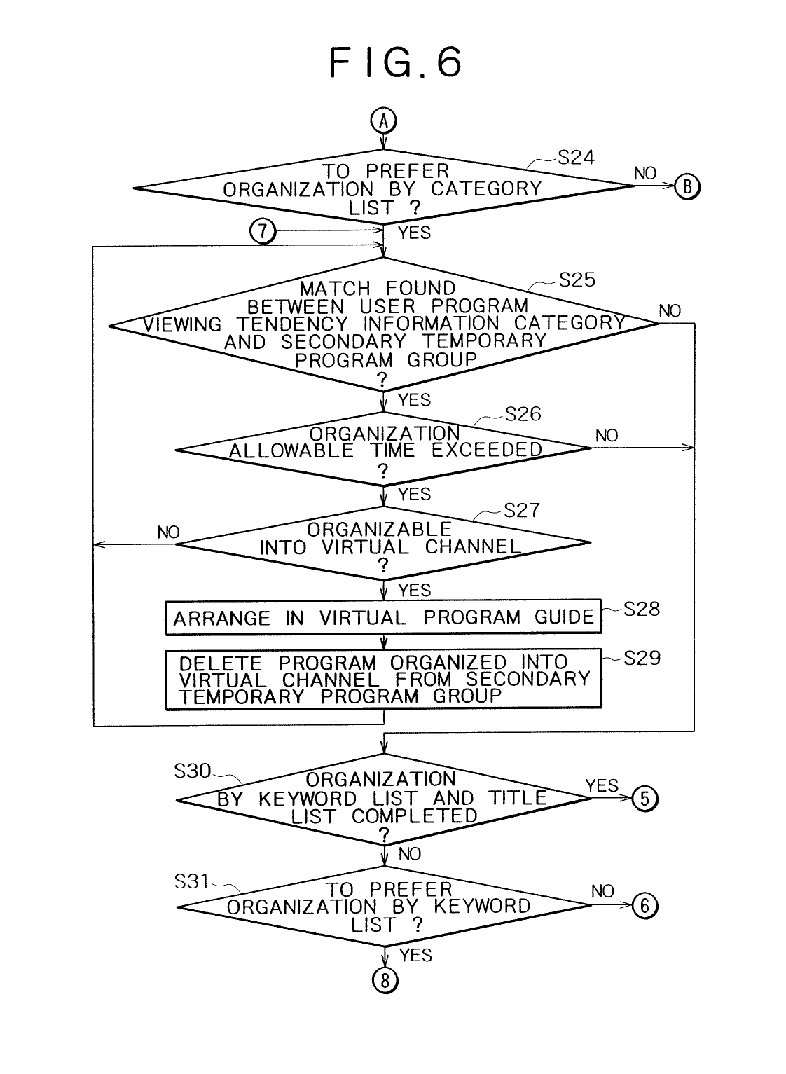

In step S16, when organizing programs into virtual channel on the basis of the title list, category list, and keyword list of the user program viewing tendency information, the controller 15 determines whether to give priority to the title list over the category list and the keyword list. To give priority to the title list, the procedure goes to step S17; otherwise, the procedure goes to step S24 shown in FIG. 6. Whether to give priority to the title list, the category list, or the keyword list is determined by the policy values inputted in step S1, priority being given to the list having the highest policy value.

For example, if the policy values of the title list, the category list, and the keyword list are 50%, 30%, and 20% respectively, priority is given to the title list, upon which the procedure goes to step S17.

In step S17, the controller 15 compares the programs in the title list of the user program viewing tendency information with the secondary temporary program group. If a matching program is found, the controller 15 retrieves its program information, upon which the procedure goes to step S18; otherwise, the procedure goes to step S22.

For example, the title list shown in Table 3 is used for the title list of the user program viewing tendency information. Because “News/Stock Price Commentary” having the highest value in Table 3 is listed in the secondary temporary program group shown in Table 23, the controller 15 retrieves the program information of this program, upon which the procedure goes to step S18.

In step S18, if the program of which program information was retrieved in step S17 is to be organized into a virtual channel, the controller 15 determines whether the organization allowable time of the title list computed in step S12 is exceeded or not. To be more specific, the length of broadcast time of the program of which program information was retrieved is subtracted from the organization allowable time and, if a negative value results, it is determined that the organization allowable time is exceeded.

If the organization allowable time is not exceeded, the procedure goes to step S19; otherwise, the procedure goes to step S22.

For example, if the program information of “News/Stock Price Commentary” was retrieved in step S18, the controller 15 subtracts the length of broadcast time, 30 minutes, of “News/Stock Price Commentary” from the organization allowable time, 240 minutes, of the title list obtained in step S12. Because 210 minutes of the organization allowable time remains, the procedure goes to step S19.

In step S19, the controller 15 computes a virtual channel free area and compares the computed free area with the length of broadcast time of the program obtained from its program information retrieved in step S17, thereby determining whether this program can be organized into a virtual channel. If the program is found organizable, the procedure goes to step S20; otherwise, the procedure goes to step S22.

For example, when organizing 30-minute “News/Stock Price Commentary” which starts at 20:00 into a virtual channel, only 30-minute “AA Science” starting at 20:30 is arranged in time zone 20:00 of VC-1 having the lowest number, so that “News/Stock Price Commentary” can be organized into VC-1, upon which the procedure goes to step S20.

In step S20, the controller 15 organizes the program into the virtual channel and arranges the program information of this program into the virtual program guide.

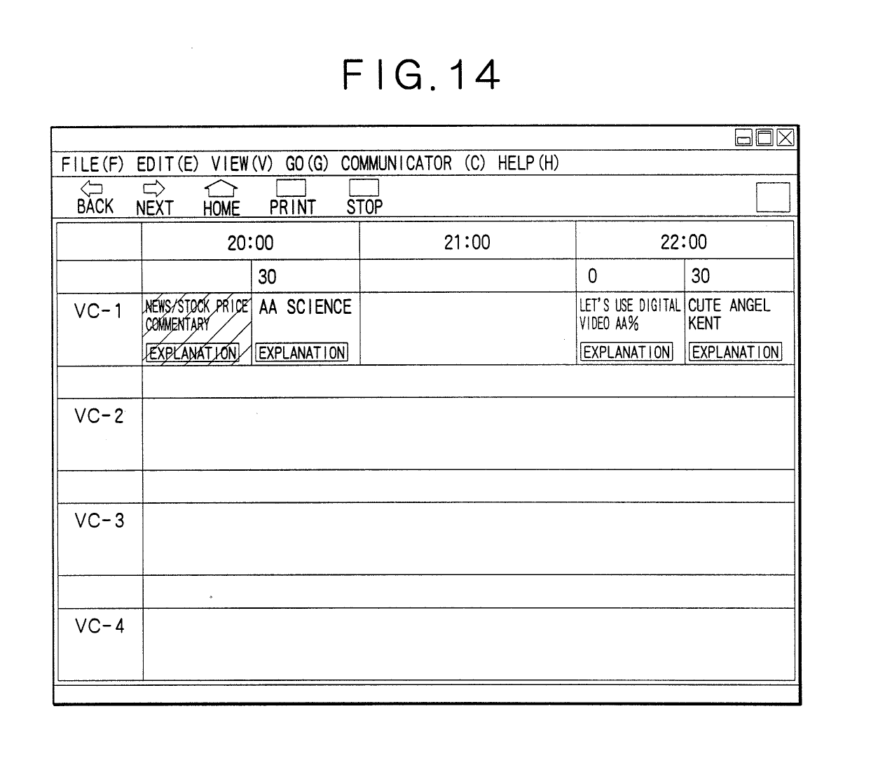

For example, “News/Stock Price Commentary” is organized into VC-1 and its program information is arranged in the virtual program guide as indicated by hatching shown in FIG. 14.

In step S21, the controller 15 deletes the program information of the program organized into the virtual channel in step S20 from the secondary temporary program group. For example, the program information of “News/Stock Price Commentary” in the secondary temporary program group listed in Table 23 is deleted.

When the process of step 21 has been completed, the procedure goes to step S17.

By repeating the processes of steps S17 through S21 from the secondary temporary program group shown in Table 23 and the title list shown in Table 3, the controller 15 organizes “AA News” of which start time is 20:00:00 into VC-2 and arranges its program information in the virtual program guide. It should be noted that the organization allowable time of the title list is 190 minutes at this point of time.

In step S22, the controller 15 determines whether the program organization into virtual channel based on the category list and the keyword list has been completed. If the organization has been completed, the procedure goes to step S23; otherwise, the procedure goes to step S39.

In step S23, the controller 15 determines whether to give priority to the program organization into virtual channel based on the category list over the organization based on the keyword list. If priority is given to the organization based on the category list, the procedure goes to step S25; otherwise, the procedure goes to step S32.

The priority between the category list and the keyword list is determined by the policy values inputted in step S1, priority being given to the list having the higher policy value. For example, if the policy values of the category list and the keyword list are 30% and 20% respectively, priority is given to the category list, upon which the procedure goes to step S25.

If the program organization into virtual channel based on the category list and the keyword list has already been executed, the one not executed is selected. For example, even if the policy value of the category list is 30% and the policy value of the keyword list is 20% as mentioned above, and if the program organization into virtual channel has already been made on the basis of the category list, priority is given to the keyword list, upon which the procedure goes to step S32.

The processes of steps S24 through S31 are shown in FIG. 6.

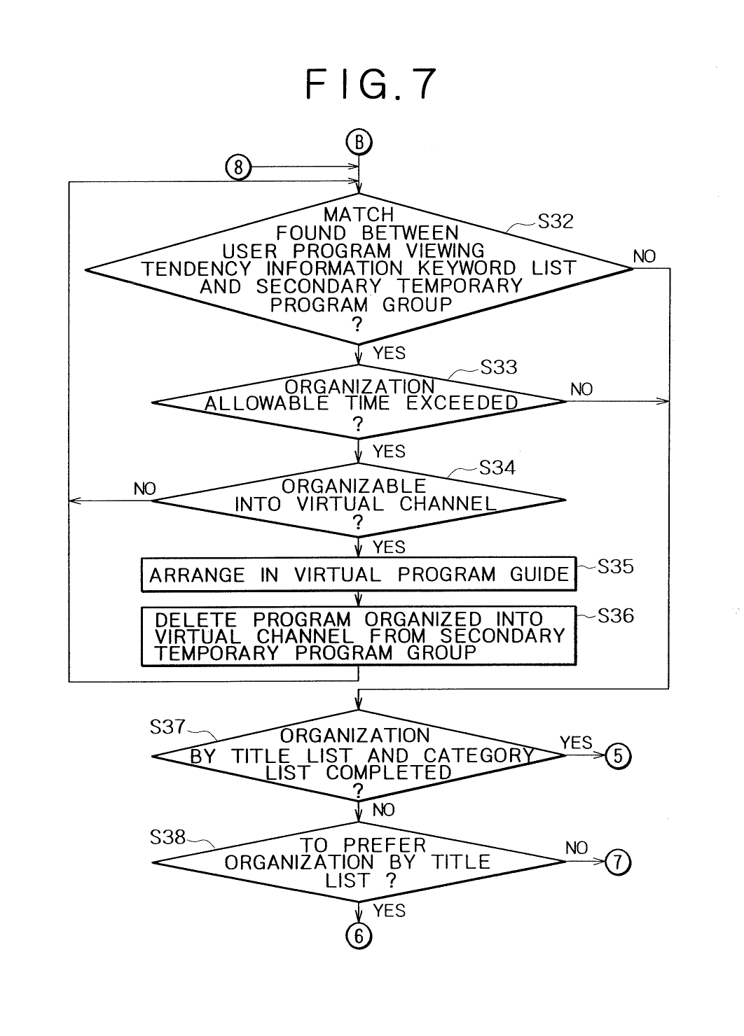

In step S24, the controller 15 determines whether to give priority to the program organization into virtual channel by the category list of the user program viewing tendency information over the program organization into virtual channel by the keyword list. To give priority to the category list, the procedure goes to step S25. To give priority to the keyword list, the procedure goes to step S32 shown in FIG. 7. Step S24 is executed only when not to give priority to the program organization into virtual channel by the title list of the user program viewing tendency information.

In step S25, the controller 15 compares the programs in the category list of the user program viewing tendency information with the secondary temporary program group. If a matching program is found, the controller 15 retrieves the program information of this program, upon which the procedure goes to step S26; otherwise, the procedure goes to step S30.

For example, assume that the category list of the user program viewing tendency information be the category list shown in Table 4. Table 24 shows a secondary temporary program group obtained by deleting the program information of the program organized into virtual channel from the secondary temporary program group shown in Table 23.

TABLE 24

| Date | Day | Start Time | Time | Title | Category | keyword |
|---|---|---|---|---|---|---|
| 2000.09.01 | Friday | 20:00:00 | 0:30:00 | DD Music | 4 | Kitayama |
| 2000.09.01 | Friday | 20:00:00 | 2:00:00 | CC Japanese | 1 | Yamada |
| | | | | Movie Theater | | |
| 2000.09.01 | Friday | 20:00:00 | 1:00:00 | DD Quiz | 7 | Maeda |
| 2000.09.01 | Friday | 20:00:00 | 1:00:00 | BB Count Down | 4 | Kitagawa |
| 2000.09.01 | Friday | 20:00:00 | 0:30:00 | CC Angler DD | 8 | Suzuki |
| 2000.09.01 | Friday | 20:00:00 | 1:00:00 | CC Challenge | 7 | Takada |
| 2000.09.01 | Friday | 20:00:00 | 1:00:00 | AA Featuring | A | Murakami |
| 2000.09.01 | Friday | 20:00:00 | 1:00:00 | DD Professional | 3 | Funaki |
| | | | | Wresting | | |
| 2000.09.01 | Friday | 20:30:00 | 0:30:00 | BB Introduction | 9 | Hara |
| 2000.09.01 | Friday | 20:30:00 | 0:30:00 | News & Sports BB | 6 | Harada |
| 2000.09.01 | Friday | 20:30:00 | 0:30:00 | Olympics EE | 3 | Takahashi |

The program categorized into “News/Report” having category number 6, the highest value in Table 4, is “News&Sports BB” of which start time is 20:30:00 in the secondary temporary list shown in Table 24. The controller 15 retrieves the program information of this program, upon which the procedure goes to step S26.

In step S26, if the controller 15 organizes the program of which program information was retrieved in step S25 into a virtual channel, the controller 15 determines whether the organization allowable time of the title list computed in step S12 is exceeded or not. To be more specific, for example, the length of broadcast time of the program of which program information was retrieved is subtracted from the organization allowable time and, if a negative value results, the controller 15 determines that the organization allowable time is exceeded. If the organization allowable time is not exceeded, the procedure goes to step S27; otherwise, the procedure goes to step S30.

For example, if the controller 15 retrieved the program information of “News&Sports BB” in step S25, the controller 15 subtracts the length of broadcast time 30 minutes of “News&Sports BB” from the organization allowable time 120 minutes of the category list computed in step S12. Because the result of the subtraction is 90 minutes, the procedure goes to step S27.

In step S27, the controller 15 computes a virtual channel free area and compares the computed free area with the length of broadcast time of the program obtained from the program information retrieved in step S25, thereby determining whether the program can be organized into a virtual channel. If the program is found organizable, the procedure goes to step S28; otherwise, the procedure goes to step S25.

For example, organizing “News&Sports BB”, a 30-minute program starting at 20:30, into virtual channel VC-1 is impossible because, VC-1 has already been arranged with “News/Stock Price Commentary” starting at 20:00 and 30-minute “AA Science” starting at 20:30. However, VC-2 has been arranged with only 30-minute “News/Stock Price Commentary” starting at 20:00, so that 30-minute “News/Stock Price Commentary” can be organized into VC-2. Then, the procedure goes to step S28.

In step S28, the controller 15 organizes the program into the virtual channel and arranges its program information in the virtual program guide.

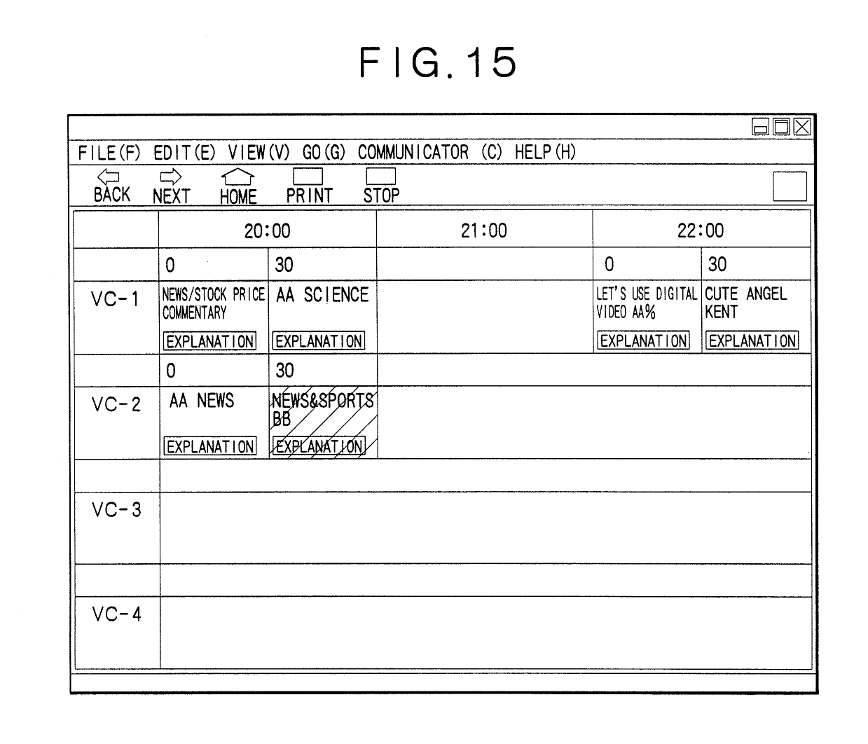

For example, “News&Sports BB” is organized in the virtual channel VC-2 and the program information is arranged as shown in the hatched portion in FIG. 15.

In step S29, the controller 15 deletes the program information of the program organized into the virtual channel in step S28 from the secondary temporary program group. For example, the program information of “News&Sports BB” is deleted from the secondary temporary program group shown in Table 24.

When the process of step 29 has been completed, the procedure returns to step S25.

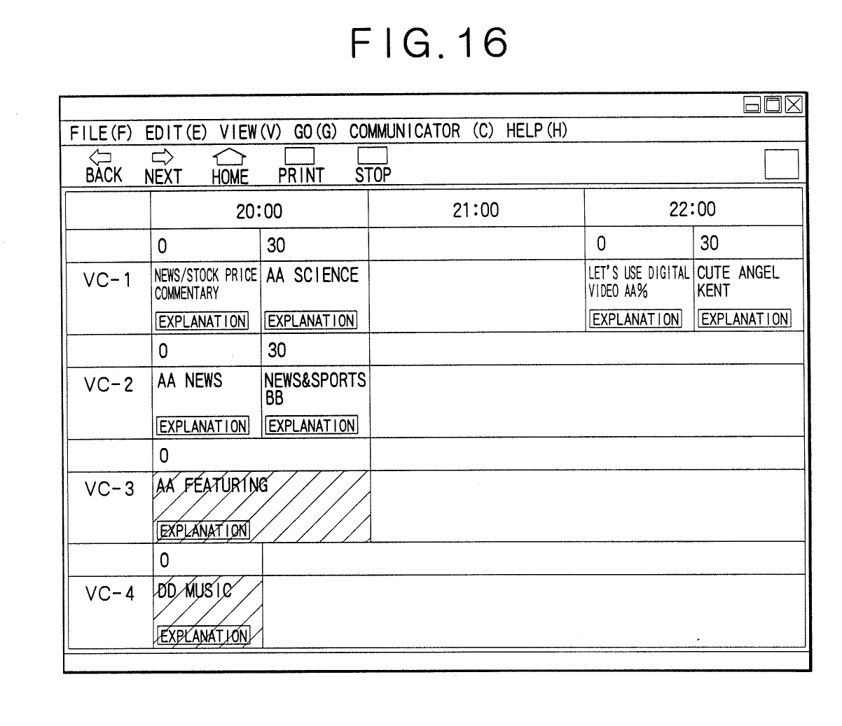

The controller 15 repeats steps S25 through S29 from secondary temporary program group shown in Table 24 the category list shown in Table 4 to organize “AA Featuring” of which start time is 20:00:00 selected on the basis of “Culture/Documentary” having category number A into VC-3 and “DD Music” of which start time is 20:00:00 selected on the basis of “Music” having category number 4 into VC-4. Then, the controller 15 arranges the program information of these organized programs into the virtual program guide as shown by hatched portions in FIG. 16. It should be noted that the organization allowable time of the category list at this point of time is 0 minute.

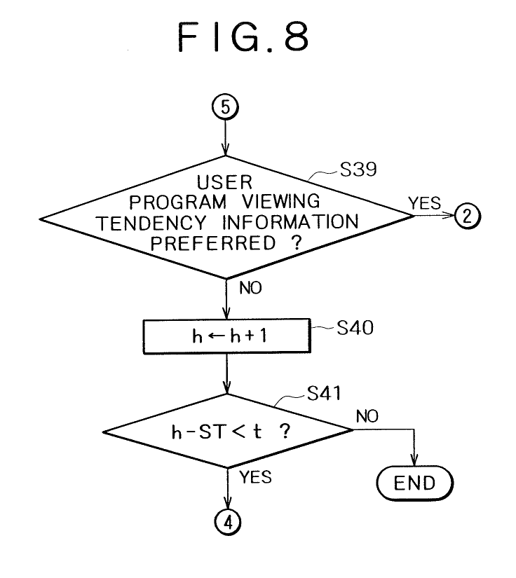

In step S30, the controller 15 determines whether the program organization based on the keyword list and the title list into virtual channel has been completed or not. If the organization is found not completed, the procedure goes to step S31; otherwise, the procedure goes to step S39 shown in FIG. 8.

In step S31, the controller 15 determines whether to give priority to the program organization by the keyword list of the user program viewing tendency information over the program organization by the title list. If the program organization by the keyword list is to be prioritized, the procedure goes to step S32; otherwise, the procedure goes to step S17 of FIG. 5.

The priority between the keyword list and the title list is determined by the policy values inputted in step S1, priority being given to the list having the higher policy value. For example, if the policy values of the keyword list and the title list are 20% and 50% respectively, priority is given to the title list, upon which the procedure goes to step S17.

If the program arrangement into virtual channel based on the keyword list or the title list has already been executed, the one not executed is selected. For example, even if the policy value of the title list is 50% and the policy value of the keyword list is 30% as mentioned above, and if the program arrangement into virtual channel has already been made on the basis of the title list, priority is given to the keyword list, upon which the procedure goes to step S32.

The processes of steps S32 through S38 are shown in FIG. 7.

In step S32, the controller 15 compares the programs in the keyword list of the user program viewing tendency information with the secondary temporary program group. If a matching program is found, the controller 15 retrieves the program information of this program, upon which the procedure goes to step S33; otherwise, the procedure goes to step S37.

For example, assume that the category list of the user program viewing tendency information be the category list shown in Table 5. Table 25 shows a secondary temporary program group obtained by deleting the program information of the program organized into virtual channel in step S29 from the secondary temporary program group shown in Table 24.

TABLE 25

| Date | Day | Start Time | Time | Title | Category | keyword |
|---|---|---|---|---|---|---|
| 2000.09.01 | Friday | 20:00:00 | 2:00:00 | CC Japanese | 1 | Yamada |
| | | | | Movie Theater | | |
| 2000.09.01 | Friday | 20:00:00 | 1:00:00 | DD Quiz | 7 | Maeda |
| 2000.09.01 | Friday | 20:00:00 | 1:00:00 | BB Count Down | 4 | Kitagawa |
| 2000.09.01 | Friday | 20:00:00 | 0:30:00 | CC Angler DD | 8 | Suzuki |
| 2000.09.01 | Friday | 20:00:00 | 1:00:00 | CC Challenge | 7 | Takada |
| 2000.09.01 | Friday | 20:00:00 | 1:00:00 | DD Professional | 3 | Funaki |
| | | | | Wresting | | |
| 2000.09.01 | Friday | 20:30:00 | 0:30:00 | BB Introduction | 9 | Hara |
| 2000.09.01 | Friday | 20:30:00 | 0:30:00 | Olympics EE | 3 | Takahashi |

Because Table 25 lists no program that is categorized into keyword “Sato” having the highest value in Table 5, the procedure goes to step S37.

In step S33, if the program of the program information retrieved in step S32 is to be organized into a virtual channel, the controller 15 determines whether the organization allowable time of the title list computed in step S12 is exceeded or not. To be more specific, for example, the length of broadcast time of the program of which program information was retrieved is subtracted from the organization allowable time and, if a negative value results, the controller 15 determines that the organization allowable time is exceeded. If the organization allowable time is not exceeded, the procedure goes to step S34; otherwise, the procedure goes to step S37.

In step S34, the controller 15 computes a virtual channel free area and compares the computed free area with the length of broadcast time of the program obtained from the program information retrieved in step S25, thereby determining whether the program can be arranged into a virtual channel. If the program is found arrangeable, the procedure goes to step S35; otherwise, the procedure goes to step S32.

In step S35, the controller 15 organizes the program into the virtual channel and arranges its program information into the virtual program guide.

In step S36, the controller 15 deletes the program information of the program organized into the virtual channel in step S35 from the secondary temporary program group. When the process of step S36 has been completed, the procedure goes to step S32.

In step S37, the controller 15 determines whether the program organization based on the title list and the category list into virtual channel has been completed or not. If the organization is found not completed, the procedure goes to step S38; otherwise, the procedure goes to step S39 shown in FIG. 8.

For example, if the program has been organized into the virtual channel on the basis of the title list and then the program has been organized into the virtual channel on the basis of the category list, the procedure goes to step S39.

In step S38, the controller 15 determines whether to give priority to the program organization by the title list over the program organization by the category list. If the program organization by the title list is to be prioritized, the procedure goes to step S17 of FIG. 5; otherwise, the procedure goes to step S25 of FIG. 6.

The priority between the title list and the category list is determined by the policy values inputted in step S1, priority being given to the list having the higher policy value. For example, if the policy values of the title list and the category list are 50% and 30% respectively, priority is given to the title list, upon which the procedure goes to step S17 of FIG. 5.

If the program organization into virtual channel based on the title list or the category list has already been executed, the one not executed is selected. For example, even if the policy value of the title list is 50% and the policy value of the category list is 30% as mentioned above, and if the program arrangement into virtual channel has already been made on the basis of the title list, priority is not given to the title list, upon which the procedure goes to step S25 of FIG. 6.

The processes of steps S39 through S41 are shown in FIG. 8.

In step S39, the controller 15 determines whether to give priority to the user program viewing tendency information over the group program viewing tendency information. If the user program viewing tendency information is prioritized, the procedure goes to step S40; otherwise, the procedure goes to step S42 shown in FIG. 9. The priority between the user program viewing tendency information and the group program viewing tendency information is determined by the policy values inputted in step S1, priority being given to the information having the higher policy value. For example, if the policy values of the user program viewing tendency information and the group program viewing tendency information are 70% and 30% respectively, then priority is given to the user program viewing tendency information, upon which the procedure goes to step S42 of FIG. 9.

In step S40, the controller 15 sets virtual program guide start time h to h+1 o'clock, proceeding to steps of the program organization into virtual channel of the next time zone. For example, if h=20:00, then the controller 15 sets h to 21:00.

In step S41, the controller 15 determines whether the number of hours t for creating the virtual program guide inputted in step S1 is exceeded or not. If the number of hours t is found not exceeded, the procedure returns to step S14 of FIG. 5; otherwise, the creation of the virtual program guide comes to an end.

For example, if the number of hours t=3, ST=20:00, and h=21:00, then h−ST=21−20=1<3, so that the procedure returns to S14.

The processes of steps 42 through S49 are shown in FIG. 9.

Before executing the processes from step S42, there are two processes depending on the policy values inputted in step S1 shown in FIG. 3. For example, if the policy value of the user program viewing tendency information is higher than that of the group program viewing tendency information, then the program organization into virtual channel on the basis of the title list, category list, and the keyword list of the user program viewing tendency information and the arrangement of the program information of that program into the virtual program guide are executed before executing the program organization into virtual channel and the arrangement of the program information into the virtual program guide on the basis of the group program viewing tendency information in step S42.

On the other hand, if the policy value of the group program viewing tendency information is higher than that of the user program viewing tendency information, then the program organization into virtual channel and the arrangement of the program information into the virtual program guide on the basis of the group program viewing tendency information starting with step S42 are executed.

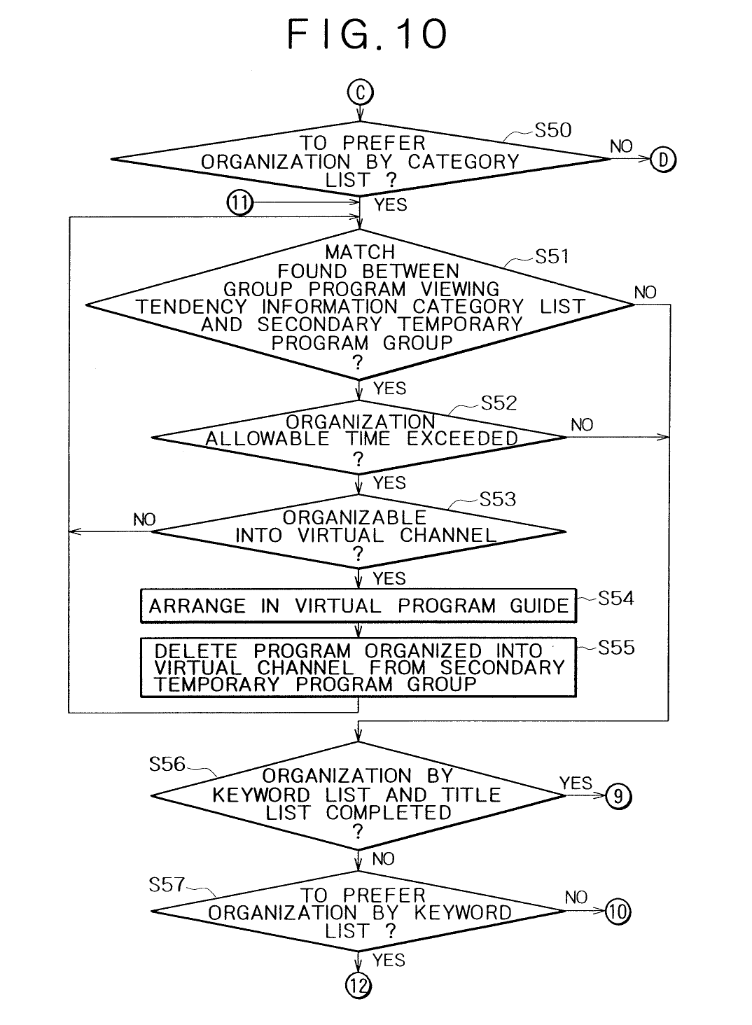

In step S42, when executing the program organization into virtual channel on the basis of the title list, category list, and keyword list of the group program viewing tendency information, the controller 15 determines whether to give priority to the title list over the category list and the keyword list. If the title list is to be prioritized, the procedure goes to step S43; otherwise, the procedure goes to step S50 shown in FIG. 10. The priority between title list, category list, and keyword list is determined by the policy values inputted in step S1, priority being given to the list having the highest value.

For example, if the policy values of title list, category list, and keyword list are 50%, 30%, and 20% respectively, the title list is prioritized, upon which the procedure goes to step S43.

In step S43, the controller 15 compares the programs in the title list of the group program viewing tendency information with the secondary temporary program group. If a matching program is found, the controller 15 retrieves its program information, upon which the procedure goes to step S44; otherwise, the procedure goes to step S48.

For example, assume that the title list of the group program viewing tendency information be the title list shown in Table 12. And assume that Table 25 be used as a secondary temporary program group.

Because “DD Professional Wrestling” having the highest value in Table 12 is listed in the secondary temporary program group in Table 25, the controller 15 retrieves its program information, upon which the procedure goes to step S44.

In step S44, if the program retrieved in step S43 is to be organized into a virtual channel, the controller 15 determines whether the organization allowable time of the title list computed in step S12 of FIG. 5 is exceeded or not. To be more specific, for example, the length of broadcast time of the program is subtracted from the organization allowable time and, if a negative value results, the controller 15 determines that the organization allowable time is exceeded. If the organization allowable time is found not exceeded, the procedure goes to step S45; otherwise, the procedure goes to step S48.

For example, when “DD Professional Wrestling” was retrieved in step S43, the controller 15 subtracts the length of broadcast time, 60 minutes, of “DD Professional Wrestling” from the organization allowable time, 90 minutes, of the title list computed in step S12. The subtraction result is 30 minutes, so that the procedure goes to step S45.

In step S45, the controller 15 computes a virtual channel free area and compares the computed free area with the length of broadcast time obtained from the program information retrieved in step S43, thereby determining whether the program can be organized into a virtual channel. If the program is found organizable, the procedure goes to step S47; otherwise, the procedure goes to step S43.

For example, assume that the 60-minute “DD Professional Wrestling” starting from 20:00 be organized into a virtual channel. Because the virtual channel free area in 20:00 is found in the 30 minutes from 20:30 in VC-4, “DD Professional Wrestling” cannot be organized in any virtual channel, upon which the procedure returns to step S43.

In step S46, the controller 15 organizes the program into the virtual channel and arranges its program information into the virtual program guide.

In step S47, the controller 15 deletes the program information of the program organized into the virtual channel in step S46 from the second temporary program group. When step S47 has been completed, the procedure goes to step S43.

Because no matching program is found between the secondary temporary program group shown in Table 25 and the title list, the controller 15 does not execute the program organization into virtual channel on the basis of the title list of the group program viewing tendency information.

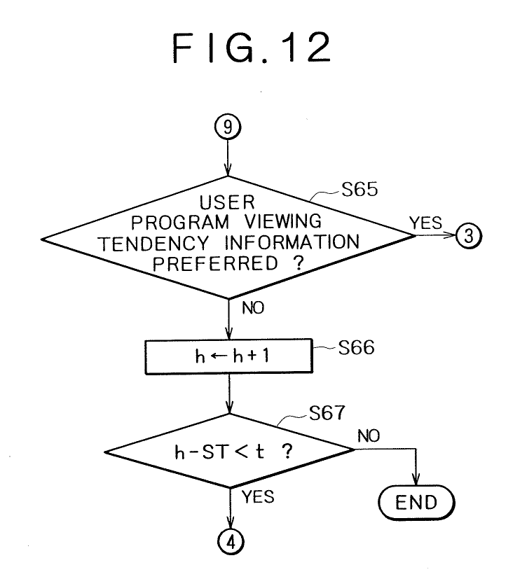

In step S48, the controller 15 determines whether the program organization into virtual channel on the basis of the category list and keyword list has been completed or not. If the program organization is found not completed, the procedure goes to step S49; otherwise, the procedure goes to step S65 shown in FIG. 12.

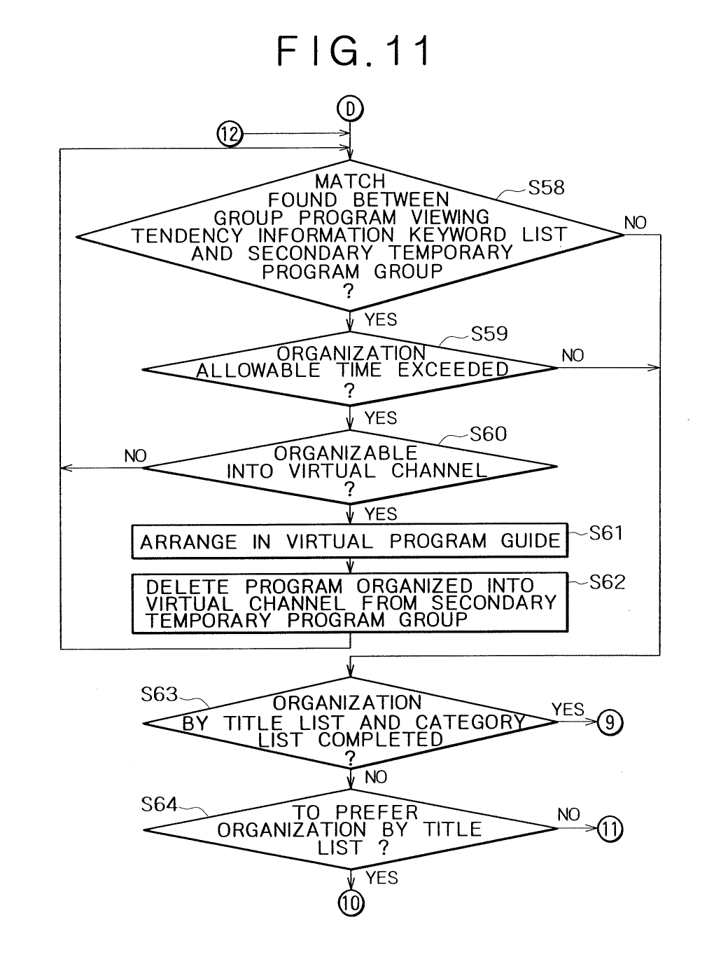

In step S49, the controller 15 determines whether to give priority to the program organization into virtual channel on the basis of the category list of the group program viewing tendency information over the program organization on the basis of the keyword list. If priority is given to the program organization on the basis of the category list, the procedure goes to step S51 shown in FIG. 10; otherwise, the procedure goes to step S58 shown in FIG. 11.

The priority between the category list and the keyword list is determined by the policy values inputted in step S1, priority being given to the list having the higher policy value. For example, if the policy values of the category list and the keyword list are 30% and 20% respectively, the category list is prioritized, upon which the procedure goes to step S51.

If the program organization into virtual channel based on the category list or the keyword list has already been executed, the one not executed is selected. For example, even if the policy value of the category list is 30% and the policy value of the keyword list is 20% as mentioned above, and if the program organization into virtual channel has already been made on the basis of the category list, priority is not given to the category list, upon which the procedure goes to step S58 of FIG. 11.

The processes of steps S50 through S57 are shown in FIG. 10.

In step S50, the controller 15 determines whether to give priority to the program organization into virtual channel by the category list of the group program viewing tendency information over that by the keyword list. If priority is given to the program organization by the category list, then the procedure goes to step S51. If priority is given to the program organization by the keyword list, then the procedure goes to step S58 shown in FIG. 11.

Step S49 is executed only when priority is not given to the program organization into virtual channel by the title list of the group program viewing tendency information in step S16 of FIG. 5.

In step S51, the controller 15 compares the programs in the category list of the group program viewing tendency information with the secondary temporary program group. If a matching program is found, the controller 15 retrieves its program information, upon which the procedure goes to step S52; otherwise, the procedure goes to step S56.

For example, assume that the category list of the group program viewing tendency information be the category list shown in Table 13. And assume that Table 25 be used as a secondary temporary program group.

The programs categorized into “Sports 2” having the highest category number 3 in Table 13 are “DD Professional Wrestling” of which start time is 20:00:00 and “Olympics EE” of which start time is 20:30:00 in the secondary temporary program group shown in Table 25. Since “DD Professional Wrestling” is found not organizable in step S45, the controller 15 retrieves the program information of “Olympics EE,” upon which the procedure goes to step S52.

In step S52, when organizing the program retrieved in step S51 into a virtual channel, the controller 15 determines whether the organization allowable time of the title list computed in step S12 of FIG. 5 is exceeded or not. To be more specific, for example, the length of broadcast time of the retrieved program is subtracted from the organization allowable time. If a negative value results, the controller 15 determines that the organization allowable time is exceeded. If the organization allowable time is found not exceeded, the procedure goes to step S53; otherwise, the procedure goes to step S56.

For example, if the program information of “Olympics EE” was retrieved in step S51, the controller 15 subtracts the length of broadcast time, 30 minutes, of “Olympics EE” from the organization allowable time, 60 minutes, of the category list computed in step S12. Because the subtraction result is 30 minutes, the controller 15 determines that the organization allowable time is not exceeded, upon which the procedure goes to step S53.

In step S53, the controller 15 computes a virtual channel free area and compares the computed free area with the length of broadcast time of the program obtained from its program information retrieved in step S51, thereby determining whether the program can be organized into a virtual channel or not. If the program is found organizable, the procedure goes to step S54; otherwise, the program returns to step S51.

For example, when organizing 30-minute “Olympics EE” starting at 20:30 into a virtual channel, a free area of 30 minutes is found in VC-4 starting at 20:30, so that this program can be organized into VC-4. Therefore, the procedure goes to step S54.

In step S54, the controller 15 organizes the program into the virtual channel and arranges its program information into the virtual program guide.

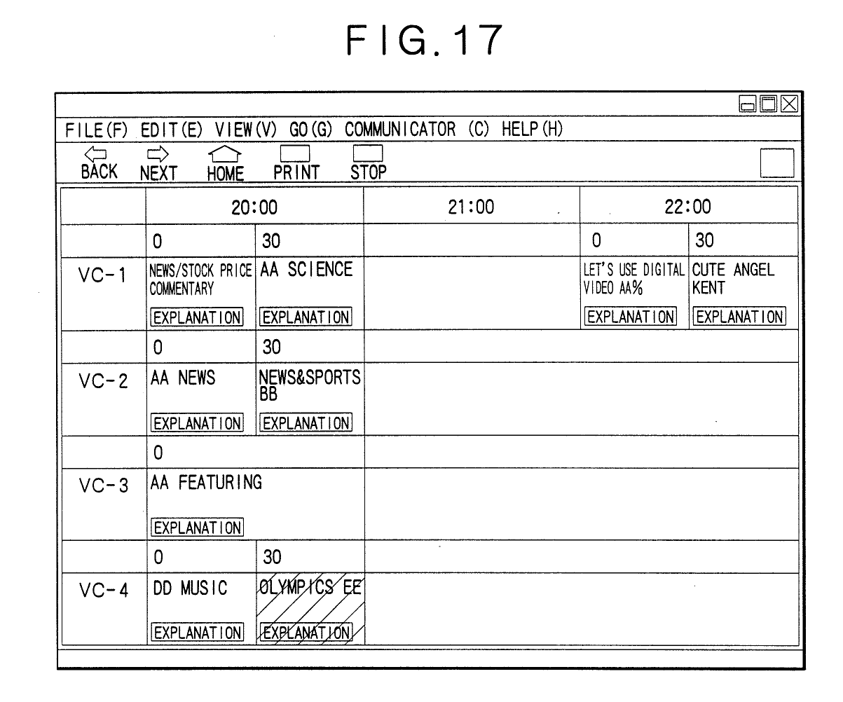

For example, the controller 15 organizes “Olympics EE” into VC-4 and arranges the program information into the virtual program guide as indicated by the hatched portion shown in FIG. 17.

In step S55, the controller 15 deletes the program information of the program organized into the virtual channel in step S54 from the secondary temporary program group. For example, the program information of “Olympics EE” is deleted from the secondary temporary program group shown in Table 25 to provide Table 26.

TABLE 26

| Date | Day | Start Time | Time | Title | Category | keyword |
|---|---|---|---|---|---|---|
| 2000.09.01 | Friday | 20:00:00 | 2:00:00 | CC Japanese | 1 | Yamada |
| | | | | Movie Theater | | |
| 2000.09.01 | Friday | 20:00:00 | 1:00:00 | DD Quiz | 7 | Maeda |
| 2000.09.01 | Friday | 20:00:00 | 1:00:00 | BB Count Down | 4 | Kitagawa |
| 2000.09.01 | Friday | 20:00:00 | 0:30:00 | CC Angler DD | 8 | Suzuki |
| 2000.09.01 | Friday | 20:00:00 | 1:00:00 | CC Challenge | 7 | Takada |
| 2000.09.01 | Friday | 20:00:00 | 1:00:00 | DD Professional | 3 | Funaki |
| | | | | Wresting | | |
| 2000.09.01 | Friday | 20:30:00 | 0:30:00 | BB Introduction | 9 | Hara |

When step S55 has been completed, the procedure returns to step S51.

Since there is no program which corresponds to the secondary temporary program group shown in Table 26 and the category list shown in Table 13, the controller 15 cannot organize any program into a virtual channel. It should be noted that the organization allowable time of the category list at this point of time is 30 minutes.

In step S56, the controller 15 determines whether the program organization into virtual channel on the basis of the keyword list and the title list has been completed or not. If the program organization is found not completed, then the procedure goes to step 57; otherwise, the procedure goes to step S65 shown in FIG. 12.

In step S57, the controller 15 determines whether to give priority to the program organization into virtual channel by the keyword list of the group program viewing tendency information over that by the title list. If priority is given to the program organization by the keyword list, the procedure goes to step S58 shown in FIG. 11; otherwise, the procedure goes to step S43 shown in FIG. 9.

The priority between the keyword list and the title list is determined by the policy values inputted in step S1, priority being given to the list having the higher policy value. For example, if the policy values of the keyword list and the title list are 20% and 50% respectively, the title list is prioritized, upon which the procedure goes to step S43 shown in FIG. 9.

If the program organization into virtual channel based on the keyword list or the title list has already been executed, the one not executed is selected. For example, even if the policy value of the title list is 50% and the policy value of the keyword list is 30% as mentioned above, and if the program organization into virtual channel has already been made on the basis of the title list, priority is given to the keyword list, upon which the procedure goes to step S51.

The processes of steps S58 through S64 are shown in FIG. 11.

In step S58, the controller 15 compares the programs in the keyword list of the group program viewing tendency information with the secondary temporary program group. If a matching program is found, the controller 15 retrieves its program information, upon which the procedure goes to step S59; otherwise, the procedure goes to step S63.

For example, assume that the category list of the group program viewing tendency information be the category list shown in Table 14. And assume that Table 26 be used as a secondary temporary program group.

Because no program having any keyword of the keyword list of Table 15 as program information is found in Table 26, the procedure goes to step S63.

In step S59, when organizing the program retrieved in step S58 into a virtual channel, the controller 15 determines whether the organization allowable time of the title list computed in step S12 of FIG. 5 is exceeded or not. To be more specific, for example, the length of broadcast time of the retrieved program is subtracted from the organization allowable time. If a negative value results, the controller 15 determines that the organization allowable time is exceeded. If the organization allowable time is found not exceeded, the procedure goes to step S60; otherwise, the procedure goes to step S63.

In step S60, the controller 15 computes a virtual channel free area and compares the computed free area with the length of broadcast time of the program obtained from its program information retrieved in step S58, thereby determining whether the program can be organized into a virtual channel or not. If the program is found organizable, the procedure goes to step S61; otherwise, the program returns to step S58.

In step S61, the controller 15 organizes the program into the virtual channel and arranges its program information into the virtual program guide.

In step S62, the controller 15 deletes the program information of the program organized into the virtual channel in step S61 from the secondary temporary program group.

When step S62 has been completed, the procedure returns to step S58.

In step S63, the controller 15 determines whether the program organization on the basis of the title list and the category list has been completed or not. If the program organization is found not completed, procedure goes to step S64. If the program organization is found completed, the procedure goes to step S65 shown in FIG. 12.

For example, if the program was first organized into a virtual channel on the basis of the title list and then the program was organized into the virtual channel on the basis of the category list, the procedure goes to step S65 shown in FIG. 12.

In step S64, the controller 15 determines whether to give priority to the program organization into virtual channel by the title list of the group program viewing tendency information over the program organization by the category list. If priority is given to the program organization by the title list, procedure goes to step S43 shown in FIG. 9; otherwise the procedure goes to step S51 shown in FIG. 10.

The priority between the title list and the category list is determined by the policy values inputted in step S1, priority being given to the list having the higher policy value. For example, if the policy values of the title list and the category list are 50% and 30% respectively, the title list is prioritized, upon which the procedure goes to step S43.

If the program organization into virtual channel based on the title list or the category list has already been executed, the one not executed is selected. For example, even if the policy value of the title list is 50% and the policy value of the category list is 30% as mentioned above, and if the program organization into virtual channel has already been made on the basis of the title list, priority is not given to the title list, upon which the procedure goes to step S51 shown in FIG. 10.

The process of steps S65 through S67 are shown in FIG. 12.

In step S65, the controller 15 determines whether priority has been given to the user program viewing tendency information over the group program viewing tendency information in step S15. If the user program viewing tendency information is found prioritized, the procedure goes to step S66; otherwise, the procedure goes to step S16 shown in FIG. 5. The priority between user program viewing tendency information and group program viewing tendency information is determined by the policy values inputted in step S1, priority being given to the higher value. For example, if the policy values of user program viewing tendency information and group program viewing tendency information are 70% and 30% respectively, then the user program viewing tendency information is prioritized, upon which the procedure goes to step S66.

In step S66, the controller 15 sets virtual program guide start time h to h+1 o'clock, proceeding to steps of the program organization into virtual channel of the next time zone. For example, if h=20:00, then the controller 15 sets h to 21:00.

In step S67, the controller 15 determines whether the number of hours t for creating the virtual program guide inputted in step S1 is exceeded or not. If the number of hours t is found not exceeded, the procedure returns to step S14 shown in FIG. 5; otherwise, the creation of the virtual program guide comes to an end.

For example, if the number of hours t=3, ST=20:00, and h=21:00, then h−ST=21−20=1<3, so that the procedure returns to S14.

In step S14, the controller 15 extracts the programs of which broadcast start times are from 21:00 to 22:00 from the primary temporary program group to provide a secondary temporary program group.

Thus, the controller 15 repeats the steps S14 through S67 to extract a secondary temporary program group from the primary temporary program group every hour, thereby organizing the programs into virtual channels on the basis of user program viewing tendency information and group program viewing tendency information and arranging their program information into the virtual program guide. For example, if the number of hours t of the virtual program guide is 3, then a desired virtual program guide can be created by repeating the above-mentioned processing loop three times.

For example, in a loop from 21:00 to 22:00, 60-minute “World AA Soccer” is organized in VC-1 at the position of 21:00 on the basis of user program viewing tendency information and then 120-minute “BB Foreign Movie Theater” is organized into VC-2 at the position of 21:00, their program information being arranged into the virtual program guide. Because there is no organization allowable time in the category list of user program viewing tendency information, the program organization into virtual channel is impossible. On the basis of the keyword list of user program viewing tendency information, 60-minute “Ruins BB Exploration” is organized into VC-3 at the position of 21:00, its program information being arranged in the virtual program guide.

Next, on the basis of the title list of group program viewing tendency information, 60-minute “Friday Drama BB” is organized into VC-4 at the position of 21:00, its program information being arranged into the virtual program guide. In the category list of group program viewing tendency information and the keyword list of group program viewing tendency information, all programs have already been organized in virtual channels in time zone 21:00, so that no further organization is allowed.

For example, in a loop from 22:00 to 23:00, because there is no organization allowable time in the title list and category list of user program viewing tendency information, the program organization into virtual channel is impossible. Therefore, on the basis of the keyword list of user program viewing tendency information, 30-minute “Bowling CC” is organized into VC-3 at the position of 22:30, its program information being arranged into the virtual program guide.

In the title list and category list of group program viewing tendency information, the organization allowable time is not enough for organizing any program into virtual channel. Therefore, on the basis of the keyword list of group program viewing tendency information, 30-minute “News BB” is organized into VC-4 at the position of 22:30, its program information being arranged into the virtual program list.

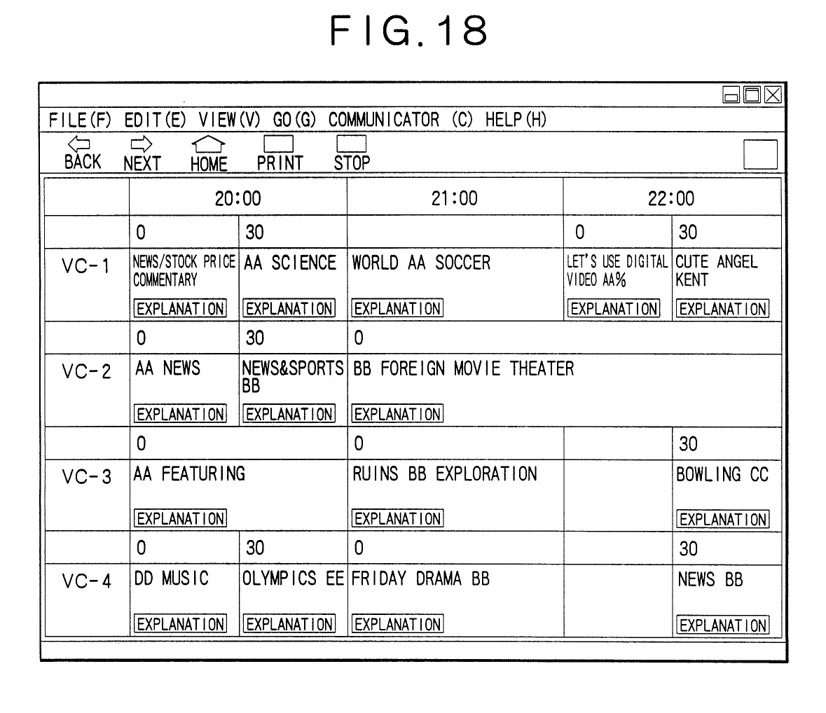

One example of the virtual program guide thus created by the processes shown in FIGS. 4 through 12 is shown in FIG. 18.

In the virtual program guide providing system 10, programs are organized into virtual channels from the user program viewing tendency information obtained from the user program viewing logs stored in the database 12 and from the group program viewing tendency information obtained from the program viewing logs stored in the database 12 of the users belonging to the group obtained by the classification made on the basis of the personal information stored in the database 13. Then, the program information of the organized programs is arranged on the basis of the virtual channels. Consequently, a virtual program guide suited for the preference of a user group to which a particular user belongs.

It should be noted that the controller 15 of the virtual program guide generating apparatus 20 can add channels organized with programs selected by an influential opinion leader or personalities representative of generations for example to virtual channels and provide a virtual program guide based on the program information of these programs to the user at the terminal apparatus 2.

The user can forcibly push other desired programs into virtual channels by inputting operation through the terminal apparatus 2 than those programs which are organized into virtual channels on the basis of the absolute viewing programs stored in the database 13, the user program viewing tendency information stored in the database 12, and the group program viewing tendency information stored in the database 14.

For example, an ordinary program guide arranged with ordinary channel program information is presented to the user through the terminal apparatus 2 and lets the user click “Must See” button in each program information box, upon which the controller 15 of the virtual program guide generating apparatus 20 forcibly organizes that specified program into a virtual channel. When a program is organized into a virtual channel by clicking “Must See” button, the specified program is organized into a time zone equivalent to the lowest virtual channel number.

The program forcibly organized into a virtual channel is reflected on user program viewing tendency information and group program viewing tendency information, incrementing the values of the title, category, and keyword of user program viewing tendency information and group program viewing tendency information.

The program service providing apparatus 6 having the virtual program guide generating apparatus 20 executes statistical processing by use of the user program viewing tendency information stored in the database 12 and the group program viewing tendency information stored in the database 14 which are used for generating a virtual program guide through the virtual program guide generating apparatus 20, thereby providing customer analysis information including the program viewing tendency classified by age, gender, and occupation for example.

The program service providing apparatus 6 provides this customer analysis information to the advertiser 4 by permission of the user to collect the information fee from the advertiser 4. The program service providing apparatus 6 appropriates the collected information fee for the funds for operating the virtual program guide providing system 10 or for the cut-down portion of the service usage charge to be collected from the terminal apparatus 2.

The advertiser 4 can get the customer analysis information by paying the information fee to the program service providing apparatus 6. With the obtained customer analysis information, the advertiser 4 can identify the programs in which to advertise or develop a new advertisement strategy.

Further, if a product advertised by the advertiser 4 through the program service providing apparatus 6 is purchased by the user of the terminal apparatus 2, the advertiser 4 may provide a part of the product sale cost to the program service providing apparatus 6.

The following describes a program preset recording service for presetting the recording of user-specified predetermined programs to a recording medium on the basis of the virtual program guide generated as described above.

The program preset recording service allows the user to record the programs listed in the virtual program guide to a recording medium in a predetermined recording apparatus or the terminal apparatus 2 by an easy method, the virtual program guide being generated by the virtual program guide generating apparatus 20 installed in the program service providing apparatus 6.

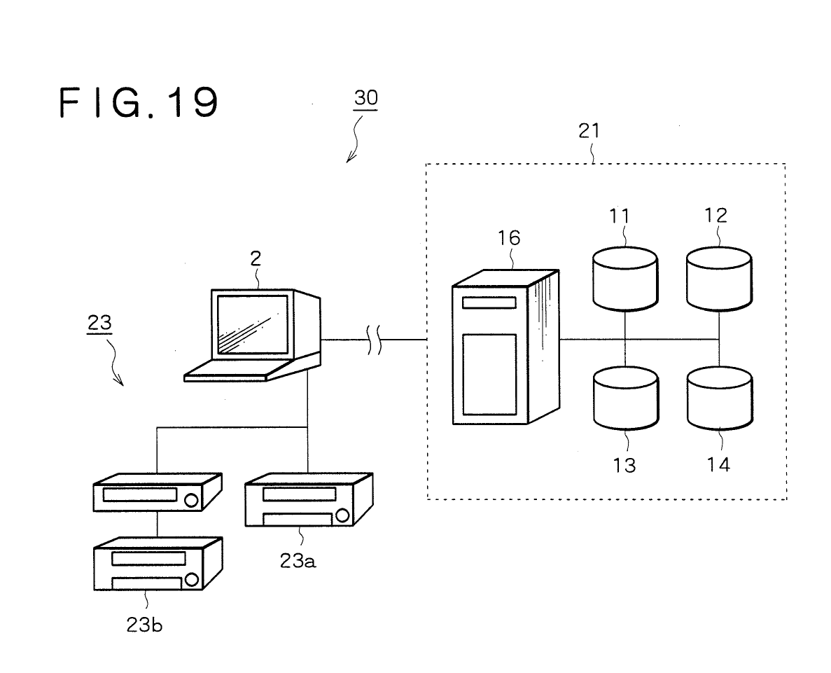

In order to provide the program preset recording service, the program service providing apparatus 6 constitutes a program recording system 30 by a program preset recording setting script generating apparatus 21 for generating commands for the preset recording of programs, the terminal apparatus 2, and a recording apparatus 23, as shown in FIG. 19.

The program preset recording setting script generating apparatus 21 has the databases 11, 12, 13, and 14 and a controller 16. To be more specific, the program preset recording setting script generating apparatus 21 has the databases 11, 12, 13, and 14 equipped on the virtual program guide generating apparatus 20 described with reference to the above-mentioned virtual program guide providing system 10 and the controller 16 obtained by adding a program preset recording setting script generating capability to the controller 15 of the virtual program guide generating apparatus 20.

The program preset recording setting script generating apparatus 21 generates a virtual program guide by following the processes described by the flowcharts shown in FIGS. 4 through 12 as described above. Then, the program preset recording setting script generating apparatus 21 generates a program preset recording setting script, which is a command for recording the generated virtual program guide to a recording medium, and sends the generated script to the terminal apparatus 2.

The following describes the program preset recording setting script. A program preset recording setting script is composed of a declaration statement for starting a program preset recording setting script, a command ID (Identification) for specifying a recording command, an infra ID, a channel number of a program to be broadcast, a program broadcast start time, a program broadcast end time (which may be replaced by the number of broadcast hours), a title of the program to be broadcast, and a declaration statement for specifying the end of the program preset recording setting script, for example. A program preset recording setting script is generated on the basis of virtual channels, but the user can customize the generated script. In addition to the virtual channel mode in which a program preset recording setting script, which is a control command for directly recording a program to be virtually broadcast in a virtual channel, is generated, there are two modes which are used to customize virtual channels.

Before describing these two virtual channel customizing modes, ordinary channels and preference channels will be described.

The ordinary channels are those contract channels and channels viewable by the user, among the channels having a predetermined frequency band.

A preference channel is one that is selected by the user from among ordinary channels in accordance with user's preference. For example, assume that there be 10 ordinary channels 1 through 10. Assume again that, of these channels, the user often view channel 3, which is movie only channel, and channel 5, which is news only channel. Assume that this user also often view channel 8, which is drama only channel. Then, assume that this user specify channel 3 and channel 8 as his preference channels. These specified channels are the preference channels of this user.

One of the two customizing modes is the preference channel mode in which the user can customize virtual channels by use of his preference channels. The preference channel mode allows the user to replace programs organized into virtual channels by programs to be broadcast in preference channels, by issuing a user command.

The other customizing mode is the ordinary channel mode for customizing virtual channels by use of ordinary channels. The ordinary channel mode allows the user to replace programs organized into virtual channels by programs to be broadcast in ordinary channels, by issuing a user command.

The terminal apparatus 2 incorporates a ground wave receiving tuner, a BS (Broadcasting Satellite) tuner, and a CS (Communications Satellite) tuner. Each of these tuners receives modulated programs transmitted by a carrier having a predetermined frequency and, demodulates the received programs into programs consisting of video and audio signals. The terminal apparatus 2 has a recording section for recording the received programs to a recording medium pre-installed in the recording section or a recording medium which is detachably loaded into the recording section. The recording medium is a magnetic tape, a magnetic disk, a magneto-optical disk, or an optical disk, for example. The terminal apparatus 2 receives a program preset recording setting script from the program preset recording setting script generating apparatus 21. The controller of the terminal apparatus 2 converts the received program preset recording setting script into a preset recording control signal suitable for the processing by the recording section and controls the recording section in accordance with the converted preset recording control signal to record it to the recording medium.

At the same time, the terminal apparatus 2, when transmitting a program preset recording setting script to the recording apparatus 23 specified in the program preset recording setting script, converts the program preset recording setting script into a control signal suitable for each recording apparatus 23. For example, the terminal apparatus 2 converts the program preset recording setting script into an IR (Infrared) control signal, a LAN (Local Area Network) control signal, or an iLINK (trademark) control signal.

The recording apparatus 23 incorporates a ground wave receiving tuner, a BS tuner, and a CS tuner. Each tuner receives modulated programs transmitted on a carrier having a predetermined frequency and demodulates the received programs into programs consisting of video and audio signals. The recording apparatus 23 has a recording section for recording the received programs to a recording medium pre-installed in the recording section or a recording medium which is detachably loaded into the recording section. The recording medium is a magnetic tape, a magnetic disk, a magneto-optical disk, or an optical disk, for example. The recording apparatus 23 receives a preset recording control signal based on the program preset recording setting script received from the terminal apparatus 2. The controller of the recording apparatus 23 receives the preset recording control signal from the terminal apparatus 2 and controls the recording section in accordance with the received preset recording control signal to record it to the recording medium.

The recording apparatus 23 incorporates a tuner shown in a recording apparatus 23a shown in FIG. 19 and uses a magnetic tape for a recording medium or is a device composed of separate tuner and recording section shown by 23b. The recording apparatus 23 may also be composed of a plurality of tuner-incorporated recording devices or recording devices externally attached with tuners. If a generated program preset recording setting script is made up of n virtual channels, the tuners can simultaneously receive n channels and the received programs of n channels can be combined into a recordable form, thereby setting the preset recording of all programs of virtual channels.

If a program preset recording setting script to be transmitted to the terminal apparatus 2 is made up of n virtual channels, the recording device may be tuners capable of receiving n channels and n recording sections accommodated in one recording apparatus 23.

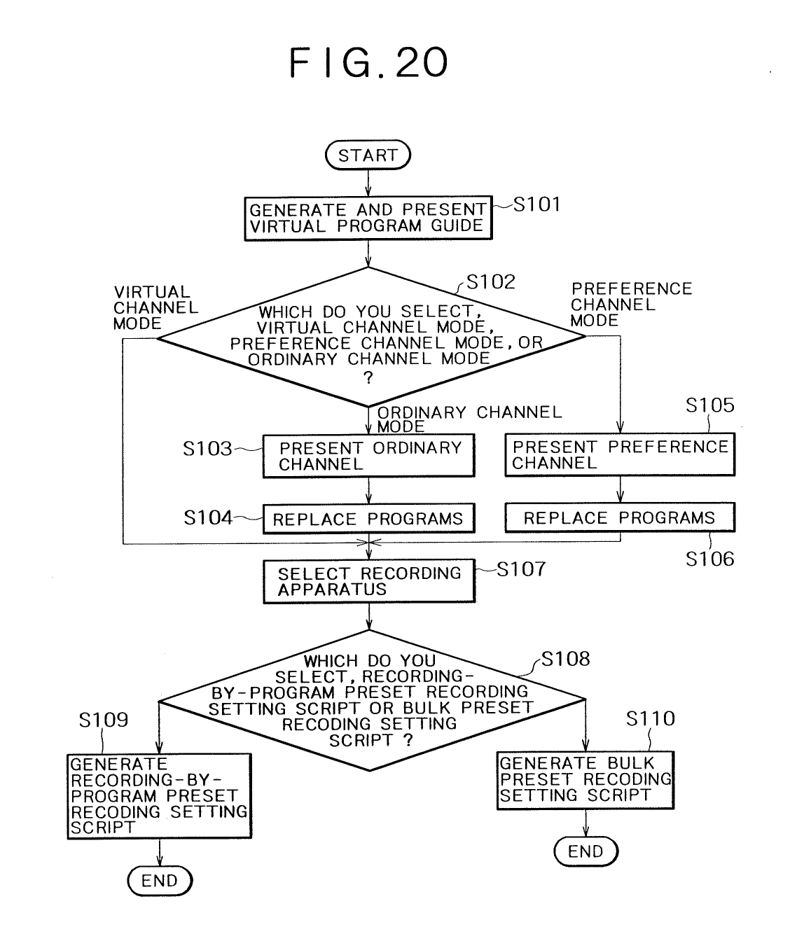

The following describes an operation of generating a program preset recording setting script by the program preset recording setting script generating apparatus 21 with reference to the flowchart shown in FIG. 20.

In step S101, the controller 16 organizes programs to be broadcast into a virtual channels as described above with reference to the flowcharts shown in FIGS. 4 through 12 and arranges the program information of these organized programs, thereby generating a virtual program guide. For example, a virtual program guide as shown in FIG. 18 is generated. The controller 16 transmits the generated virtual program guide to the terminal apparatus 2. The terminal apparatus 2 receives the virtual program guide and displays it on the display section, as shown in FIG. 18.

In step S102, the controller 16, in response to the input made by the user at the terminal apparatus 2, determines whether to generate program preset recording setting script in the virtual channel mode, the preference channel mode, or the ordinary channel mode. If the virtual channel mode is selected, the procedure goes to step S107. If the ordinary channel mode is selected, the procedure goes to step S103. If the preference mode is selected, the procedure goes to step S105.

In step S103, the controller 16 presents an ordinary channel program guide to the terminal apparatus 2. For example, the ordinary channel program guide is one as shown in FIG. 21. The user views this ordinary program guide on the display section of the terminal apparatus 2. The presented ordinary program guide is the same in time zone as a virtual program guide.

In step S104, the controller 16, in response to the input by the user at the terminal apparatus 2, organizes the programs selected from the ordinary program guide into virtual channels and arranges the program information of these programs into a virtual program guide.

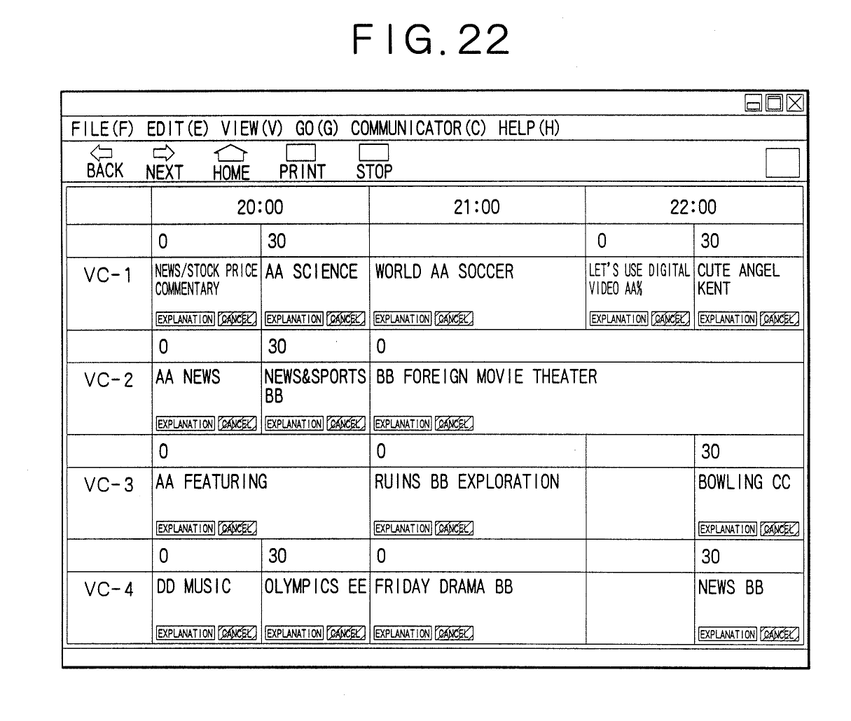

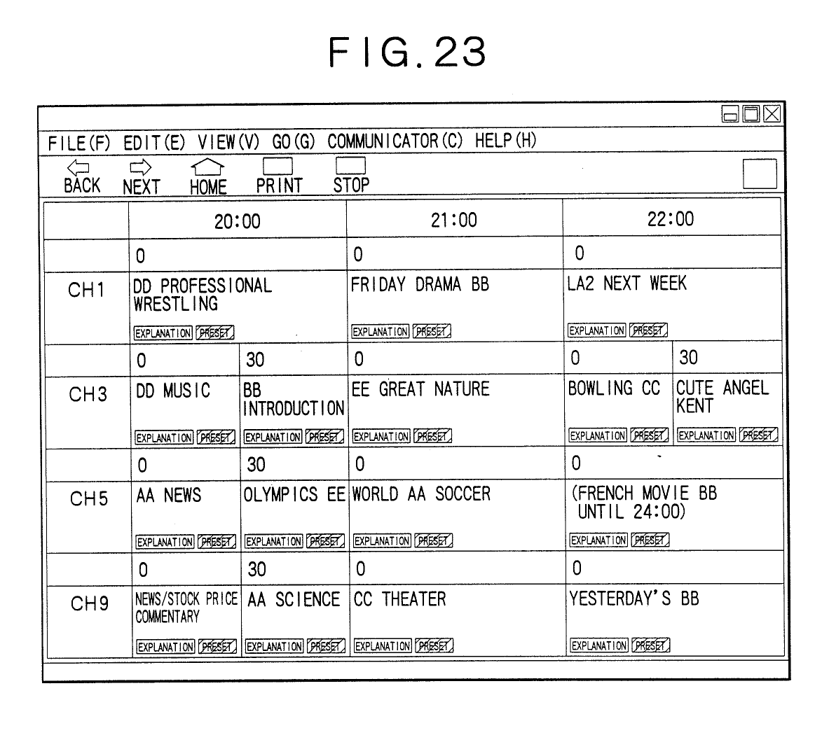

For example, in order to arrange “DD Professional Wrestling” starting at 20:00 on CH1 into the virtual program guide for preset recording, the controller 16 specifies a program in the virtual program guide to be replaced by “DD Professional Wrestling” and deletes the specified program from the virtual program guide. The deletion is effected by clicking “Cancel” button as shown in FIG. 22 in each program information box in the virtual program guide, for example. In this example, “AA News” and “News&Sports” on VC-2 are deleted.

Then, when the user clicks “Preset” button in the program information box of “DD Professional Wrestling,” this program is organized into the virtual channel and its program information is arranged into the virtual program guide at the position of 20:00 on VC-2.

The program organized into the virtual channel by clicking “Preset” button is reflected onto to user program viewing tendency information and group program viewing tendency information, thereby incrementing the values of the title, category, and keyword in these information.

The controller 16 determines whether the program organized from ordinary channel to virtual channel with its program information arranged in the virtual program guide is a program of a series by checking the program information stored in the database 11. If the program is found in series, the controller 16 stores it as an initial condition for virtual channel organization, the initial condition being automatically used for a next virtual channel organizing operation.

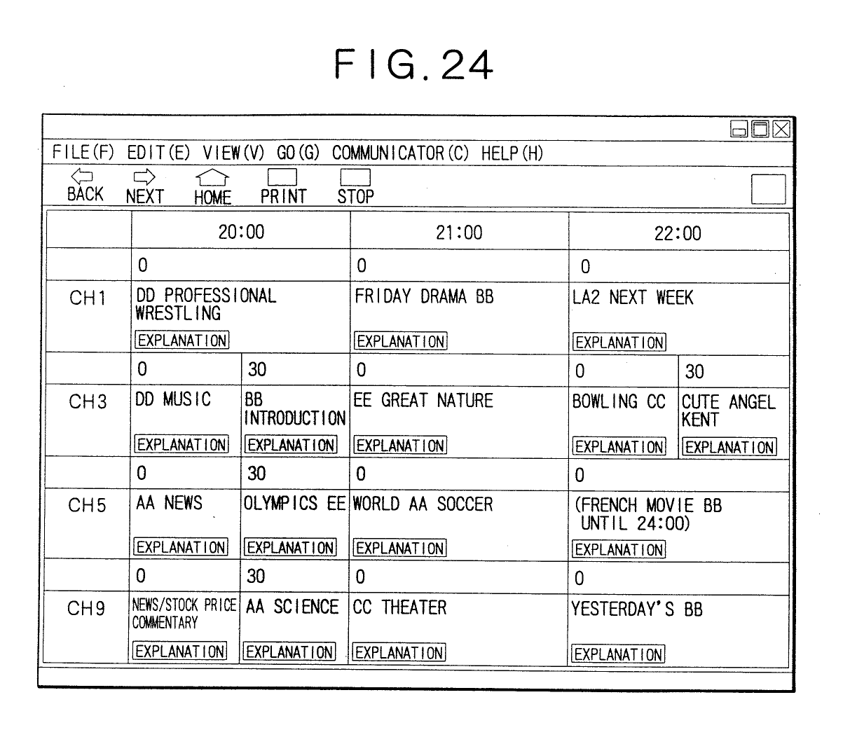

In step S105, the controller 16 presents the programs arranged in the preference channel program guide to the terminal apparatus 2. For example, assume that CH1, CH3, CH5, and CH9 be registered by the user as preference channels. A preference channel program guide is as shown in FIG. 24, which is shown on the display section of the terminal apparatus 2 for the presentation to the user. The presented preference channel program guide is the same in time zone as the virtual program guide.

In step S106, in response to the input by the user at the terminal apparatus 2, the controller 16 organizes the programs selected by the user from preference channel into virtual channel and arranges their program information into the virtual program guide. The arrangement is made in the same manner in which the program information is arranged from ordinary channel program guide to virtual program guide.

Here, the controller 16 determines whether the program organized from preference channel into virtual program guide with its program information arranged into the virtual program guide is a series by checking the program information stored in the database 11. If the program is found in series, the controller 16 stores it as an initial condition for virtual channel organization, the initial condition being automatically used for a next virtual channel organizing operation.

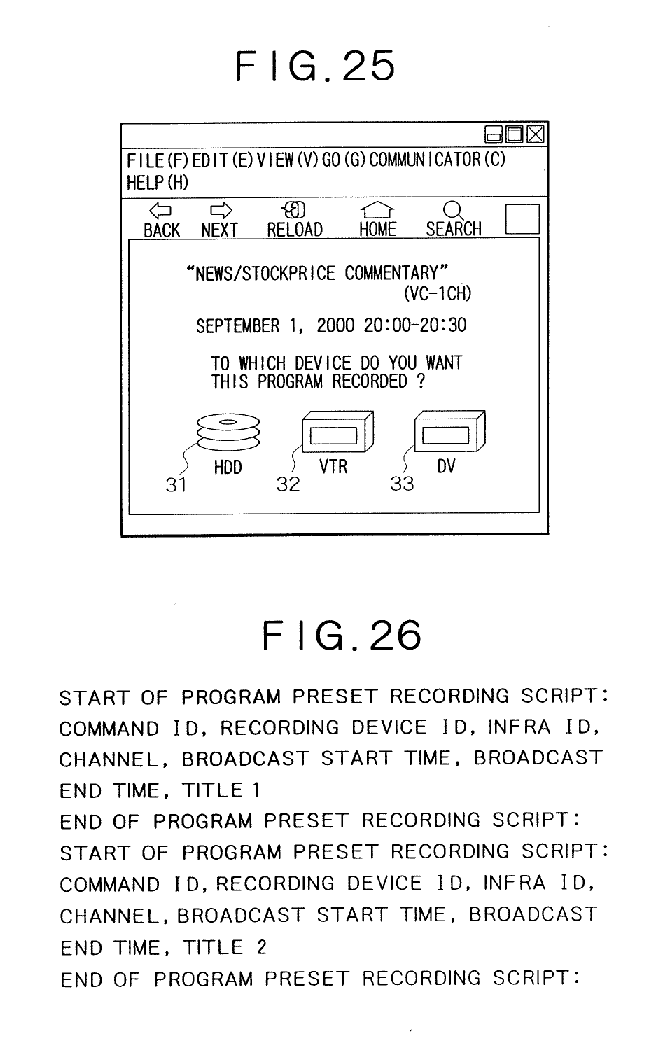

In step S107, in response to the input by the user, the controller 16 selects the recording section of the terminal apparatus 2 or the recording apparatus 23 to which a preset recording control signal is transmitted. For example, this selection is executed by displaying a selection menu for selecting the recording section of the terminal apparatus 2 and the recording apparatus 23 represented by icons 31, 32, and 33 as shown in FIG. 25. The user clicks any of the icons for selection. Icon 31 shown in FIG. 25 represents a HDD (Hard Disk Drive) of the terminal apparatus 2 for example, icon 32 represents a VTR (Video Tape Recorder) of the terminal apparatus 23a, and icon 33 represents a DV (Digital Video) of the terminal apparatus 23b.

It should be noted that the recording section of the terminal apparatus 2 and the recording apparatus 23 are assumed to have been registered by the user when the user used the services in the program recording system 30. When the recording section of the terminal apparatus 2 or the recording apparatus 23 is selected, an icon of the selected recording device is displayed in each program information column of the virtual program guide.

In step S108, the controller 16 determines whether to generate a recording-by-program preset recording setting script or a bulk preset recording setting script. To generate the recording-by-program preset recording setting script, the procedure goes to step S109. To generate the bulk preset recording setting script, the procedure goes to step S110.

The recording-by-program preset recording setting script is generated for each program. For example, as shown in FIG. 26, the recording-by-program preset recording setting script specifies which of the recording apparatuses 23 is to be used by one script and which of the programs on which of the channels is to be preset for recording.

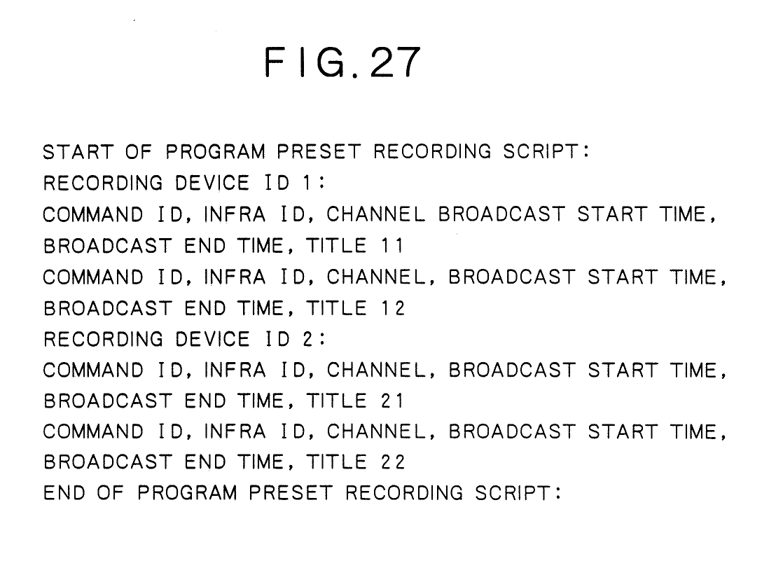

The bulk preset recording setting script specifies the preset recording of two or more different programs by one script. For example, as shown in FIG. 27, the bulk preset recording setting script generates only one script when presetting two or more programs for recording on two or more recording apparatuses 23.

In step S109, the controller 16 generates the recording-by-program preset recording setting script and transmits it to the terminal apparatus 2.

In step S110, the controller 16 generates the bulk preset recording setting script and transmits it to the terminal apparatus 2.

Each program preset recording setting script generated in steps S101 through S110 is converted into a required signal to be transmitted to the recording section of the terminal apparatus 2 or the recording apparatus 23, upon which the setting of preset recording of the specified programs is executed.

It should be noted that the program preset recording setting script generating apparatus 21 of the program recording system 30 can also transmit generated virtual program guides to mobile terminal apparatuses. The mobile terminal apparatuses include a mobile telephone having a display section for displaying text data and image data and a PDA (Personal Digital Assistant) for example, which can transfer/receive information via the Internet. The mobile terminal apparatus receives the virtual program guide sent from the program preset recording setting script generating apparatus 21 and presents the received virtual program guide to the user through the display section. The user references the virtual program guide and checks programs to be set for preset recording and transmits a control command for controlling the generation of a program preset recording setting script to the program preset recording setting script generating apparatus 21, thereby generating the program preset recording setting script. In response to the control command received from the mobile terminal apparatus, the program preset recording setting script generating apparatus 21 generates the program preset recording setting script in the procedure shown in above-mentioned steps S101 through S110 to set the recording section of the terminal apparatus 2 or the recording apparatus 23 for preset recording. The preset recording setting command inputted from the mobile terminal apparatus is reflected onto user program viewing tendency information and group program viewing tendency information at the time of virtual channel organization, thereby incrementing the title, category, and keyword values of the program concerned.

Thus, in the program recording system 30, the program preset recording setting script generating apparatus 21 generates a program preset recording setting script, which is a control command for recording a program to a recording medium, and controls the recording of the program to the recording section of the terminal apparatus 2 or the recording apparatus 23 by this control command, thereby recording to a specified recording medium the programs of user preference or preference of a group to which the user belongs.

The example mentioned above shows the virtual program guide generating apparatus 20 which organizes programs to be broadcast in a plurality of real channels having a predetermined frequency band into virtual channels and transmits a virtual program guide generated on the basis of virtual program guide and the virtual program guide generating apparatus 20 which has the terminal apparatus 2 for receiving the virtual program guide from the virtual program guide generating apparatus 20 and presenting the received virtual program guide to the user.

The virtual program guide generating apparatus 20 of the virtual program guide providing system 10 may be replaced by a virtual content program guide generating apparatus which selects content in accordance with a predetermined selection reference, organizes the selected content into a virtual content group, and generates a virtual content program guide listing content information indicative of the attribute of each content on the basis of the virtual content group.

When providing content including at least one of still image data, moving image data, audio data, and text data managed by one or more content providing apparatuses to the terminal apparatus 2 in download format or streaming format via an information transmission medium such as the Internet, the virtual content program guide generating apparatus organizes content having high user preference into a virtual content group and generates a content program guide arranged with content information on the basis of the virtual content group.

The following describes a virtual content group and a virtual content program guide to be generated in the present invention.

One or more content providing apparatuses which store and manage the content to be provided to users stores plural pieces of content including at least one of still image data, moving image data, audio data, and text data. A collection of these pieces of content is an actual, real content group.

On the other hand, a virtual content group is generated by selecting pieces of content from the real content group on the basis of user preference and content attribute information and organizing the selected pieces of content into a group on a virtual basis, thereby making it appear as if only the pieces of content preferred by the user are stored in a content providing apparatus as content resources. The virtual content group corresponds to virtual channels organized by the virtual program guide generating apparatus 20.

The virtual content program guide virtually presents the content generated by the above-mentioned virtual content group. The virtual program also corresponds to a virtual program guide generated by the virtual program guide generating apparatus 20.

The virtual content program guide generating apparatus applies the method in which the controller 15 of the virtual program guide generating apparatus 20 generates a virtual program guide by following the processes of steps S1 through S67 on the basis of the user program viewing tendency information and group program viewing tendency information generated from the user program viewing logs stored in the database 12 to generate a virtual content program guide on the basis of the user's content usage tendency information equivalent to the user program viewing tendency information generated from the user's content usage logs and/or the group content usage tendency information of a group to which the user belongs equivalent to the group program viewing tendency information.

The virtual content group is of two kinds: one is a virtual content group which is a collection of pieces of content and the other is a virtual content group which is obtained by organizing pieces of content having the concept of time into a time series in accordance with user's usage form.

If, among the pieces of content which are transmitted from the content providing apparatus to the terminal apparatus 2, the pieces of content which are not restricted in transmission date are organized into one group as a virtual content group, this group of content is organized as a simple content group having no concept of time-dependent sequence.

On the other hand, those pieces of content which are restricted in transmission date or which have the concept of time as attribute information in which significance is given only when provided to the user in a predetermined sequence can also be organized into a virtual content group by considering the content of time-dependent sequence on the basis of content information, which is content attribute information, and/or user content usage tendency information and/or group content usage tendency information. The virtual content group with the concept of time-dependent sequence considered denotes a virtual content group which is so organized that no discrepancy occurs when the user uses the content and the pieces of the content in the group are ordered in an easy to understand manner. For example, in the case of a drama series, the first story and the second story are organized in the order of elapsed time. Also, in the case of stock news, they may be organized in the order of elapsed time.

Further, the virtual content program guide generating apparatus can apply the method in which the program preset recording setting script, which is a control command for recording programs from the virtual program guide to a recording medium, is generated by following the procedure shown in steps S101 through S110 to generate a content preset recording setting script on the basis of the virtual content program guide generated as described above, thereby recording the content from the recording section of the terminal apparatus 2 or the recording apparatus 23 in the program recording system 30 to a corresponding recording medium.

The virtual content program guide generating apparatus configured as described above can generate a virtual content program guide to present the content of high user preference when providing the content including at least one of still image data, moving image data, audio data, and text data by each content providing apparatus.

In addition, the virtual content program guide generating apparatus can generate a virtual content program guide considering the concept of time when providing the content which must be scheduled because it takes a predetermined time for reproduction as with content including moving image data or audio data or whose value changes depending on a content providing sequence, thereby presenting the content with user's content usage situation considered.

If the virtual program guide generating apparatus 20 is used as the virtual content program guide generating apparatus, the program service providing apparatus 6 can be configured to handle the above-mentioned content instead of programs and the commissioning broadcast provider 3 can also be configured to create content, employing the same fee-charging processing.

The following describes a method of expenses collection to be employed in a remote program preset recording service based on mobile terminal apparatuses for executing a program preset recording setting operation from a location away from the terminal apparatus 2 in the program recording system 30 shown in FIG. 19.

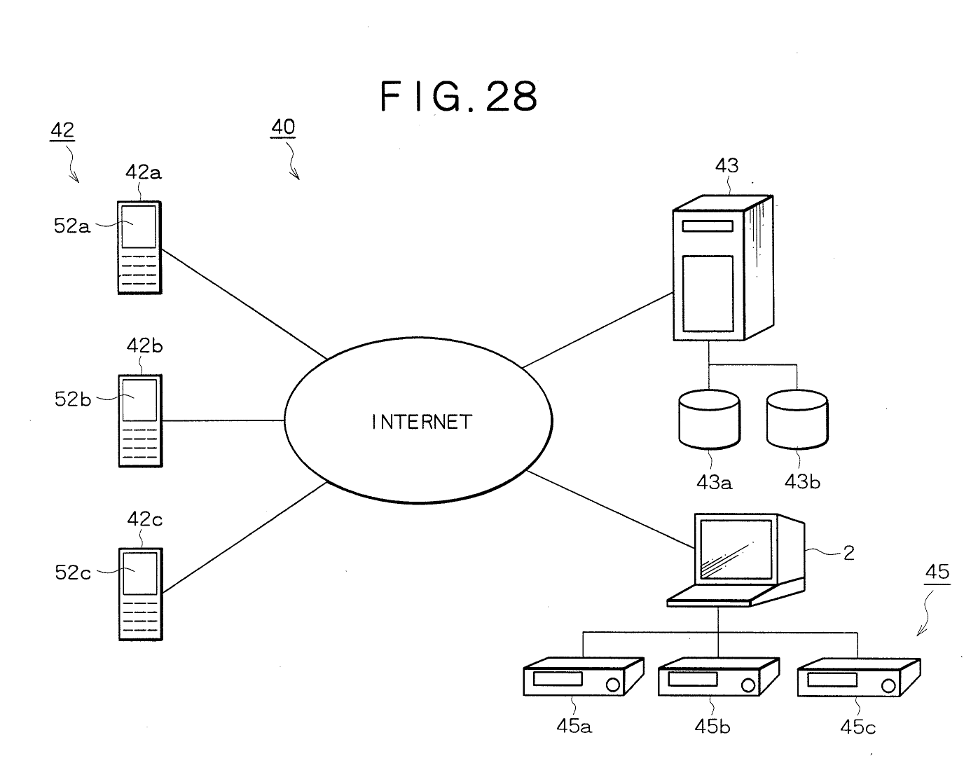

In order to remotely execute a program preset recording setting to the terminal apparatus 2 by use of a mobile terminal apparatus, the program service providing apparatus 6 configures a program preset recording system 40 with a program information providing apparatus 43, the terminal apparatus 2, a recording apparatus 45, and mobile terminal apparatuses 42a, 42b, and 42c as shown in FIG. 28.

The mobile terminal apparatuses 42a, 42b, and 42c are PCs (personal computers) or PDAs (Personal Digital Assistants) for example having display sections 42a, 42b, and 42c which are each a LCD (Liquid Crystal Display) for example for displaying text information or image information for example.

The mobile terminal apparatus 42a stores, in its storage section not shown, a Web browser for getting program information for introducing television programs provided on the Internet by the program information providing apparatus 43. A controller, not shown, of the mobile terminal apparatus 42a searches a database 43a of the program information providing apparatus 43 for the program information by use of the Web browser on the Internet and displays the retrieved program information on the display section 52a.

The mobile terminal apparatus 42b stores in its storage section not shown mailer software (hereinafter referred to as a mailer) for receiving electronic mail from the program information providing apparatus 43 and displaying the received electronic mail on the display section 52b. The mobile terminal apparatus 42b also stores in its storage section not shown a Web browser as the auxiliary software of the mailer. This Web browser starts when the user checks a URL (Uniform Resource Locator) attached to electronic mail, displaying the program information on the display section 52b.

The mobile terminal apparatus 42c stores in its storage section not shown the mailer software (hereinafter referred to as a mailer) for receiving electronic mail, receiving electronic mail from the program information providing apparatus 43 and displaying the received electronic mail on the display section 52c.

The program information providing apparatus 43 has a database 43a storing program information, which is program attribute information, such as a program introductory comment summarizing the contents of each program and a program guide tabulating the program information about the programs organized into each channel and a database 43b storing a program preset recording setting script into an account set for each user. The storage section, not shown, of the program information providing apparatus 43 stores a Web server program which provides on the Internet the program information and program guides stored in the database 43a to the mobile terminal apparatuses 42a and 42b via their Web browsers.

The storage section of the program information providing apparatus 43 stores a mail server program which retrieves program introductory comments from the program information stored in the database 43a and periodically transmits the retrieved introductory comments to the mobile terminal apparatuses 42b and 42c. The time of the transmission to the mobile terminal apparatuses 42b and 42c can be set by the user; for example, the user can transmit every 3 hours or at 6:00 every day. The electronic mail to be transmitted from the program information providing apparatus 43 is attached with a URL which includes the information for identifying a program the information for identifying a user who receives the electronic mail for each program introductory comment. This URL is linked with each piece of program information stored in the database 43a of the program information providing apparatus 43. The URL will be detailed later.

In addition, the program information providing apparatus 43 generates a program preset recording setting script, which is a control command based on the program information for controlling the recording apparatus 45 to record programs to a recording medium and transmits the generated script to the terminal apparatus 2.

The terminal apparatus 2, which is a PC for example, incorporates a ground wave receiving tuner, a BS (Broadcasting Satellite) tuner, and a CS (Communications Satellite) tuner. Each of these tuners receives modulated programs transmitted by a carrier having a predetermined frequency and demodulates the received programs into programs consisting of video and audio signals. The terminal apparatus 2 has a recording section for recording the received programs to a recording medium pre-installed in the recording section or a recording medium which is detachably loaded into the recording section. The recording medium is a magnetic tape, a magnetic disk, a magneto-optical disk, or an optical disk, for example. The terminal apparatus 2 receives a program preset recording setting script sent from the program information providing apparatus 43. The controller of the terminal apparatus 2 converts the received program preset recording setting script into a preset recording control signal suitable for the processing by the recording section and controls the recording section in accordance with the converted preset recording control signal to record it to the recording medium. At the same time, the terminal apparatus 2, when transmitting a program preset recording setting script to the recording apparatus 45 specified in the program preset recording setting script, converts the program preset recording setting script into a control signal suitable for each recording apparatus 45. For example, the terminal apparatus 2 converts the program preset recording setting script into an IR (Infrared) signal, a LAN (Local Area Network) control signal, or an iLINK (trademark) control signal.

The terminal apparatus 2 stores in its storage section not shown program preset recording setting scrip pickup software for retrieving a program preset recording setting script stored for each account of the terminal apparatus 2 in the database 43b of the program information providing apparatus 43. This program preset recording setting script pickup software starts when a session has been established between the terminal apparatus 2 and the program information providing apparatus 43 to search the account of the user of the database 43b for the program preset recording setting script and downloads the retrieved script.

The recording apparatus 45 incorporates a ground wave receiving tuner, a BS tuner, and a CS tuner. Each tuner receives modulated programs transmitted on a carrier having a predetermined frequency and demodulates the received programs into programs consisting of video and audio signals. The recording apparatus 45 has a recording section for recording the received programs to a recording medium pre-installed in the recording section or a recording medium which is detachably loaded into the recording section. The recording medium is a magnetic tape, a magnetic disk, a magneto-optical disk, or an optical disk, for example. The recording apparatus 45 receives a preset recording control signal based on the program preset recording setting script received from the terminal apparatus 2. The controller of the recording apparatus 45 receives the preset recording control signal from the terminal apparatus 2 and controls the recording section in accordance with the received preset recording control signal to record it to the recording medium. The recording apparatus 45 may have a plurality of recording devices such as a recording apparatus 45a, which is a DV, a recording apparatus 45b, which is a VTR, and a recording apparatus 45c, which is a DVD, as shown in FIG. 28 for example.

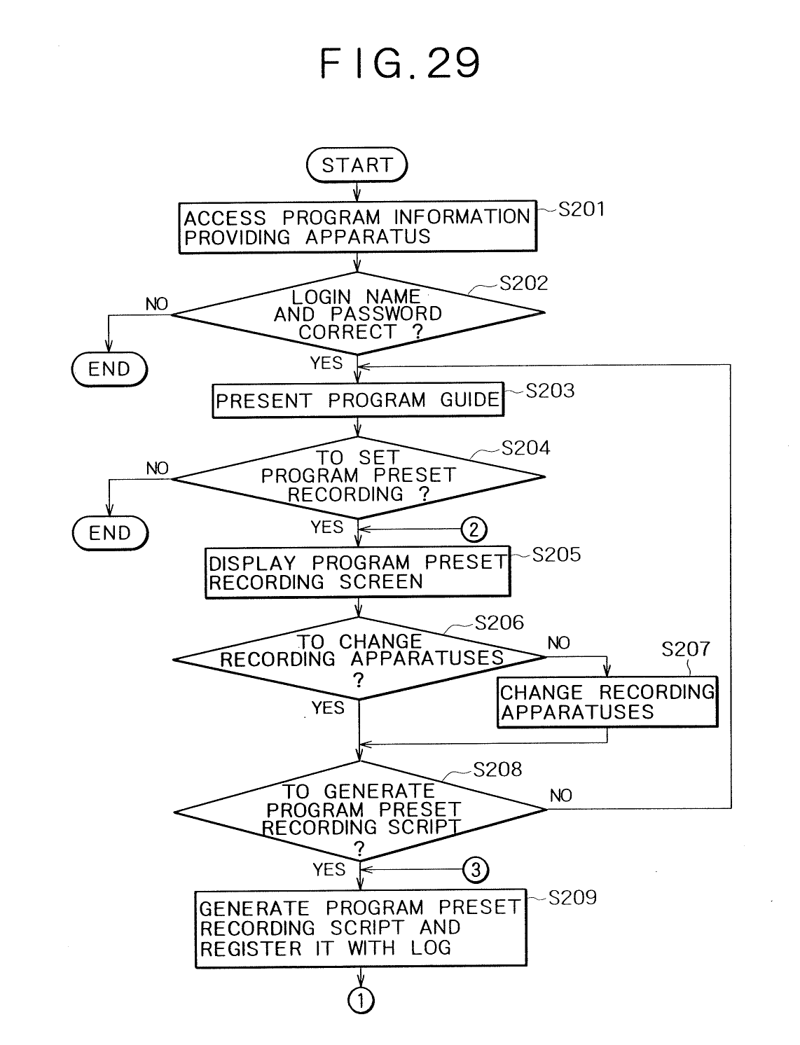

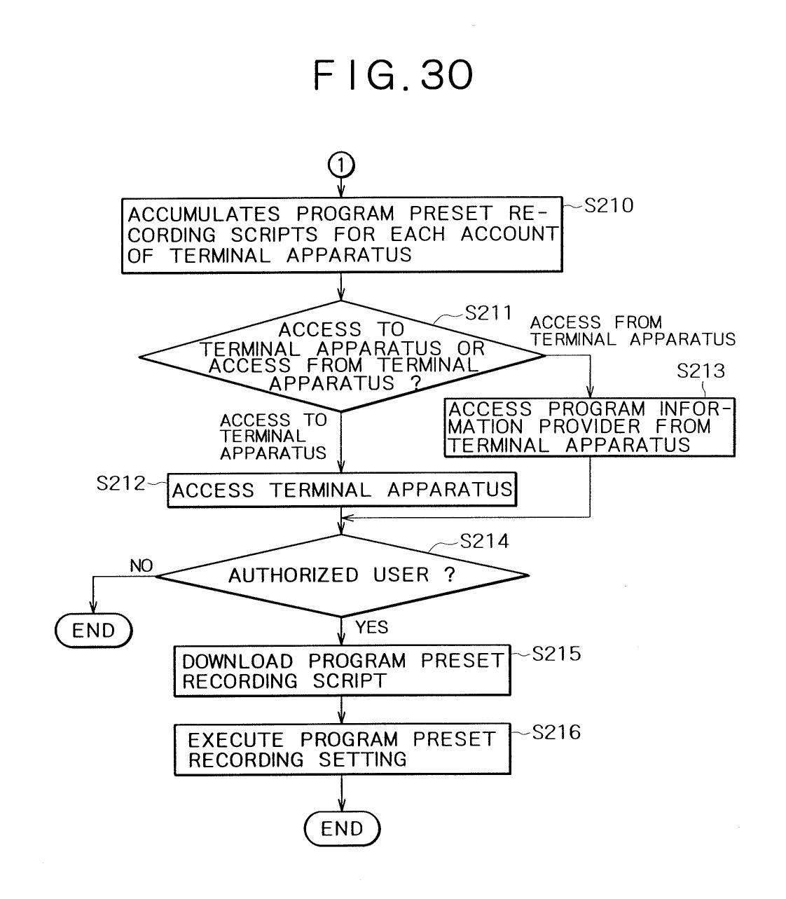

The following describes, with reference to the flowchart shown in FIGS. 29 and 30, an operation of the program preset recording setting in the direct access mode in which the mobile terminal apparatus 42a directly accesses the program information providing apparatus 43 in the program preset recording system 40 via the Internet.

It should be noted that, in the direct access mode, the user must perform user registration before starting a program preset recording service with the program information providing apparatus 43. For example, the user must register in advance user's login name, password, electronic mail address, postal address, telephone numbers (of the mobile terminal apparatus 2 and the terminal apparatus 2), the recording section of the terminal apparatus 2 and the recording apparatus 45 to which a program is to be recorded, credit card number for example for settling fee-charging, and user's profile such as name, age, gender, and occupation. The recording section of the terminal apparatus 2 and the recording apparatus 45 may be registered as a plurality of the recording sections of the terminal apparatus 2 and the recording apparatuses 45. In order to register a plurality of the recording sections of the terminal apparatus 2 and the recording apparatuses 45, one of the mainly used recording sections or recording apparatuses 45 is registered as a default device.

In step S201, in response to the input by the user, the controller, not shown, of the mobile terminal apparatus 42a accesses the program information providing apparatus 43 via the Internet by use of the Web browser stored in the storage section, not shown. In response, the program information providing apparatus 43 requests the user through the Web browser of the mobile terminal apparatus 2 for user's login name and password.

In step S202, when the user's login name and password have been entered by the user through the Web browser of the mobile terminal apparatus 42a, the program information providing apparatus 43 determines whether to establish a session for transferring/receiving data between the mobile terminal apparatus 42a and the program information providing apparatus 43. If the login name and password are found correct, then the procedure goes to step S203; otherwise the procedure comes to an end.

It should be noted that the inputting of the user's login name and password may be omitted from the next usage of the service of the program preset recording system 40 by registering the user ID (Identification) for example.

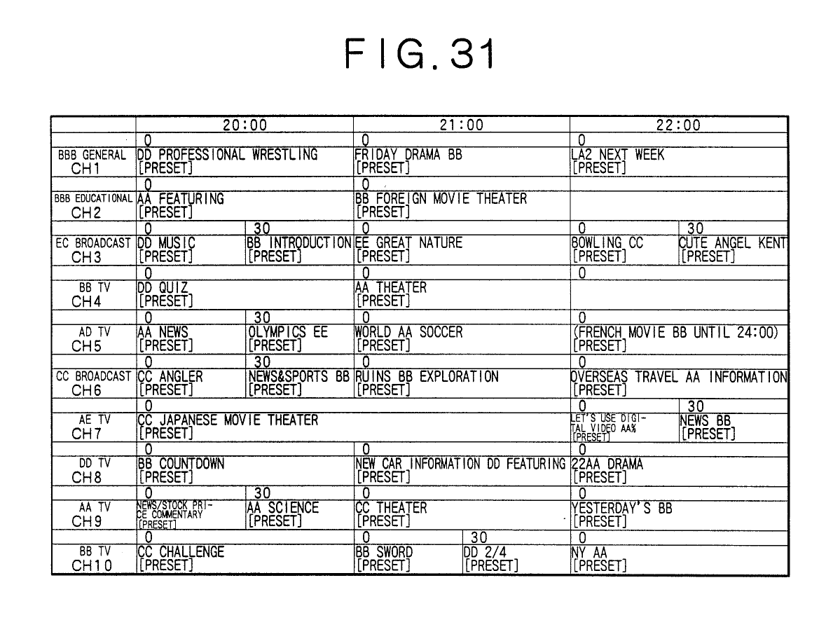

In step S203, the controller of the mobile terminal apparatus 42a, the controller of the mobile terminal apparatus 42a downloads from the database 43a a program guide arranged with the program information of programs for each channel by use of the Web browser. The mobile terminal apparatus 42a displays the downloaded program guide on the display section 52a. FIG. 31 illustrates an exemplary program guide displayed on the display section 52a. The program guide in FIG. 31 is composed of 10 channels CH1 through CH10 allocated to 10 broadcast stations, indicating 3-hour program information from 20:00 to 22:00. In the program information box of each program, a time zone 20:00 to 21:00 of broadcast station “BBB General” allocated to CH1 for example contains a program called “DD Professional Wrestling” for example. It should be noted that “Preset” button attached to each program information will be detailed later.

In step S204, the controller determines on the basis of the input by the user through the mobile terminal apparatus 42a whether to set the preset recording of a program listed in the program guide. To set the preset recording, the procedure goes to step S5; otherwise, the procedure comes to an end. For example, if the program guide illustrated in FIG. 31 is displayed on the display section 52a of the mobile terminal apparatus 42a and the program preset recording is to be set, then clicking “Preset” button attached to each program box of the program guide enters the program preset recording setting mode.

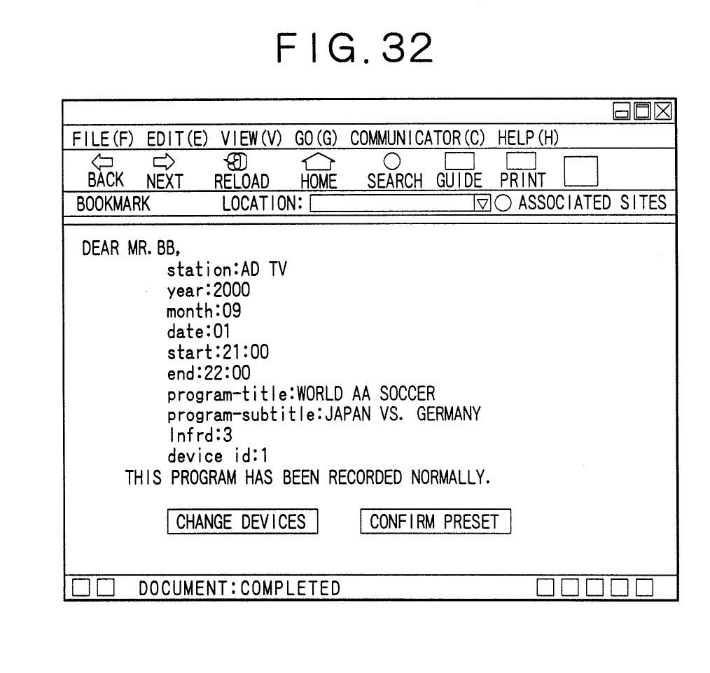

In step S205, the controller of the mobile terminal apparatus 42a displays, by use of the Web browser, a screen for confirming the program preset recording setting made in response to the input by the user in step S204. For example, if the user clicks “Preset” button of the program guide displayed on the display section 52a in step S204, the controller of the mobile terminal apparatus 42a displays a program preset recording setting confirmation screen as shown in FIG. 32 on the display section 52a by use of the Web browser. This program preset recording setting confirmation screen shows that the name of the station “station” from which the program is broadcast is “AD TV,” the date of broadcasting “year,” “month,” and “date” are “2000,” “09” and “01,” broadcast start time “start” is “21:00,” broadcast end time “end” is “22:00,” program title “program-title” is “World AA Soccer,” program subtitle “program-subtitle” is “Japan Vs. Germany,” infra-identification number “Infra” for identifying broadcasting means such as ground wave, CS, or BS is “3,” and device identification number “device id” for identifying the recording apparatus 45 to which the program is recorded is “1” for example. The program preset recording setting confirmation screen also contains “Change Devices” button to be described later for changing the devices to which the program is recorded and “Confirm Preset” button for executing the generation of a program preset recording setting script to be described in step S208.

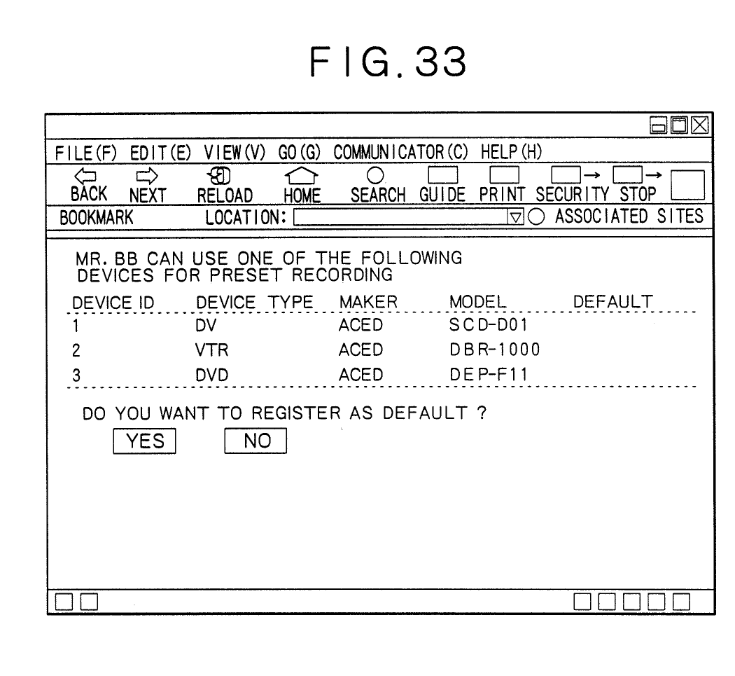

In step S206, in response to the input by the user, the controller determines whether to change the recording section of the terminal apparatus 2 or the recording apparatus 45 set as a default device before entering step S201 to another of the recording sections of the terminal apparatus 2 or the recording apparatuses 45. To change the recording sections of the terminal apparatus 2 or the recording apparatuses 45, the procedure goes to S207; otherwise, the procedure goes to step S208. It should be noted that, if there is only one recording apparatus 45 registered, this process can be skipped. For example, if the program preset recording setting information screen shown in FIG. 32 is displayed on the display section 52a of the mobile terminal apparatus 42a through the Web browser, clicking “Change Devices” button of a screen for confirming the program preset recording setting causes a device change screen shown in FIG. 33 to be displayed on the display section 52a of the mobile terminal apparatus 42a through the Web browser. The device change screen shown in FIG. 33 contains, for each device, “Device ID” indicative of the ID number of the recording section of the mobile terminal apparatus 2 or the recording apparatus 45 in the program preset recording system 40, “Device Type” indicative of the type of the recording section of the mobile terminal apparatus 2 or the recording apparatus 45, “Maker” indicative of the maker of the recording section of the mobile terminal apparatus 2 or the recording apparatus 45, “Model” indicative of the model of the recording section of the mobile terminal apparatus 2 or the recording apparatus 45, and “Default” indicative of the recording section of the mobile terminal apparatus 2 or the recording apparatus 45 registered as the default device. As shown in the device change screen in FIG. 33, the recording section of the mobile terminal apparatus 2 or the recording apparatus 45 registered with the program preset recording system 40 are of three types: DV (Digital Video) having device ID of 1, VTR (Video Tape Recorder) having device ID of 2, and DVD (Digital Versatile Disk) having device ID of 3. Of these three devices, the recording apparatus 45 whose device ID is 1 is registered as the default device.

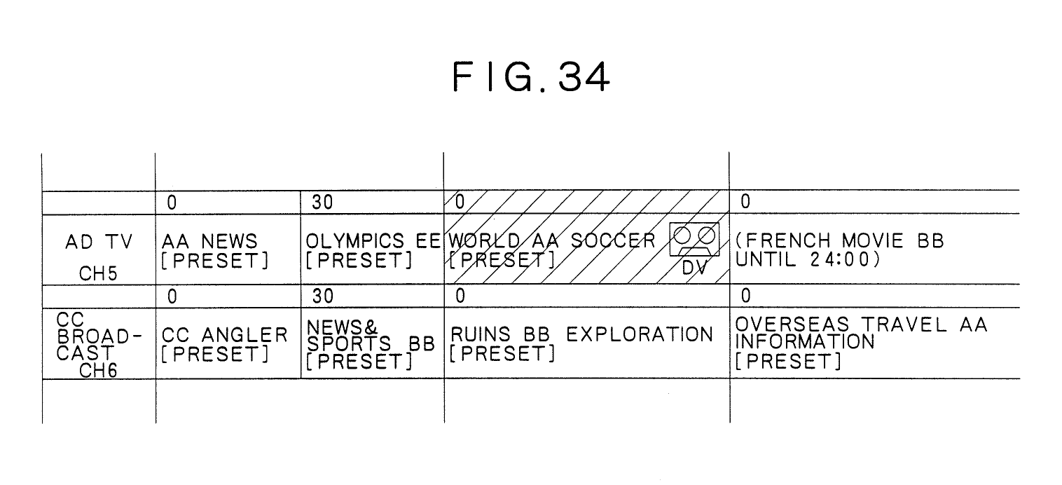

In step S207, in response to the input by the user at the mobile terminal apparatus 42a, the controller changes the recording sections of the mobile terminal apparatus 2 or the recording apparatuses 45. For example, this device change is executed when the user clicks the default box of the recording section of the terminal apparatus 2 or the recording apparatus 45 to be newly set to default on the device change screen of FIG. 33 and clicks “Yes” button in response to message “Do you want to register as default?” When the user clicks “Yes” button, the Web browser screen returns to the program preset recording setting confirmation screen shown in FIG. 32. When the recording section of the terminal apparatus 2 or the recording apparatus 45 has been set, an icon representative of the device thus set is displayed in the corresponding program box in the program guide as shown in FIG. 34. For example, an icon of DV is displayed in the program box of “World AA Soccer” as hatched in FIG. 34.

In step S208, in response to the input by the user at the mobile terminal apparatus 42a, the controller determines whether to generate a program preset recording setting script. To generate the script, the procedure goes to step S209; otherwise, the procedure returns to step S203. For example, to generate the script, when the user clicks “Confirm Preset” button in the program preset recording setting confirmation screen shown in FIG. 31, the information thereof is transmitted to the controller of the program information providing apparatus 43.

In step S209, in response to the input by the user at the mobile terminal apparatus 42a, the controller of the program information providing apparatus 43 generates a program preset recording setting script. When the program preset recording setting script has been generated, its log is stored for each user into the database 43b of the program information providing apparatus 43.

In step S210, the controller of the program information providing apparatus 43 stores the generated program preset recording setting script into the account of the corresponding user in the database server 3b.

In step S211, when the program information providing apparatus 43 accesses the terminal apparatus 2, the procedure goes to step S212; when the terminal apparatus 2 accesses the program information providing apparatus 43, the procedure goes to step S213.

In step S212, the controller of the program information providing apparatus 43 accesses the terminal apparatus 2 to establish a session for data transfer. When the program preset recording setting script has been stored in the account of the user in the database 43b in step S209, the controller of the program information providing apparatus 43 immediately accesses the terminal apparatus 2. When step S212 has been completed, the procedure goes to step S214.

In step S213, the controller of the terminal apparatus 2 accesses the program information providing apparatus 43 to establish a session for data transfer. The controller of the terminal apparatus 2 periodically accesses the program information providing apparatus 43; for example, several times a day as specified by the user. When step S213 has been completed, the procedure goes to step S214.

In step S214, when the session between the program information providing apparatus 43 and the terminal apparatus 2 has been established, the program preset recording setting script pickup software stored in the recording section of the terminal apparatus 2, which is a software program to acquire the program preset recording setting script, starts.

The started program preset recording setting script pickup software accesses the program information providing apparatus 43 in order to download the program preset recording setting script stored in the database 43b of the program information providing apparatus 43. The controller of the program information providing apparatus 43 authenticates whether the accessing program preset recording setting script pickup software is that of the authorized user. This authentication is executed by use of the user ID or user login ID and password.

It should be noted that, when installing the program preset recording setting script pickup software in the terminal apparatus 2, the user must register his ID or user login ID and password and stores them into a storage section, not shown, of the program information providing apparatus 43.

In response to the access by the program preset recording setting script pickup software, the controller of the program information providing apparatus 43 determines whether this software is of the authorized user of the account in the database 43b by use of the user ID or the user login ID and password stored in the above-mentioned storage section. If the software is of the authorized user, the procedure goes to step S215; otherwise, the procedure comes to an end.

In step S215, the controller of the terminal apparatus 2 downloads the program preset recording setting script from the database 43b of the program information providing apparatus 43 by use of the program preset recording setting script pickup software stored in the storage section, not shown. At the same time, when the program preset recording setting script has been downloaded by the program preset recording setting script pickup software of the terminal apparatus 2, the controller of the program information providing apparatus 43 generates a message notifying thereof by setting a program guide account which can be accessed by the Web browser.

In step S216, the controller of the terminal apparatus 2 retrieves the program preset recording setting script by use of the program preset recording setting script pickup software stored in the storage section and determines whether the device for recording the program described in the program preset recording setting script is the recording section of the terminal apparatus 2 or the recording apparatus 45. If the device is the recording section of the terminal apparatus 2, then the controller of the terminal apparatus 2 converts the program preset recording setting script into a preset recording control signal suitable for processing by the recording section. If the device is the recording apparatus 45, then the controller converts the program preset recording setting script into a signal suitable for processing by the recording apparatus 45 and then transmits the signal to the recording apparatus 45. The recording apparatus 45 receives the preset recording control signal from the terminal apparatus 2 and performs the preset recording of the program as specified by the control signal.

The following describes an operation of canceling the program preset recording setting made on the basis of the program preset recording setting script generated in the direct access mode described above with reference to the flowcharts of FIGS. 29 and 30.

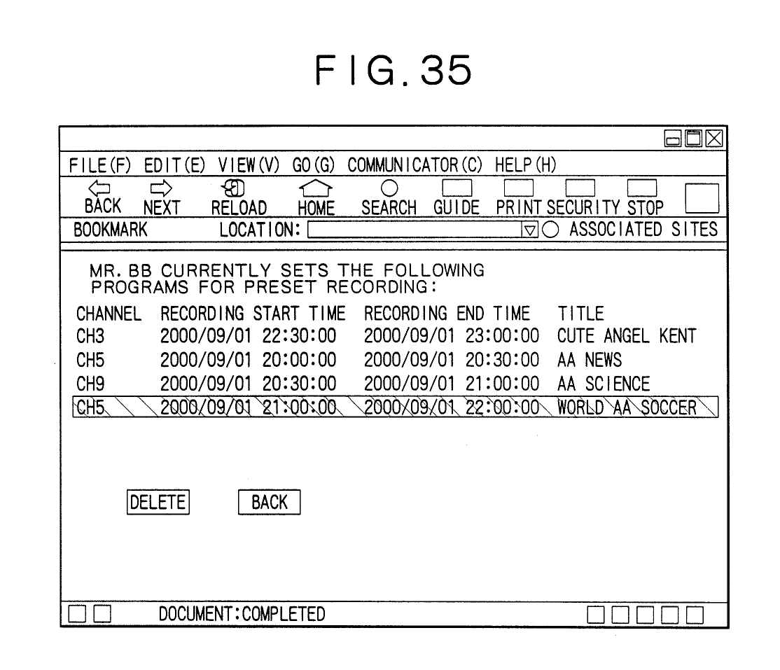

In order to cancel the setting of program preset recording, the user first clicks “Cancel” button, not shown, in the program guide displayed on the display section 52a of the mobile terminal apparatus 42a by use of the Web browser. When “Cancel” button is clicked, the controller of the program information providing apparatus 43 retrieves, from the program preset recording log of each user stored in the database 43b, the user's program preset recording log for which the recording has not been executed on the recording section of the terminal apparatus 2 or the recording apparatus 45 and displays the retrieved log on the display section 52a of the mobile terminal apparatus 42a. FIG. 35 illustrates an exemplary program preset recording log. As shown in FIG. 35, the program preset recording log is displayed in which the channels on which preset programs are broadcast are shown under “Channel,” such as CH3, CH5, and CH9 for example. Program recording start times are shown under “Recording Start Time” such as “2000/09/01 22:30:00” for example, which is September first, 2000, 22:30:00. Program recording end times are shown under “Recording End Time” such as “2000/09/01 23:00:00 for example, which is September first, 2000, 23:00:00. Program names are shown under “Title” such as “Cute Angel Kent” for example. In FIG. 35, four programs are preset for recording, which are “Cute Angel Kent,” “AA News,” “AA Science,” and “World AA Soccer.”

When the program preset recording log is displayed on the display section 52a of the mobile terminal apparatus 42a, the user selects the program of which preset recording is to be canceled from the program preset recording log and clicks “Delete” button on the screen shown on the display section 52a. When the “Delete” button is clicked, the controller of the program information providing apparatus 43 generates a cancel script for invalidating the preset recording of the selected program. The generated cancel script is transmitted from the program information providing apparatus 43 to the terminal apparatus 2 in which the cancel script is converted into a control signal suitable for processing by the recording section of the terminal apparatus 2 or the recording apparatus 45, the control signal being transmitted thereto. In response to the received control signal, the recording section of the terminal apparatus 2 or the recording apparatus 45 cancels the setting of preset recording of the program. When the preset recording setting is canceled, the corresponding program preset recording log is deleted and is registered as a cancel log with the account of the user in the database 43b of the program information providing apparatus 43.

The following describes, with reference to the flowcharts shown in FIGS. 36, 29, and 30, an operation of program preset recording setting in a first mail access mode in which the program information providing apparatus 43 periodically transmits electronic mail attached with URL to the mobile terminal apparatus 42b to perform program preset recording setting by use of the Web browser of the mobile terminal apparatus 42b in the program preset recording system 40.

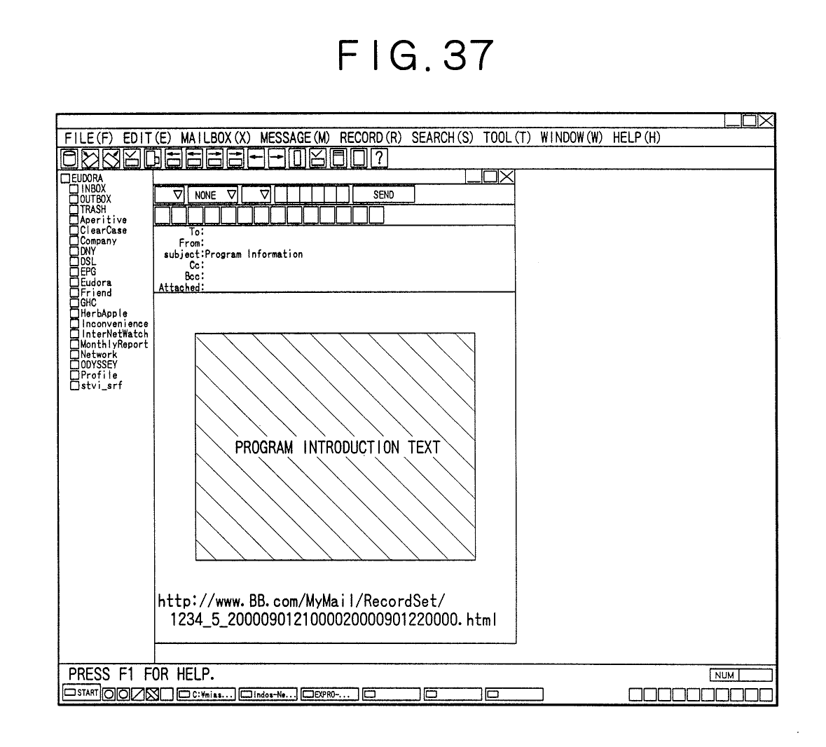

In step S221, the controller of the program information providing apparatus 43 transmits, to the mobile terminal apparatus 42b, an electronic mail message attached with a program introductory comment of the program and a URL for identifying user, program channel, broadcast start time and broadcast end time for each program introductory comment. FIG. 37 illustrates an exemplary electronic mail message transmitted from the program information providing apparatus 43 to the mobile terminal apparatus 42b. A program introductory comment summarizes the contents of a program and is placed in “Program Introductory Comment” box hatched in FIG. 37. It should be noted that no specific program introductory comment is shown. This electronic mail message is also attached with URL “http://BB.com/MyMail/RecordSet/1234_{—}5_{—}2000090121000020000901220000.html.” This URL indicates the location of a directory in which the corresponding program information of the database 43a of the program information providing apparatus 43 is stored and, at the same time, indicates user identification and capabilities which can be executed by accessing this URL. “RecordSet” in the URL shown in FIG. 37 indicates that this URL is for setting program preset recording, “1234” indicates an user identifier for identifying the user of this program preset recording system 40, following “5” indicates the channel number of the program, “20000901210000” indicates the program start date and time, Sep. 1, 2000, 21:00, and “20000901220000” indicates the program end date and time, Sep. 1, 2000, 22:00.

In step S222, in response to the input by the user at the mobile terminal apparatus 42b, the controller determines whether to access the URL attached to the received electronic mail. To access the URL, the procedure goes to step S223; otherwise, the procedure comes to an end. For example, if the electronic mail as shown in FIG. 37 is transmitted from the program information providing apparatus 43 to the mobile terminal apparatus 42b, the user clicks the attached URL such as “http://www.BB.com/MyMail/RecordSet/1234_{—}5_{—}2000090121000020000901220000.html” to access thereto.

In step S223, the controller of the mobile terminal apparatus 42b searches the database 43a of the program information providing apparatus 43 for the program information of the corresponding program by use of the Web browser and displays the retrieved program information on the display section 52b. When step S223 is completed, the procedure goes to steps S204 through S216 shown in FIGS. 29 and 30.

The processes of steps S204 through S216 are the same as described with the direct access mode. By following the processes of steps S204 through S216, a program preset recording setting script is generated to set the preset recording of a corresponding program to the terminal apparatus 2 or the recording apparatus 45 in the first mail access mode.

The following describes an operation of canceling the program preset recording setting made on the basis of the program preset recording setting script generated in the first mail access mode described with reference to the flowcharts of FIGS. 36, 29, and 30.

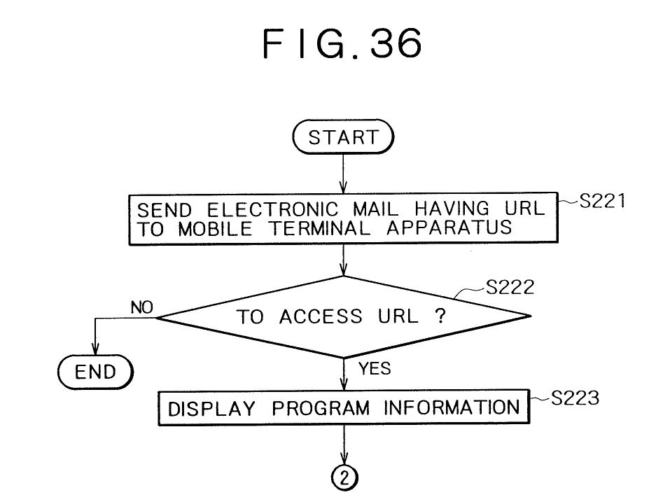

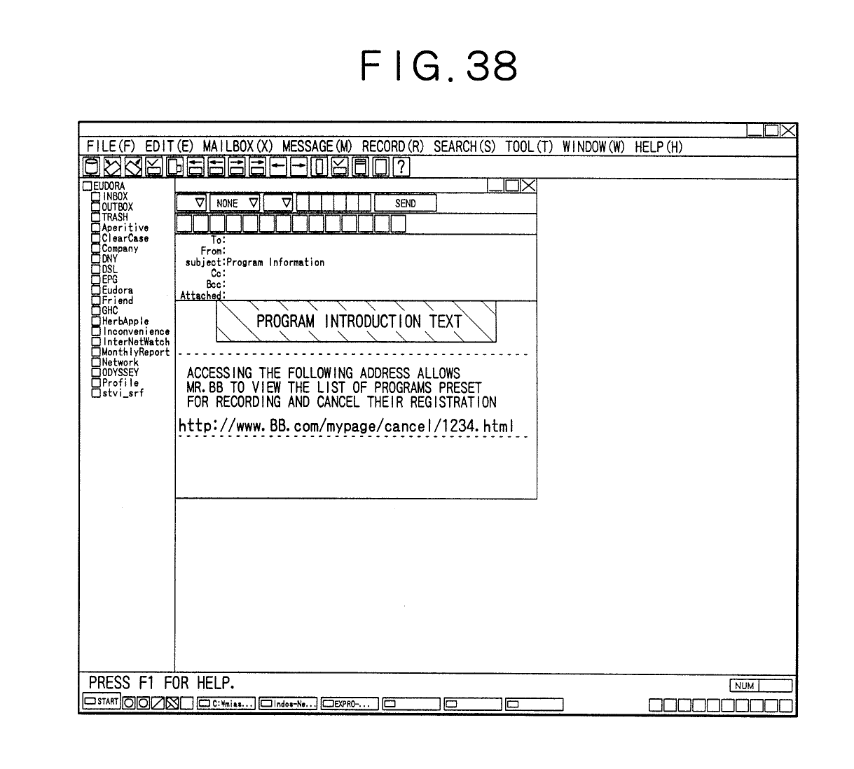

If at least one program has been set for preset recording, an electronic mail message to be transmitted from the program information providing apparatus 43 to the mobile terminal apparatus 42b in step S221 shown in FIG. 36 is attached with a cancel URL as shown in FIG. 38 for example, like “http://www.BB.com/myPage/Cancel/1234.html.” This cancel URL identifies the user and indicates capabilities to be executed when accessed. “Cancel” in the cancel URL shown in FIG. 37 indicates that this URL functions to cancel the setting of program preset recording and “1234” indicates a user identifier for identifying the user using the program preset recording system 40. To cancel the setting of program preset recording, the user clicks, at the terminal apparatus 2b, the cancel URL attached to the electronic mail. When the cancel URL is clicked, the controller of the program information providing apparatus 43 retrieves a program preset recording log in which the recording to the recording section of the terminal apparatus 2 or the recording apparatus 45 has not yet been performed from among the program preset recording logs of users stored in the database 43b and passes the cancel URL to the mobile terminal apparatus 42b. In response, the controller of the mobile terminal apparatus 42b starts the Web browser and displays the retrieved program preset recording log on the display section 52b. For example, the controller of the mobile terminal apparatus 42b displays through the Web browser the log of programs set for preset recording as shown in FIG. 35 on the display section 52b of the mobile terminal apparatus 42b. Checking the program log screen shown on the display section 52b, the user selects a program to be canceled of the setting of preset recording. To cancel the setting of preset recording, the user clicks “Delete” button as shown in FIG. 35 for example after the selection. The subsequent cancel operation in the first mail access mode is generally the same as that in the direct access mode.

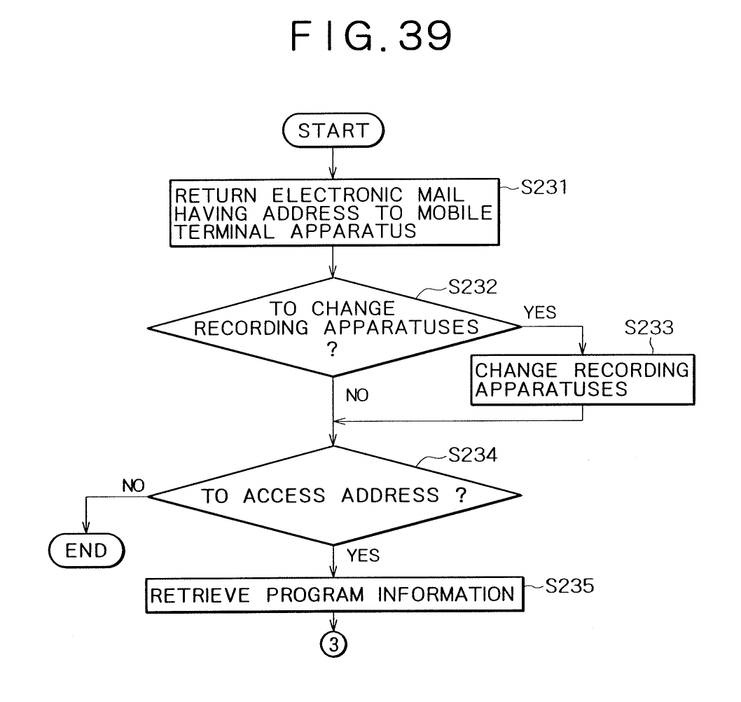

The following describes, with reference to the flowcharts shown in FIGS. 39, 29, and 30, an operation of program preset recording setting to be executed in a second mail access mode in which an electronic mail message attached with a URL is periodically transmitted from the program information providing apparatus 43 to the mobile terminal apparatus 42c and mobile terminal apparatus 42c accesses the URL attached to the received electronic mail message to perform program preset recording setting in the program preset recording system 40.

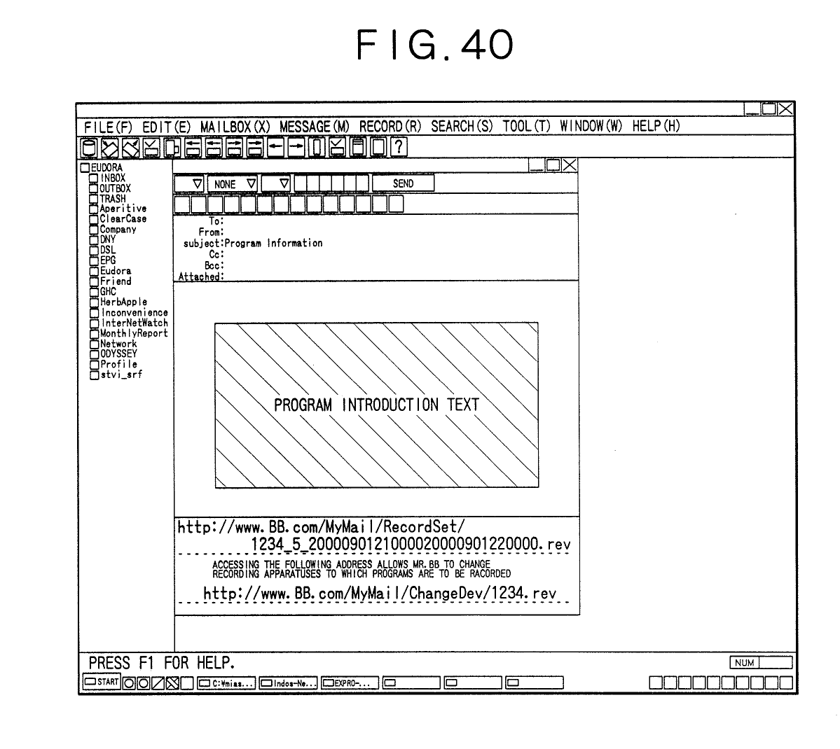

In step S231, the controller of the program information providing apparatus 43 transmits, to the mobile terminal apparatus 42c, an electronic mail message attached with a program introductory comment of the program and a URL for identifying user, program channel, broadcast start time and broadcast end time for each program introductory comment. FIG. 40 illustrates an exemplary electronic mail message transmitted from the program information providing apparatus 43 to the mobile terminal apparatus 42c. A program introductory comment summarizes the contents of a program and is placed in “Program Introductory Comment” box hatched in FIG. 40. It should be noted that no specific program introductory comment is shown.

This electronic mail message is also attached with URL “http://BB.com/MyMail/RecordSet/1234_{—}5_{—}2000090121000020000901220000.rev.” This URL indicates user identification and capabilities which can be executed by accessing this URL. “RecordSet” in the URL shown in FIG. 40 indicates that this URL is for setting program preset recording, “1234” indicates an user identifier for identifying the user of this program preset recording system 40, following “5” indicates the channel number of the program, “20000901210000” indicates the program start date and time, Sep. 1, 2000, 21:00, and “20000901220000” indicates the program end date and time, Sep. 1, 2000, 22:00.

In addition, the electronic mail message shown in FIG. 40 is attached with a recording device change mode URL for entering a mode in which the default recording section of the terminal apparatus 2 or the default recording apparatus 45 is changed to another registered recording section of the terminal apparatus 2 or another registered recording apparatus 45, the URL being “http://www.BB.com/MyMail/ChangeDev/1234.rev” for example. It should be noted that, if there is only one registered recording section of the terminal apparatus 2 or only one registered recording apparatus 45, this recording device setting change mode URL is not attached to electronic mail.

In step S232, in response to the input by the user at the mobile terminal apparatus 42c, the controller determines whether to change the default recording section of the terminal device 2 or the default recording apparatus 45 to another registered recording section of the terminal apparatus 2 or the another registered recording apparatus 45. To change the devices, the procedure goes to step S233; otherwise, the procedure goes to step S234.

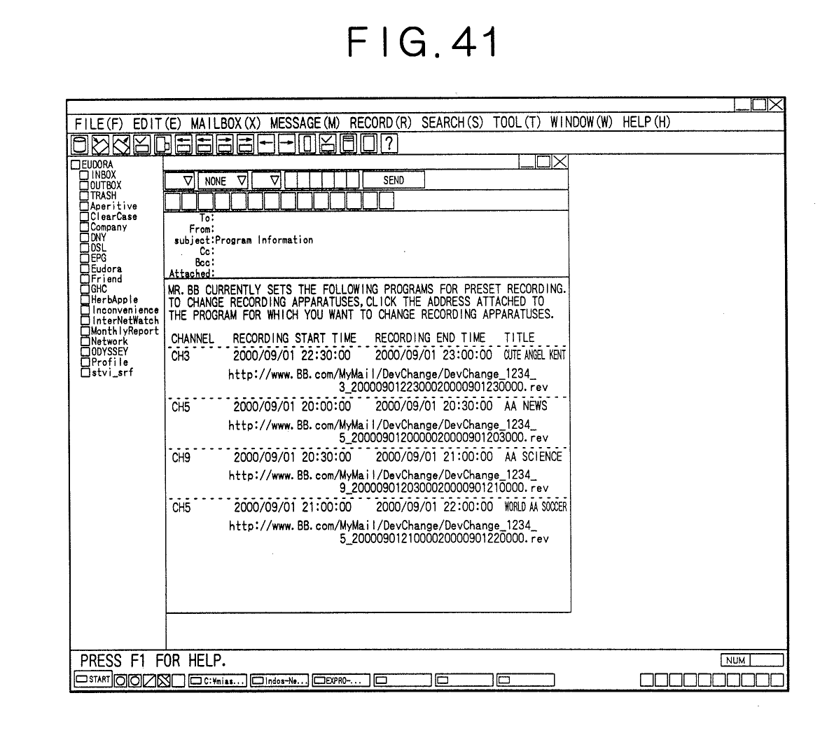

For example, to change the default recording section of the terminal apparatus 2 or the default recording apparatus 45, the user clicks the recording device change mode URL “http://www.BB.com/MyMail/ChangeDev/1234.rev” attached to the program introductory electronic mail shown in FIG. 40, upon which the recording device change mode is entered. In the recording device change mode, the controller of the program information providing apparatus 43 transmits to the mobile terminal apparatus 42c a recording device change program selection electronic mail message shown in FIG. 41 attached with a program preset recording log and recording device selection URLs for changing the recording section of the terminal apparatus 2 or the recording apparatus 45 for each program listed in the program preset recording log. As shown in FIG. 41, the recording device change program selection electronic mail is attached with a recording device selection mode URL for each of the programs set for preset recording.

As shown in FIG. 41, the program preset recording log is displayed in which the channels on which preset programs are broadcast are shown under “Channel,” such as CH3, CH5, and CH9 for example. Program recording start times are shown under “Recording Start Time” such as “2000/09/01 22:30:00” for example, which is September first, 2000, 22:30:00. Program recording end times are shown under “Recording End Time” such as “2000/09/01 23:00:00 for example, which is September first, 2000, 23:00:00. Program names are shown under “Title” such as “Cute Angel Kent” for example. URL “http://www.BB.com/MyMail/DevChange/DevChange_{—}1234_{—}3_{—2000090122300020000901230000}.rev” for example is attached to each program. The recording device selection mode URL provides user identification and indicates capabilities which can be executed by accessing this URL. “DevChange” in the URL shown in FIG. 41 indicates that this URL is for setting program preset recording, “1234” is a user identifier for identifying the user using this program preset recording system 40, “3” indicates channel number, “20000901223000” indicates program start date and time, which is September first, 2000, 22:30, and “20000901230000” indicates program end date and time, which is September first, 2000, 23:00.

In step S233, in response to the input by the user at the mobile terminal apparatus 2c, the controller changes the recording section of the terminal apparatus 2 or the recording apparatus 45 to another device. This change is executed when the user clicks the recording device selection mode URL attached to each of the programs set for preset recording in the recording device change program selection electronic mail shown in FIG. 41, upon which the recording device section mode in which the user can select a registered recording device is entered. For example, when the user clicks the recording device selection mode URL attached to a program of which title is “World AA Soccer,” the controller of the program information providing apparatus 43 transmits, to the mobile terminal apparatus 42c, a recording device selection electronic mail message attached with a recording device setting URL for selecting the specified device from the registered recording sections of the terminal apparatus 2 or the registered recording apparatuses 45 and setting the selected device.

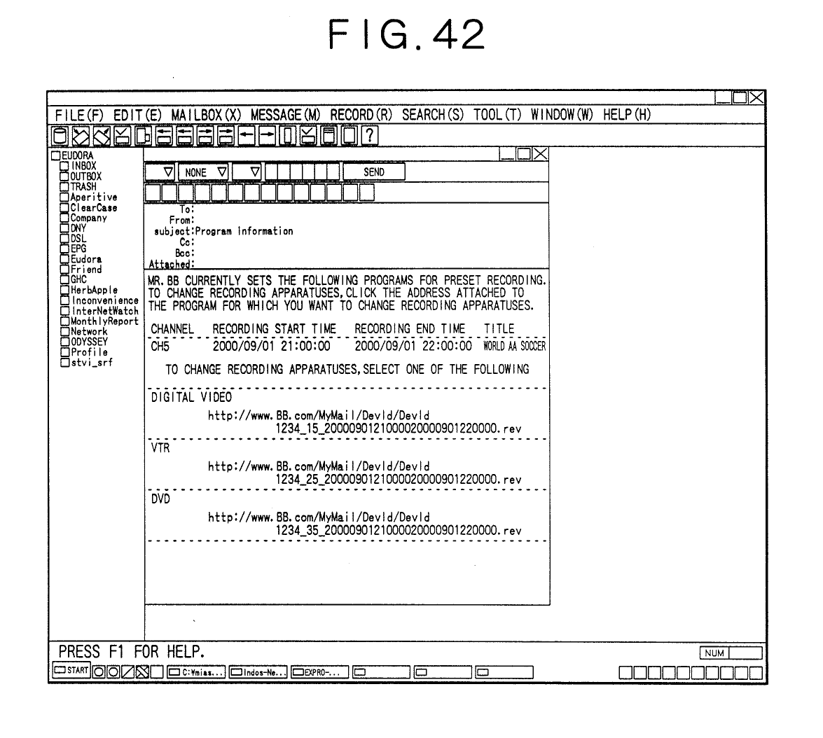

Receiving the recording device selection electronic mail, the controller of the mobile terminal apparatus 42c causes the mailer software stored in the storage section to display the recording device selection electronic mail shown in FIG. 42 for example on the display section 52c. As shown in FIG. 42, in the recording device selection electronic mail, the program information of each program for which device change is to be made shows “Channel” as “CH5” for example, “Recording Start Time” as “2000/09/01 21:00:00” for example, “Recording End Time” as “2000/09/01 22:00:00” for example, and “Title” as “World AA Soccer” for example. In addition, the controller displays all recording device setting URLs for the recording sections of the terminal apparatus 2 and the recording apparatuses 45 registered with the program preset recording system 40. One of the recording device setting URLs is displayed as “http://www.BB.com/MyMail/DevID/DevID_{—}1234_{—}15_{—}2000090121000020000901220000.rev” for example in the case of the digital video shown in FIG. 41. “1234” of the recording device setting URL for the digital video shown in FIG. 42 is a user identifier for identifying the user using this program preset recording system 40, “1” of “15” indicates device ID while “5” indicates channel number, “20000901210000” indicates program start date and time, which is September first, 2000, 21:00, and “20000901220000” indicates program end date and time, which is September first 2000, 22:00. In addition to the digital video, FIG. 42 shows VTR and DVD of which device IDs are “2” and “3” respectively, as the recording section of the terminal apparatus 2 and the recording apparatus 45 registered with the program preset recording system 40.

When the recording device selection electronic mail is displayed on the display section 52c of the mobile terminal apparatus 42c, the user selects a desired recording device setting URL at the mobile terminal apparatus 42c. When the desired URL is selected and the information thereof is transmitted to the program information providing apparatus 43, the controller of the program information providing apparatus 43 selects the default recording section of the terminal apparatus 2 and the default recording apparatus 45 as the newly selected recording section of the terminal apparatus 2 and the newly selected recording apparatus 45 and modifies the program preset recording setting script accordingly.

When the modified program preset recording setting script is transmitted, the terminal apparatus 2 sets the recording section of the terminal apparatus 2 and the recording apparatus 45 as default devices in accordion with the modified program preset recording setting script. When step S233 has been completed, the procedure goes to step S234.

In step S234, in response to the input by the user at the mobile terminal apparatus 42c, the controller determines whether to access the program preset recording setting URL attached to the program introductory electronic mail. To access this URL, the procedure goes to step S233; otherwise, the procedure comes to an end.

In step S235, in response to the access to the program preset recording setting URL attached to the program introductory electronic mail, the controller of the program information providing apparatus 43 searches the program information stored in the database 43a for a corresponding program. When step S235 has been completed, the procedure goes to steps S209 through S216 shown in FIGS. 29 and 30.

The processes of steps S209 through S216 are generally the same as those in the direct access mode. By following the above-mentioned processing, a program preset recording setting script is generated and the setting of program preset recording can be made to the terminal apparatus 2 or the recording apparatus 45 in the second mail access mode.

The following describes an operation for canceling the setting of program preset recording made on the basis of the program preset recording setting script generated in the first mail access mode described with reference to the flowcharts shown in FIGS. 39, 29, and 30.

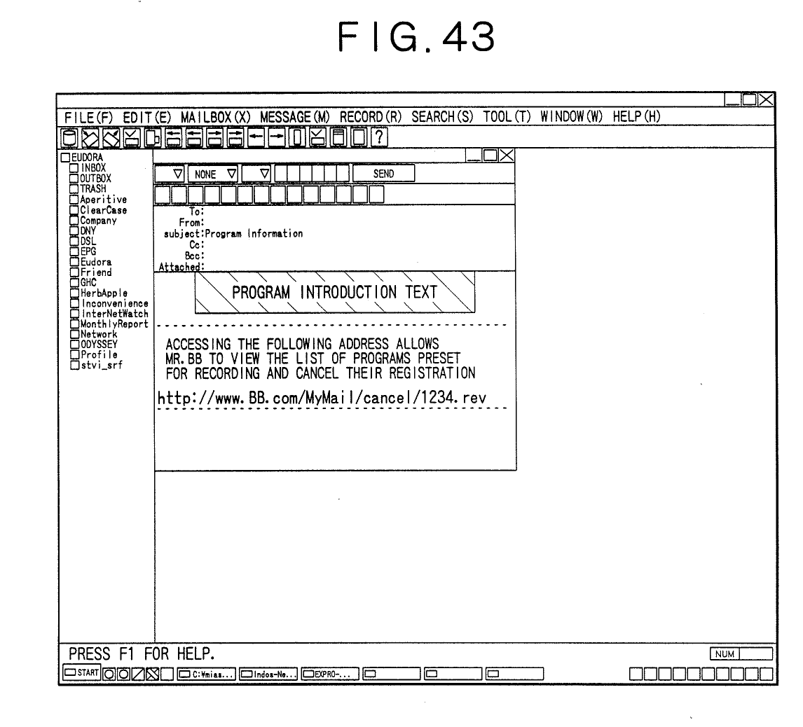

If at least one program has been set for preset recording, an electronic mail message to be transmitted from the program information providing apparatus 43 to the mobile terminal apparatus 42c in step S231 is attached with a cancel URL as shown in FIG. 43 for example, like “http://www.BB.com/MyMail/Cancel/1234.html.” This cancel URL identifies the user and indicates capabilities to be executed when accessed.

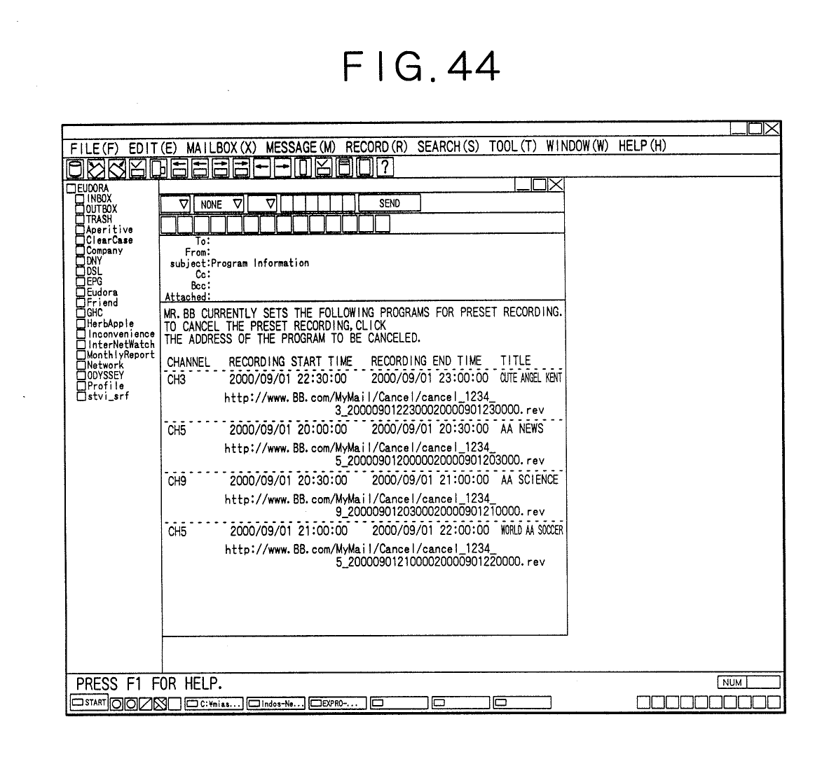

“Cancel” in the cancel URL shown in FIG. 43 indicates that this URL functions to cancel the setting of program preset recording and “1234” indicates a user identifier for identifying the user using the program preset recording system 40. To cancel the setting of program preset recording, the user clicks, at the terminal apparatus 2c, the cancel URL attached to the electronic mail. When the cancel URL is clicked, the controller of the program information providing apparatus 43 retrieves a program preset recording log in which the recording to the recording section of the terminal apparatus 2 or the recording apparatus 45 has not yet been performed from among the program preset recording logs of users stored in the database 43b, generates a program preset recording setting cancel electronic mail message attached with the cancel URL, and transmits this mail message to the mobile terminal apparatus 42c. In response, the controller of the mobile terminal apparatus 42b causes the mailer software stored in the storage section to display this electronic mail message on the display section 52b. For example, the controller of the mobile terminal apparatus 42b displays the program preset recording setting cancel electronic mail as shown in FIG. 44 on the display section 52c. In the program information of each program set for preset recording in this electronic mail message, “Channel” is shown as “CH3” for example, “Recording Start Time” as “2000/09/01/22:30:00” for example, “Recording End Time” as “2000/09/01/23:00” for example, and “Title” as “Cute Angel Kent” for example. The program preset recording setting cancel URL is shown as “http://www.com/MyMail/Cancel/cancel_{—}1234_{—}3_{—}2000090122300020000901230000.rev” for example. This cancel URL identifies the user and indicates capabilities to be executed when accessed. “Cancel” in this URL shown in FIG. 44 indicates that this URL is for canceling the setting of program preset recording, “1234” is a user identifier for identifying the user using this program preset recording system 40, “3” indicates channel number, “20000901223000” indicates program start date and time, which is September first, 2000, 22:30, and “20000901230000” indicates program end date and time, which is September first, 2000, 23:00.

When the user selects a program of which setting for preset recording is to be canceled from among the programs set for preset recording in the screen shown on the display section 52c of the mobile terminal apparatus 42c and clicks the selected program, the information thereof is transmitted to the program information providing apparatus 43. In response, the controller of the program information providing apparatus 43 generates a cancel script for canceling the setting of preset recording of the selected program. The generated cancel script is transmitted from the program information providing apparatus 43 to the terminal apparatus 2 to be converted into a control signal suitable for the processing by the recording section of the terminal apparatus 2 or the recording apparatus 45, the control signal being transmitted thereto. In accordance with the received control signal, the recording section of the terminal apparatus 2 or the recording apparatus 45 cancels the setting of the preset recording of the selected program. When the preset recording has been canceled, the corresponding program preset recording log is deleted to be registered, as a cancel log, with the account of the corresponding user in the database 43b of the program information providing apparatus 43.

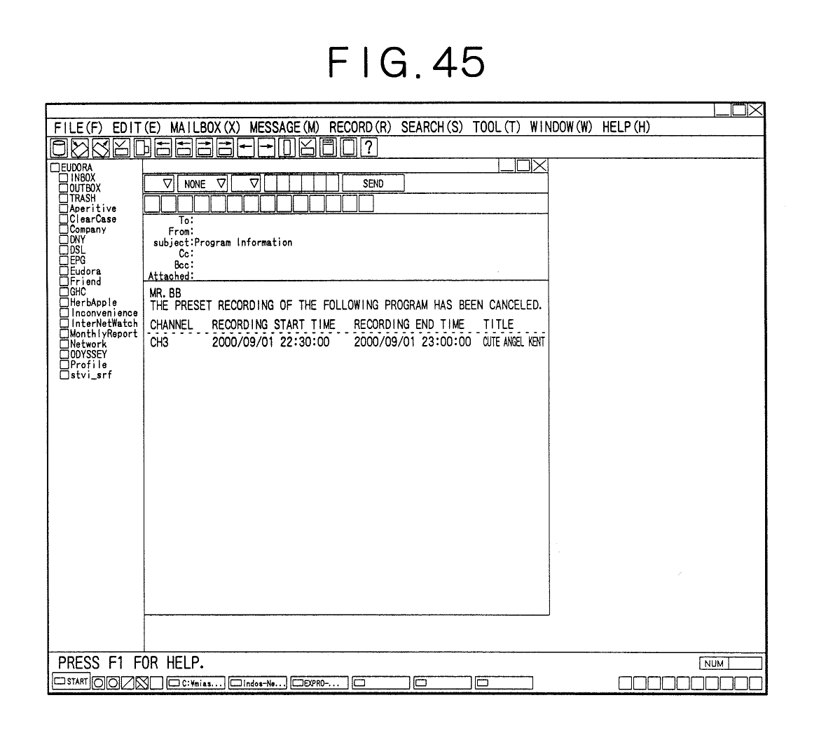

In addition to the generation of a cancel script, the controller of the program information providing apparatus 43 transmits an execution confirmation electronic mail message telling that the program preset recording setting has been canceled to mobile terminal apparatus 32c. The controller of the mobile terminal apparatus 42c displays the received cancel execution confirmation electronic mail on the display section 52c as shown in FIG. 45 for example. As shown in FIG. 45, this electronic mail shows “Channel,” “Recording Start Time,” “Recording End Time,” and “Title” for example of the program of which setting for preset recording has been canceled.

Thus, in the program preset recording system 40, the program guide stored in the database 43a of the program information providing apparatus 43 is presented to the user at the display section 52a of the mobile terminal apparatus 42a through the Web browser, a request for setting the preset recording of a user-specified program is inputted by the user at the mobile terminal apparatus, and a program preset recording setting script is generated by the program information providing apparatus 43, thereby setting the preset recording of the specified program to the recording section of the terminal apparatus 2 or the recording apparatus 45.

Further, in the program preset recording system 40, an electronic mail message attached with the program information stored in the database 43a of the program information providing apparatus 43 and a URL linked with this program information is transmitted to the mobile terminal apparatuses 42b and 42c and, in response to the access to this URL by the users of the mobile terminal apparatuses 42b and 42c, a program preset recording setting script is generated by the program information providing apparatus 43, thereby setting the preset recording of a specified program to the recording section of the terminal apparatus 2 or the recording apparatus 45.

It should be noted that, in the above-mentioned direct access mode and first and second mail access modes, the program information providing apparatus 43 can use CGI (Common Gateway Interface) to transfer/receive information on an HTTP basis, thereby performing program preset recording setting.

CGI denotes, in a server-client type network, an interface which starts, upon request from a client, a program corresponding to a request from a WWW (World Wide Web) server and returns the results obtained by this program to the client. A program started in a WWW server is referred to as a CGI script.

The program for generating a program preset recording setting script or a cancel script in each of the direct access mode and first and second mail access modes corresponds to this CGI script. The CGI script is stored in the storage section, not shown, of the program information providing apparatus 43. In the direct access mode, the program starts when accessed from the program guide. In the first and second mail access modes, the program starts when the user clicks the URL attached to the electronic mail to be transmitted to the mobile terminal apparatus 42b or 42c.

The following describes a URL for starting a CGI script to be attached to an electronic mail message to be transmitted to the mobile terminal apparatus 42b in the first mail access mode using the mobile terminal apparatus 42b. As described in step S221, the controller of the program information providing apparatus 43 transmits, to the mobile terminal apparatus 42b, an electronic mail message attached with a program introductory comment of the program and a URL for identifying program channel, broadcast start time and broadcast end time for each program introductory comment, via the Internet. Instead of “http://www.BB.com/MyMail/RecordSet/1234_{—}5_{—}2000090121000020000901220000.html,” this URL is “http://www.BB.com/MyMail/Record.cgi?userID=1234&InfraID=1&StationID=3&start=20000901210000&end=20000901220000” for example.

The above-mentioned URL is an address indicative of the location of the CGI on the Web server, the values after each “?” in the URL is an argument for starting the script.

For example, the arguments in the above-mentioned URL are shown as “userID=1234” for identifying the user of the program preset recording system 40, “InfraID=1” for identifying ground wave broadcasting from CS “2” or BS “3”, “StationID=3” for identifying a channel number corresponding to the frequency allocated to the broadcast station from which the program concerned is broadcast, “start=20000901210000” for indicating the program start date and time, which is September first, 2000, 21:00, and “end=20000901220000” for indicating the program end date and time, which is September first, 2000, 22:00. Each argument is concatenated with another with symbol “&”.

The following describes operations of accessing the above-mentioned URL, generating a program preset recording setting script, and executing program preset recording setting.

First, when the user clicks the URL at the mobile terminal apparatus 42b, a script generating command for generating a program preset recording setting script and the program information such as program broadcasting station, broadcasting means, and broadcast start and end times to the program information providing apparatus 43 to be stored in the database 43b for each user account.

The terminal apparatus 2 periodically operates on a time-managing timer and a power control capability, establishing an Internet session with the program information providing apparatus 43.

When an Internet session is established between the program information providing apparatus 43 and the terminal apparatus 2, the program preset recording setting script pickup software stored in the storage section, not shown, of the terminal apparatus 2 accesses the program information providing apparatus 43 by use of the authentication information such as user login ID and password, thereby authenticating the user for using a program preset recording setting script generating CGI script stored in the storage section of the program information providing apparatus 43. When the user authentication has been completed, the program preset recording setting script generating CGI script generates a program preset recording setting script from the script generating command and program information stored in the database 43b for each user account and transmits the generated program preset recording setting script to the terminal apparatus 2. Receiving the program preset recording setting script, the terminal apparatus 2 stores the program preset recording setting script in its storage section or the recording apparatus 45 to perform a program preset recording setting operation.

When the program has been set for preset recording by the program preset recording setting script, the program information providing apparatus 43 notifies the mobile terminal apparatus 42b of the success or failure of the setting.

First, after the program has been set for preset recording by the program preset recording setting script, the terminal apparatus 2 accesses the program information providing apparatus 43 by use of the authentication information to authenticate the user who uses a program preset recording setting result report CGI script for notifying the mobile terminal apparatus 42b of the completion of the program preset recording setting stored in the storage section of the program information providing apparatus 43. When the user authentication has been completed, the program preset recording setting result report CGI script generates an electronic mail message for notifying the result of the program preset recording setting by using the program information as argument and transmits the generated electronic mail message to the mobile terminal apparatus 42b.

Further, the terminal apparatus 2 transmits the program information of the program set for preset recording to the recording section of the terminal apparatus 2 or the recording apparatus 45 to the program information providing apparatus 43, thereby causing the program information providing apparatus 43 to generate a log of the program set for preset recording.

First, the terminal apparatus 2 accesses the program information providing apparatus 43 by use of the authentication information to authenticate the user for using the program preset recording log generating CGI script for generating a log of the program set for preset recording stored in the storage section of the program information providing apparatus 43. After the user authentication has been completed, the program preset recording log generating CGI script generates a program preset recording log of the program set for preset recording by use of the program information of the program set for preset recording as argument. The generated program preset recording log is transmitted to the terminal apparatus 2 to be stored in its storage section.

In addition, the terminal apparatus 2 transmits the program information of the program recorded to a recording medium by the recording section of the terminal apparatus 2 or the recording apparatus 45 to the program information providing apparatus 43, thereby causing the program information providing apparatus 43 to generate a log of the program which has been recorded to the recording medium.

First, the terminal apparatus 2 accesses the program information providing apparatus 43 by use of authentication information to authenticate the user for using a program recording completion log generating CGI script for generating a log of the program set for preset recording and recorded to the recording medium in the storage section of the program information providing apparatus 43. After the user authentication has been completed, the program recording completion log generating CGI script generates a program recording completion log by use of the program information of the program recorded to the recording medium as argument. The generated program recording completion log is transmitted to the terminal apparatus 2 to be stored in its storage section.

By executing communication by use of CGI on an HTTP or HTTPS basis in the program information providing apparatus 43 as described above, a device change operation may also be made on the default recording section of the terminal apparatus 2 or the recording apparatus 45 in generally the same manner as above.

Moreover, the process of generating the above-mentioned program preset recording setting script applies when generating a cancel script. Namely, the user clicks the URL attached to an electronic mail message transmitted to the mobile terminal apparatus 42b to access the cancel CGI script stored in the storage section of the program information providing apparatus 43, thereby generating a cancel script for canceling the setting of preset recording of the program set to the recording section of the terminal apparatus 2 or the recording apparatus 45.

In the direct access mode using the mobile terminal apparatus 42a and the second mail access mode using the mobile terminal apparatus 42c, use of CGI allows to perform all operations mentioned above, such as the program preset recording setting by a program preset recording setting script, the cancellation of program preset recording setting by a cancel script, and the device change on default devices.

Thus, the communication between the program information providing apparatus 43 and the terminal apparatus 2 between which an Internet session has been established by use of HTTP or HTTPS, which is a communication protocol obtained by adding a security capability to HTTP and each kind of CGI script stored in the storage section of the program information providing apparatus 43 is used, thereby enhancing the user-friendliness in the setting of program preset recording in the program preset recording system 40 and enhancing the security against the information leakage which may be caused by information transaction.

The use of HTTPS as a communication protocol for the communication which involves personal information transfer between the mobile terminal apparatuses 42a, 42b, and 42c, the program information providing apparatus 43, and the terminal apparatus 2 between which an Internet session has been established enhances the security, thereby preventing the leakage of personal information.

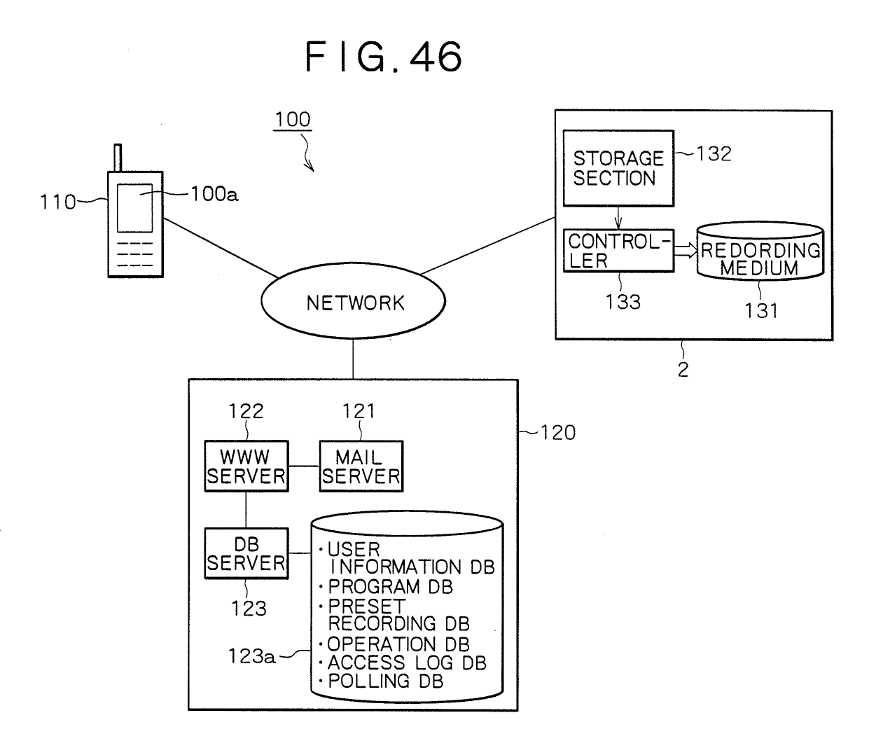

The following describes a program preset recording system 100 obtained by adapting the program preset recording system 40 more to actual services with reference to FIG. 46.

The program preset recording system 100 comprises a mobile terminal apparatus 110, a server apparatus 120, and a terminal apparatus 2.

The mobile terminal apparatus 110 is a portable wireless telephone device having a display section 110a, which is a LCD (Liquid Crystal Display) for example, capable of displaying text information and image information. The mobile terminal apparatus 110 also has, in its storage section not shown, mailer software for transferring/receiving electronic mail and browser software for downloading HTML data from a WWW server 122 of the server apparatus 120 and displaying the downloaded HTML data on the display section 110a of the mobile terminal apparatus 110.

The server apparatus 120 has a mail server 121, the WWW server 122, and a database server 123 and provides the source of service provision in the program preset recording system 100, performing the information management for the users who use the program preset recording system 100 and generating program preset recording setting scripts, which are control commands for executing a program preset recording setting operation at the terminal apparatus 2.

The electronic mail to be generated by the mail server 121 and transmitted to the mobile terminal apparatus 110 is of two kinds; visit mail and operation result mail.

The visit mail is generated at a predetermined time attached with a URL for accessing the WWW server 122 of the server apparatus 120 and is transmitted to the mobile terminal apparatus 110. When the user accesses the URL attached to the visit mail at the mobile terminal apparatus 110, a session is established with the server apparatus 120 to be ready for receiving various services from the server apparatus 120.

On the other hand, the operation result mail carries the results of the execution of a command by the server apparatus 120 in response to the command inputted by the user at the mobile terminal apparatus 110.

The WWW server 122 has a plurality of CGI scripts for executing programs for predetermined operations in accordance with the arguments written in a URL. For example, the CGI scripts generate a program guide on demand from the mobile terminal apparatus 110 or the terminal apparatus 2 in accordance with the arguments written in a URL to send the generated program guide via the Internet and generate a program preset recording setting script, which is a control command for setting a program preset recording operation, for example.

The database server 123 has and manages a database 123a which stores the user information of users of the program preset recording system 100, the program information of programs which can be set for preset recording in the program preset recording system 100, and all other data associated with this system.

The database 123a consists of a plurality of databases which store all data associated with the program preset recording system 100 as classified by type. The following describes examples of these databases contained in the database 123a managed by the database server 123 (hereinafter, a database is also referred to as a DB).

The database 123a contains a user information DB storing such personal information of users of the program preset recording system 100 as user IDs and passwords for example, a program DB storing the program information of programs which can be set for preset recording in the program preset recording system 100, a preset recording DB storing the information of programs set by the user for preset recording, an access log DB storing the logs of access to the server apparatus 120 by the terminal apparatus 2, an operation DB storing operation scripts, and a polling DB storing the logs of times at which access was periodically made to the server apparatus 120 by the access software of the mobile terminal apparatus 110.

The terminal apparatus 2 is a PC having a ground wave tuner, not shown, for receiving ground wave television signals transmitted from a television station, not shown, a recording medium such as HDD (Hard Disk Drive), and a recording section, not shown for recording the received television signals to the recording medium 131.

The terminal apparatus 2 has a display section, not shown, for displaying programs broadcast from a television station, allowing the user to view desired programs.

A storage section 132 of the terminal apparatus 2 stores access software which periodically accesses the server apparatus 120 to download a program preset recording setting script generated by the WWW server 122 and converts the downloaded program preset recording setting script into a control signal suitable for the processing by the above-mentioned recording section.

A controller 133 of the terminal apparatus 2 automatically records a program received by the ground wave tuner to the recording medium in accordance with the control signal obtained from the program preset recording setting script by the above-mentioned access software.

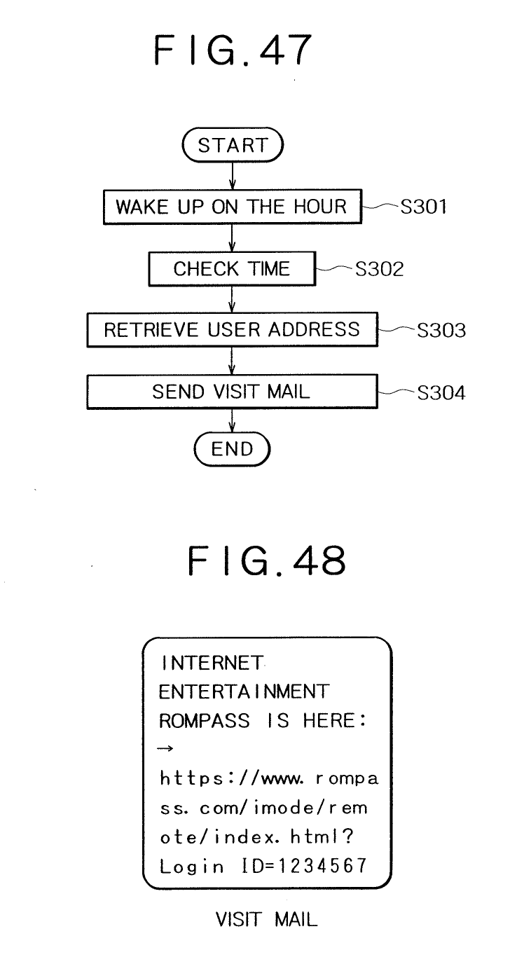

The following describes a processing operation to be executed when performing program preset recording in the program preset recording system 100 with reference to the flowchart shown in FIG. 47.

The mail server 121 of the server apparatus 120 starts at a predetermined time (step S301), checks a visit mail transmission time (step S302), searches the addresses of registered users of the program preset recording system 100 stored in the database 123a for the mail address of a predetermined user (step S303), generates a visit mail message attached with a URL for accessing the server apparatus 120, and sends the generated visit mail message (step S304).

The mobile terminal apparatus 110 receives the visit mail message from the mail server 121 and causes mailer software stored in its storage section, not shown, to display the visit mail message on the display section 110a.

At this moment, the visit mail message as shown in FIG. 48 is displayed on the display section 110a of the mobile terminal apparatus 110. The URL attached to the visit mail message is “https://www.rompass.com/imode/remote/index.html?LoginID=1234567” for example, user “LoginID” as an argument being written as “1234567” in advance. Consequently, when the server apparatus 120 is accessed by the user from the mobile terminal apparatus 110 via this URL, the server apparatus 120 can identify which user has made this access request.

When the user accesses the URL attached to the visit mail message at the mobile terminal apparatus 110, the controller, not shown, of the mobile terminal apparatus 110 instantly starts browser software stored in its storage section. This browser software accesses the WWW server 122 of the server apparatus 120 to request for the transfer of HTML information written in the URL.

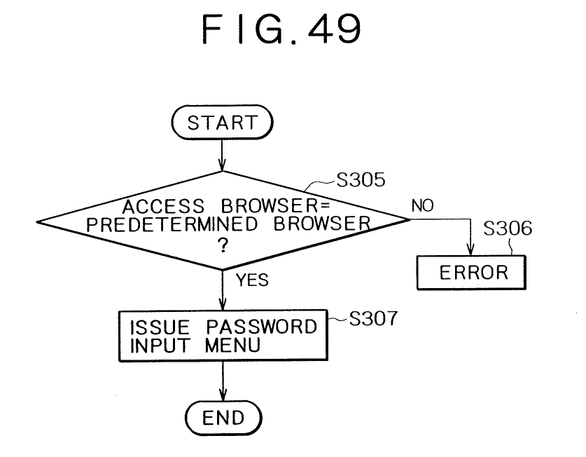

In response, as shown in the flowchart of FIG. 49, the WWW server 122 of the server apparatus 120 determines whether the accessing browser software is the predetermined browser software of the mobile terminal apparatus 110 of which is use is allowed in the program preset recording system 100 (step S305). If the browser software is found not the authorized browser software, the WWW server 122 sends an error message to the mobile terminal apparatus 110 (step S306). If the browser software is found the authorized browser software, then the WWW server 122 issues an authentication menu screen written in HTML for prompting the input of user password and transmits the menu screen to the mobile terminal apparatus 110 (step S307).

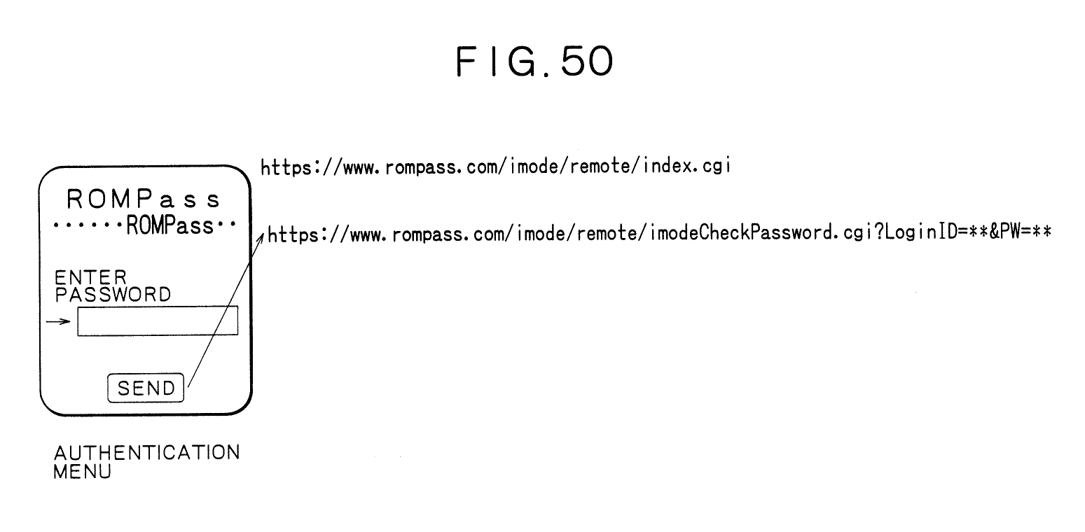

The browser software of the mobile terminal apparatus 110 receives the HTML information from the WWW server 122, analyzes the received HTML information, and displays a resultant authentication menu screen as shown in FIG. 50 for example on the display section 110a.

The authentication menu screen has a password input box and “Send” button for transmitting the inputted password. This “Send” button corresponds to the URL of the WWW server 122. The password inputted in the password box becomes the argument of this URL. For example, the URL linked with “Send” button is expressed as “https://www.rompass.com/imode/remote/imodeCheckPassword.cgi?LoginID=**&PW=**” for example, “LoginID=” being followed by the login ID of the user and “PW=” being followed by the password of the user.

When the user clicks “Send” button to access this URL, the browser software of the mobile terminal apparatus 110 accesses the WWW server 122 of the server apparatus 120, thereby requesting the transfer of the HTML written in the URL.

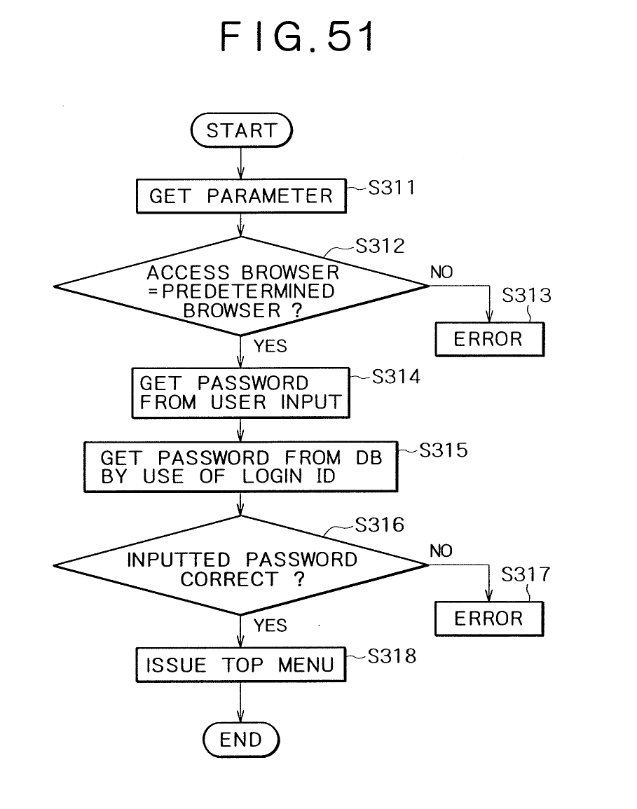

In response, as shown in the flowchart of FIG. 51, the WWW server 122 of the server apparatus 120 gets the argument written in the URL (step S311) to determine whether the accessing browser software is the predetermined browser software of the program preset recording system 100 of which use is allowed in the program preset recording system 100 (step S312). If the browser software is found not the authorized browser software, the WWW server 122 sends an error message to the mobile terminal apparatus 110 (step S313). If the browser software is found the authorized browser software, then the WWW server 122 gets the password written in the URL (step S314).

The CGI script of the WWW server 122 controls the database server 123 to search the database 123a for the corresponding user password by use of the login ID written in the URL (step S315). Further, the CGI script compares the password retrieved by the database server 123 with the password inputted by the user (step S316). If these passwords are found mismatching, the WWW server 122 sends an error message to the mobile terminal apparatus 110 (step S317). If these passwords are found matching, the WWW server 122 issues a top menu screen written in HTML for selecting a mode for requesting a program guide or a mode for requesting a preset completion list of programs already set for preset recording and transmits this screen to the mobile terminal apparatus 110 (step S318).

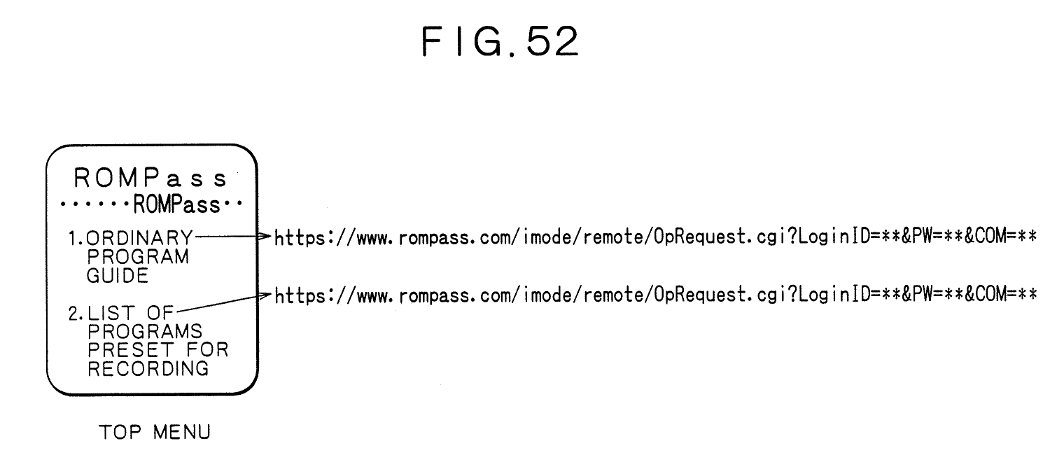

The browser software of the mobile terminal apparatus 110 receives the HTML information from the WWW server 122, analyzes the received HTML information, and displays a resultant authentication menu screen as shown in FIG. 52 for example on the display section 110a.

The top menu screen allows the user to select one of the modes “1: Ordinary program guide” for retrieving a program guide and “2: Preset completion list” for displaying a list of programs already set for preset recording. These modes are linked with the URL of the WWW server 122 as shown below. The URL is written as “https://www.rompass.com/imode/remote/OpRequest.cgi?LoginID=**&PW=**&COM=″” for example, having “LoginID” and “PW” and “COM” as arguments. “COM=” is followed by a predetermined command. In this example, the command for indicating “1: Ordinary program guide” or “2: Preset completion list” depending on the user selection becomes the argument. When this URL is accessed, the browser software of the mobile terminal apparatus 110 accesses the WWW server 122 of the server apparatus 120 to request the transfer of the HTML information written in this URL.

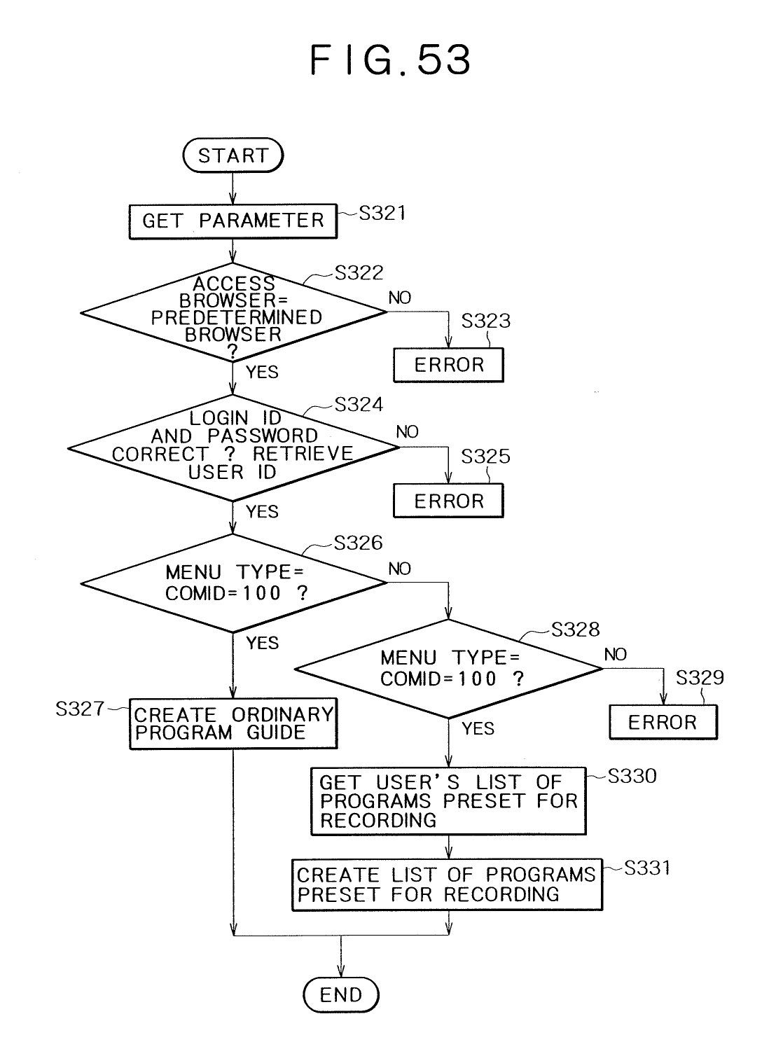

In response, as shown in the flowchart of FIG. 53, the WWW server 122 of the server apparatus 120 gets the argument written in the URL (step S321) to determine whether the accessing browser software is the predetermined browser software of the mobile terminal apparatus 110 of which use is allowed in the program preset recording system 100 (step S322). If the browser software is found not the authorized browser software, the WWW server 122 transmits an error message to the mobile terminal apparatus 110 (step S323).

If the browser software is found the authorized browser software, then the database server 123 compares the login ID and password written in the URL with those stored in the database 123a (step S324). If they are found mismatching, the database server 123 sends an error message to the mobile terminal apparatus 110 (step S325). If they are found matching, the database server 123 determines whether the command ID written in the URL is 100 for example which indicates the ID number of “1: Ordinary program guide” (step S326). If the command ID is found 100, a predetermined CGI script stored in the storage section of the WWW server 122 generates a program guide in the form of HTML (step S327).

If the command ID is not 100, then the database server 123 determines whether the command ID is 101 for example which indicates the ID number of “2: Preset completion list” (step S328). If the command ID is found not 101, the database server 123 sends an error message to the mobile terminal apparatus 110 (step S329). If the command ID is found 101, a predetermined CGI script stored in the storage section of the WWW server 122 gets from the database 123a a preset recording list of the programs already set for preset recording by the user (step S330) to generate a preset completion list in the form of HTML (step S331).

The generated program guide or preset completion list is transmitted to the mobile terminal apparatus 110 to be displayed by the browser software, not shown, on the display section 110a. Viewing the display section 110a of the mobile terminal apparatus 110, the user selects a predetermined program to set the preset recording or cancel the setting of preset recording.

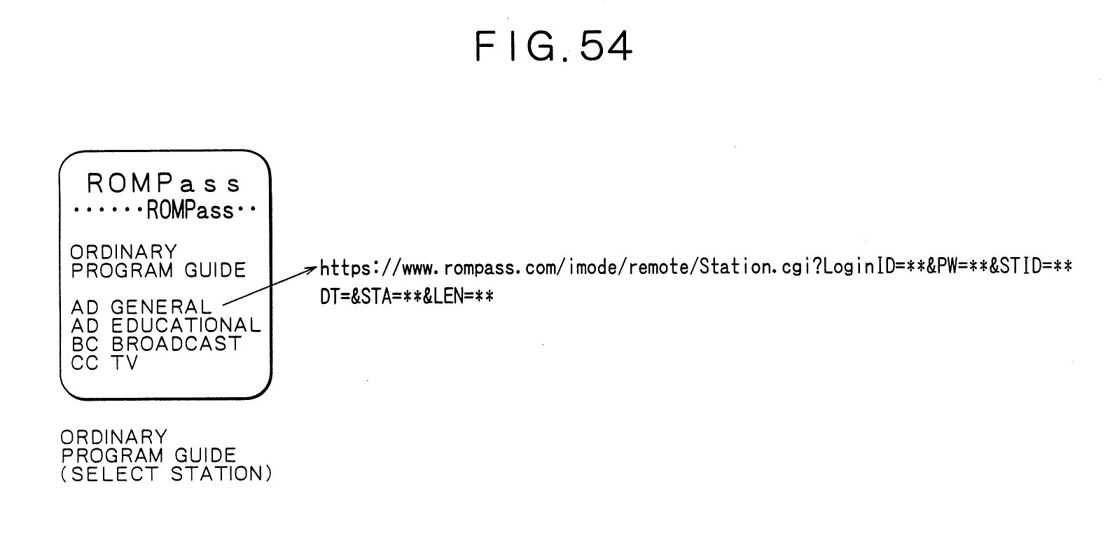

For example, if the user selects “1: Ordinary program guide” on the screen shown in FIG. 52, the ordinary program guide is generated by the server apparatus 120 and a list of broadcast stations which broadcast the programs as shown in FIG. 54 is displayed on the display section 110a of the mobile terminal apparatus 110.

Each broadcast station displayed on the display section 110a has its ID number, which is written to the URL when the user selects that broadcast station as a CGI argument. For example, the URL becomes “https://www.rompass.com/imode/remote/Station.cgi?LoginID=**&PW=**&STID=**&DT=**&STA=**&LEN=**”, broadcast ID, date of program guide transmission, and time zone of program guide transmission being written to positions of “**” following “STID=”, “DT=”, “STA=” and “LEN=” respectively.

For example, if the user wants a program guide of the broadcast station called “AD General” for only two hours start at 19:00 of Mar. 29, 2000, then if the ID of this station is “1”, the arguments become “STID=1”, “DT=20000329”, “STA=190000”, and “LEN=020000”.

When the user accesses this URL, the browser software of the virtual program guide providing system 10 accesses the WWW server 122 of the server apparatus 120 to request the transfer of the HTML information written in the URL.

When the URL having a broadcast station selecting argument is accessed, a program selection screen is displayed on the display section 110a of the mobile terminal apparatus 110, the screen allowing the user to select a desired program from among the programs arranged in a time-dependent manner to be broadcast from that station.

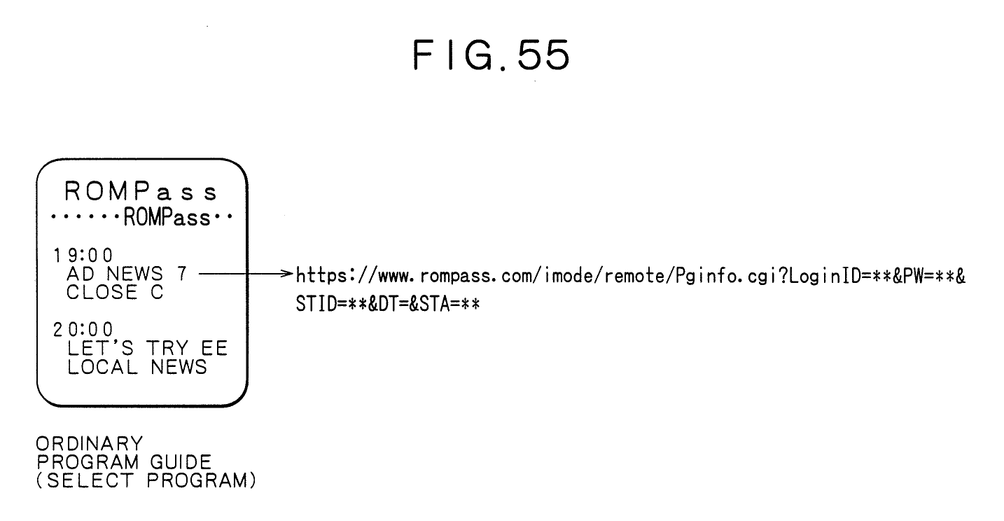

With reference to the screen shown on the display section 110a of the mobile terminal apparatus 110 shown in FIG. 55, the user selects a desired program to be set for preset recording.

Each program is linked with a URL for accessing the WWW server 122 of the server apparatus 120, the URL being attached with a different argument for a different program. For example, the URL is “https://www.rompass.com/imode/remote/Station.cgi?LoginID=**&PW=**&STID=**&DT=**&STA=**” having login ID, password, station ID, broadcasting date, and broadcasting start time of the program as arguments.

For example, if the user selects “AA News 7” to be broadcast at 19:00, arguments “DT=20000329”, which is the broadcasting date Mar. 29, 2000 and “STA=190000”, which is broadcasting start time 19:00 are attached to the URL. Consequently, the user-specified program “AA News 7” can be identified.

The screen shown on the display section 110a shown in FIG. 55 can be scrolled by the user at the input section, not shown, of the mobile terminal apparatus 110. Therefore, if there are two or more programs scheduled for broadcasting in the specified time zone as shown in FIG. 54, the user can scroll the screen to any desired program.

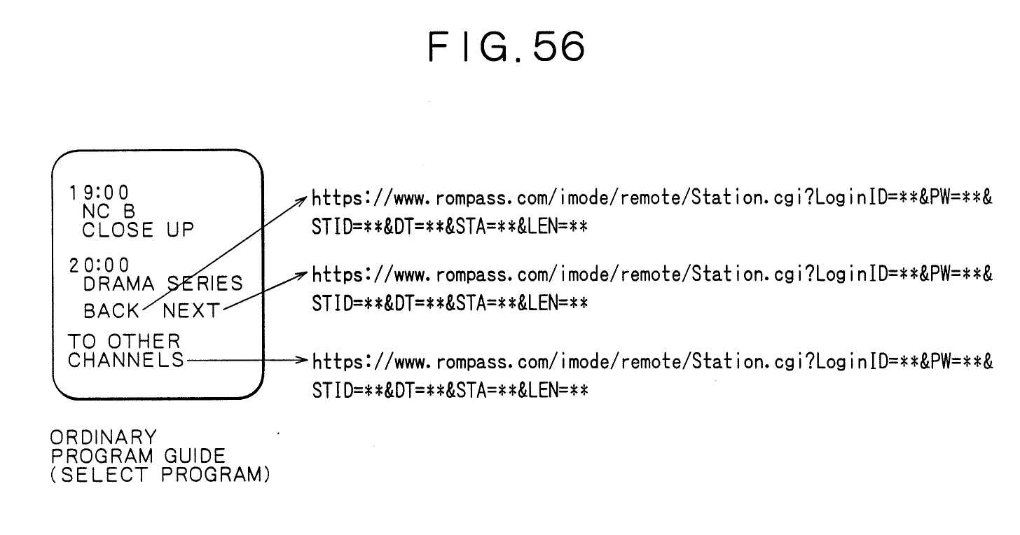

As shown in FIG. 56, if the desired program is broadcast before the time shown on the screen on the display section 110a, user clicks “Back” button or, if the desired program is broadcast after the displayed time, the user clicks “Next” button. If the user wants to preset a program to be broadcast from another station, the user clicks “To Another Channel” button. Consequently, a new program selection screen is shown on the display section 110a for program selection by the user in the above-mentioned procedure.

Each of the above-mentioned buttons is linked with a URL corresponding to the WWW server 122 of the server apparatus 120, each URL having an argument for identifying the button.

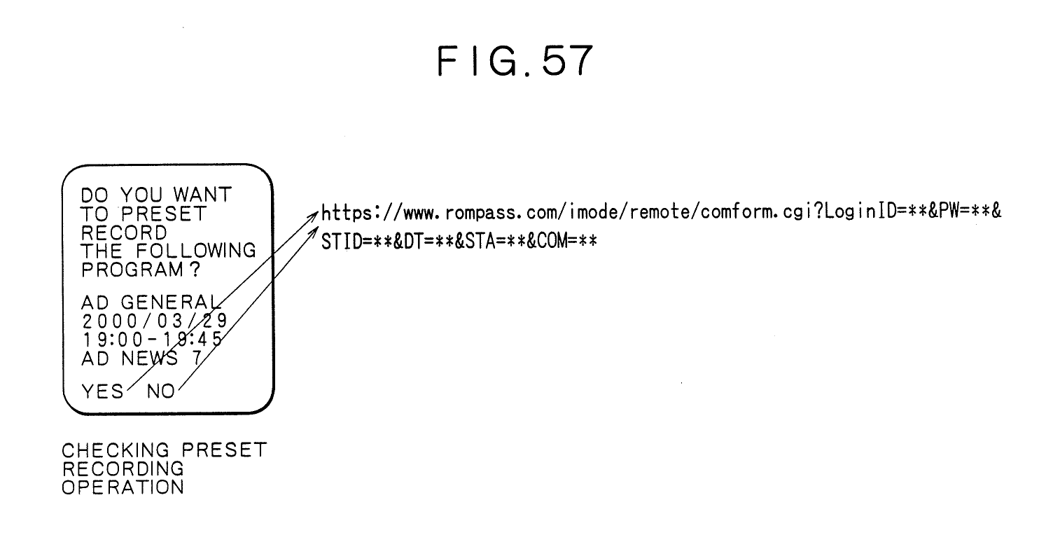

When a program is selected by the user as shown in FIG. 55 or 56, the browser software of the mobile terminal apparatus 110 gets HTML information from the WWW server 122 and analyzes the obtained HTML information to display a resultant preset recording operation confirmation screen as shown in FIG. 57 on the display section 110a.

It is assumed that program “AD News 7” of station “AD General” to be broadcast from 19:00 to 19:45 on Mar. 29, 2000 has been selected by the user. The preset recording operation confirmation screen shown in FIG. 57 has “Yes” button and “No” button for finally making confirmation of whether the user sets the preset recording of the program. To set the preset recording, the user clicks “Yes” button. To cancel the setting, the user clicks “No” button. These buttons are linked with the following URL. When one of the buttons is clicked, the browser software of the mobile terminal apparatus 110 searches the WWW server 122 of the server apparatus 120 for the HTML information and requests the transmission of the retrieved HTML information.

The URL linked with each of the above-mentioned buttons is “https://www.rompass.com/imode/remote/confirm/.cgi?LoginID=**&PW=**&STID=**&DT=**&STA=**&COM=**” for example, login ID, password, program broadcasting date, program broadcasting start time, and command ID being attached as CGI script arguments. For the command ID, the ID number of a command for setting preset recording is attached for the URL linked with “Yes” button or the ID number of a command for not setting preset recording is attached for the URL linked with “No” button, each ID number being written after “&COM=”.

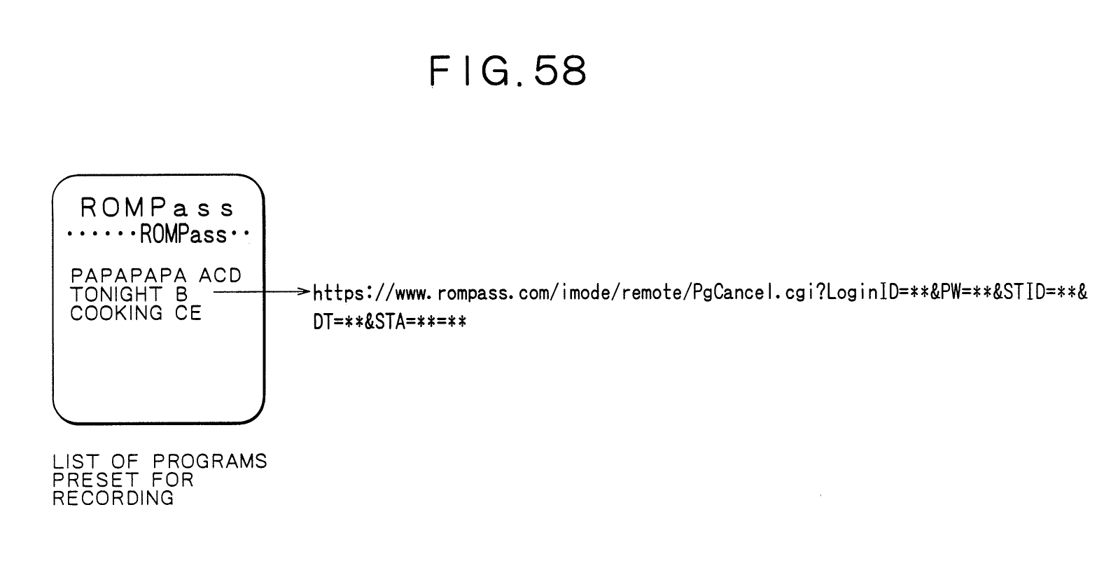

On the other hand, if “2: Preset completion list” is selected on the screen shown in FIG. 52, a preset completion list is generated in the server apparatus 120 and the generated list is shown on the display section 110a of the mobile terminal apparatus 110 as shown in FIG. 58. Each of the program in this list is linked with a URL for accessing the WWW server 122 of the server apparatus 120, a different argument being attached to a different URL.

For example, the above-mentioned URL is “https://www.rompass.com/imode/remote/PgCancel.cgi?LoginID=**&PW=**&STID=**&DT=**&STA=**2” having login ID, password, station ID, broadcasting date, and broadcasting time as arguments.

If the user selects program “PaPaPaPa ACD” for example, the URL is attached with arguments “DT=20000328” indicative of program broadcasting date Mar. 28, 2000 and “STA=190000” indicative of broadcast start time 19:00. Consequently, program “PaPaPaPa ACD” selected by the user can be identified.

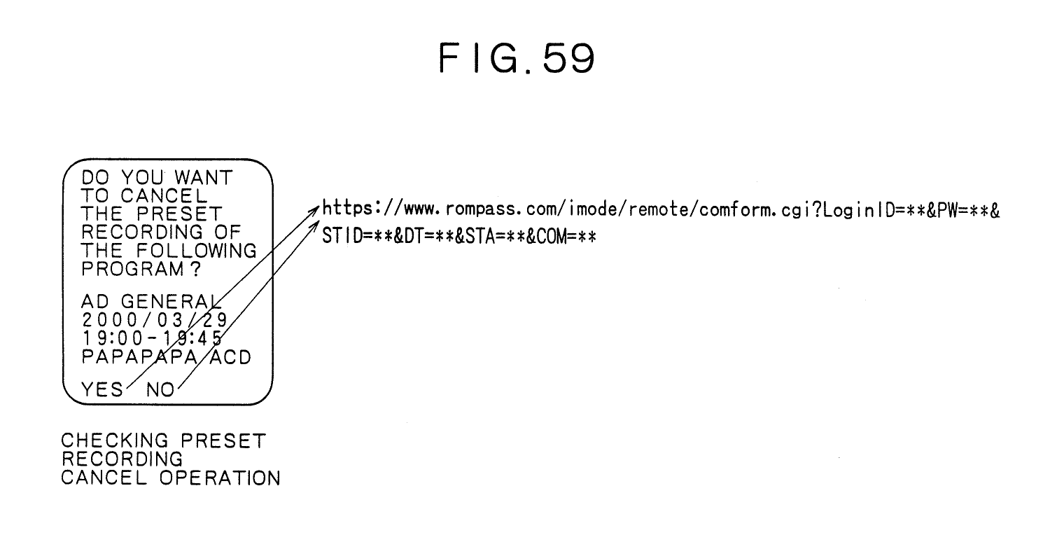

When the program is selected by the user as shown in FIG. 58, the browser software of the mobile terminal apparatus 110 gets HTML information from the WWW server 122 and analyzes the retrieved HTML information to display a preset operation confirmation screen as shown in FIG. 59 on the display section 110a.

It is assume here that program “PaPaPaPa ACD” of station “AD General” to be broadcast from 19:00 to 19:45 on Mar. 28, 2000 be selected as shown in FIG. 58. The preset recording operation confirmation screen shown in FIG. 59 has “Yes” button and “No” button for finally making confirmation of whether the user sets the preset recording of the program. To set the preset recording, the user clicks “Yes” button. To cancel the setting, the user clicks “No” button. These buttons are linked with the following URL. When one of the buttons is clicked, the browser software of the mobile terminal apparatus 110 searches the WWW server 122 of the server apparatus 120 for the HTML information and requests the transmission of the retrieved HTML information.

The URL linked with each of the above-mentioned buttons is “https://www.rompass.com/imode/remote/confirm/.cgi?LoginID=**&PW=**&STID=**&DT=**&STA=**&COM=**” for example, login ID, password, program broadcasting date, program broadcasting start time, and command ID being attached as CGI script arguments. For the command ID, the ID number of a command for canceling the setting of preset recording is attached for the URL linked with “Yes” button or the ID number of a command for not canceling the setting of preset recording is attached for the URL linked with “No” button, each ID number being written after “&COM=”.

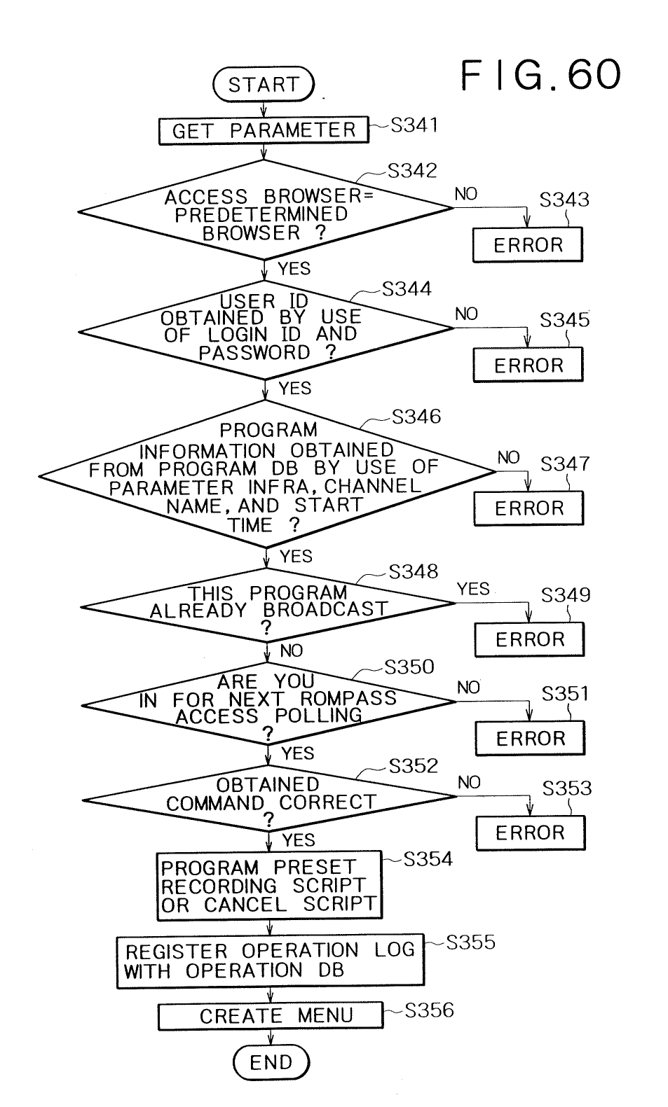

The following describes, with reference to the flowchart shown in FIG. 60, an operation of the server apparatus 120 to be executed when program preset recording is set or the setting of program preset recording is canceled on the screen shown in the display section 110a of the mobile terminal apparatus 110 shown in FIG. 57 or 59.

First, when the user clicks “Yes” or “No” button of the preset recording confirmation screen or preset recording setting cancel screen shown in FIG. 57, the WWW server 122 of the server apparatus 120 gets an argument written in the URL accordingly (step S341) to determine whether the accessing browser software is the predetermined browser software of the mobile terminal apparatus 110 of which use is allowed in the program preset recording system 100 (step S342).

If the accessing browser software is found to the authorized browser software, the WWW server 122 of the server apparatus 120 sends an error message to the mobile terminal apparatus 110 (step S343). If the accessing browser software is found the authorized browser software, then the database server 123 compares the login ID and password of written in the URL with those stored in the database 123a (step S344). If they are found mismatching, the database server 123 sends an error message to the mobile terminal apparatus 110 (step S345). If they are found matching, the database 123 searches the program information stored in the program DB for the corresponding program information by use of the station ID and program start time arguments obtained in step S341 (step S346).

If no corresponding program information is found, the database server 123 sends an error message to the mobile terminal apparatus 110 (step S347). If the corresponding program information is found, the database server 123 determines whether the program written in the URL is one broadcast before the current time (step S348). If the program is found broadcast in the past, the database server 123 sends an error message to the mobile terminal apparatus 110 (step S349).

For example, in step S348, the controller, not shown, of the server apparatus 120 determines that the broadcast start time has passed if T1prog (T1curr where T1prog is program start time and T1curr is current time. Then, in step S349, the controller notifies the mobile terminal apparatus 110 thereof. If T1prog>T1curr, the controller of the server apparatus 120 determines that the program has not yet been broadcast, upon which the procedure goes to step S350.

In step S350, let time at which the access software of the terminal apparatus 2 polled last (the time at which the terminal apparatus 2 accesses the server apparatus 120) be P0prev and a polling interval at which the terminal apparatus 2 polls the server apparatus 120 be INTVPo for example, then polling time P0next at which the access software of the mobile terminal apparatus 110 polls the server apparatus 120 is expressed as P0next=P0prev+INTVPo.

Therefore, if T1prog≦P0next, the controller of the server apparatus 120 determines that the program preset recording cannot be set, upon which the procedure goes to step S351, in which the controller notifies the mobile terminal apparatus 110 thereof.

If T1prog>P0next, the procedure goes to step S352, in which the controller of the server apparatus 120 executes the setting of program preset recording at the next polling by the access software of the mobile terminal apparatus 110.

Next, the controller of the server apparatus 120 determines whether the command ID obtained in step S341 is an authorized command (step S352). If the command is found not authorized, the controller sends an error message to the mobile terminal apparatus 110 (step S353).

The controller of the server apparatus 120 generates a program preset recording setting script or a program preset recording setting cancel script of a predetermined format adapted to the preset recording setting software of the terminal apparatus 2 (hereinafter, a program preset recording setting script or a program preset recording setting cancel script is also referred to as an operation script) (step S354). This predetermined format has station name, program start time, program end time, program title, program attribute information for example as well as command and user login ID as extension information.

In response to the generation of the operation script, the controller of the server apparatus 120 registers, as an operation log, the access from the mobile terminal apparatus 110 with the operation DB of the database 123a (step S355) and notifies the mobile terminal apparatus 110 of the acceptance of a preset event. If the terminal apparatus 2 receives a program preset recording setting script or a program preset recording setting cancel script, the controller notifies the mobile terminal apparatus 110 of the transmission of electronic mail having information thereof (step S356).

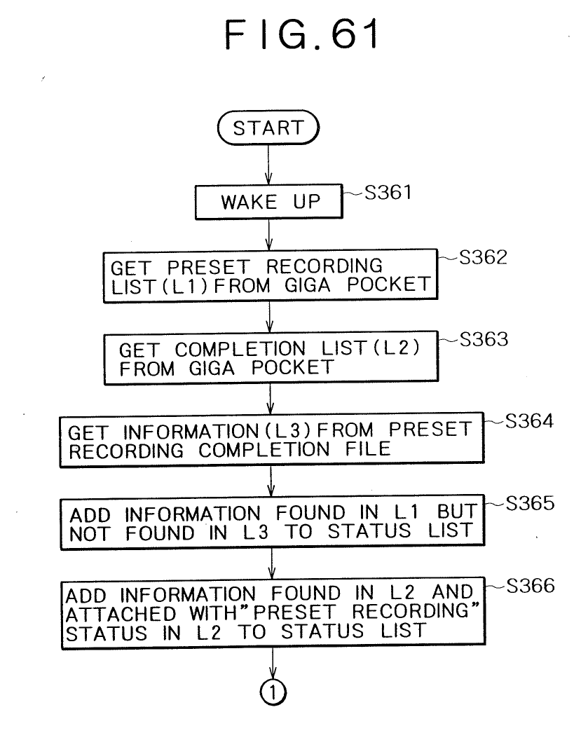

When a program preset recording setting script or a program preset recording setting cancel script has been generated, the terminal apparatus 2 downloads the generated script from the server apparatus 120 as described in the flowcharts shown in FIGS. 61, 62, and 65.

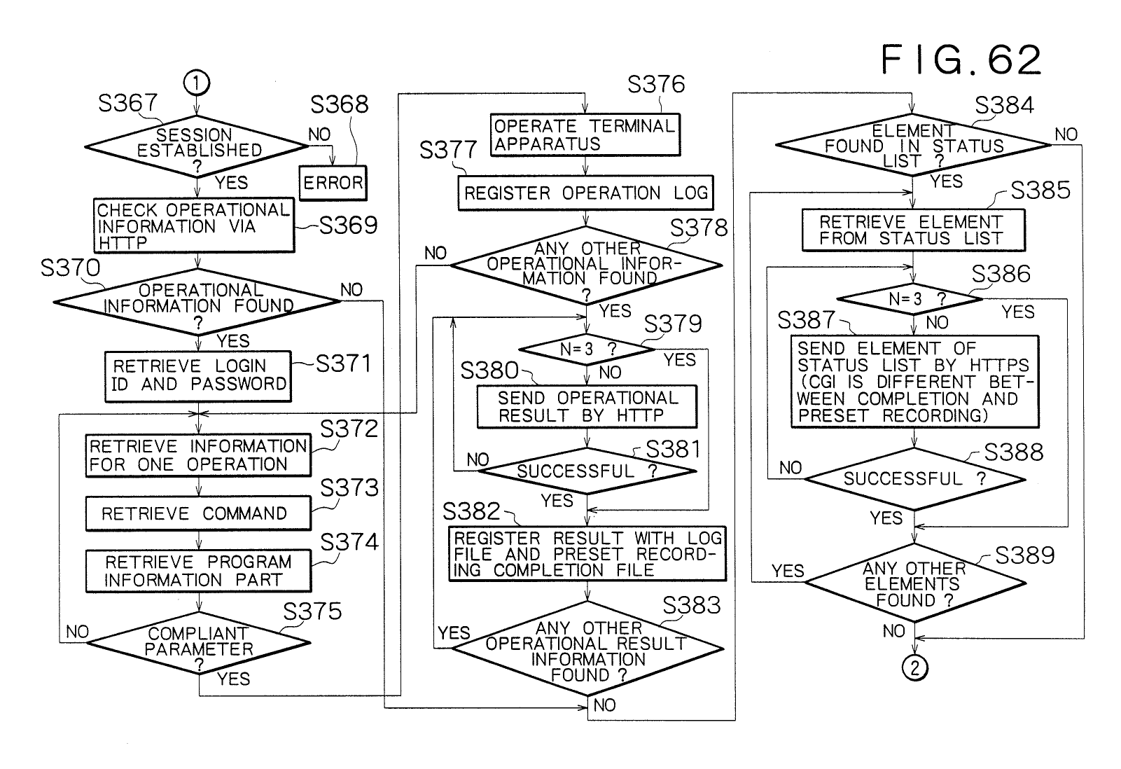

First, as shown in FIG. 62, the controller 133 of the terminal apparatus 2 starts the terminal apparatus 2 at a predetermined time (a polling time) to search a terminal apparatus database, not shown, for a preset list (L1) which lists programs already set for preset recording (step S361).

The preset list L1 consists of a list of programs set for preset recording by the program preset recording setting script generated by the server apparatus 120 and a list of programs set for preset recording by the user directly from the input section, not shown, of the terminal apparatus 2. Namely, the list L1 contains all lists of the programs set for preset recording at the terminal apparatus 2.

Next, the controller 133 of the terminal apparatus 2 gets a completion list (L2) which lists the programs already recorded to the recording medium 131 (step S363). Of the programs listed in list L2, “Preset” status is attached to each program set for preset recording.

In addition, in response to a request by the mobile terminal apparatus 110 for setting of preset recording, the controller 133 of the terminal apparatus 2 gets information (L3) from a preset recording completion file, which is a file of programs of which setting for preset recording has been completed (step S364).

The controller 133 of the terminal apparatus 2 compares L1 with L3. The controller 133 determines those programs which are found in L1 and not found in L3 to be the programs which were set for preset recording by the user from the input section of the terminal apparatus 2, adding these programs to the status list (step S365). Further, the controller 133 of the terminal apparatus 2 adds those programs attached with “Preset” status in the retrieved L2 to the status list (step S366).

The terminal apparatus 2 is set for preset recording by the mobile terminal apparatus 110 or directly by the user. In the former, the setting is performed via the server apparatus 120, so that the server apparatus 120 can know the programs to be set for preset recording by the mobile terminal apparatus 110.

If the preset recording is set directly by the user to the terminal apparatus 2, the server apparatus 120 which must manage all information in the program preset recording system 100 cannot know the programs set for preset recording. Therefore, the status is provided which notifies the server apparatus 120 of the setting status of the programs which are outside the control of the server apparatus 120. Therefore, the status list is updated every time the terminal apparatus 2 downloads the operation script from the server apparatus 120. It should be noted that each program added to the status list is hereinafter referred to as an element.

When step S366 has been completed, the procedure goes to the steps described in the flowchart shown in FIG. 62.

As shown in the flowchart shown in FIG. 62, the controller 133 of the terminal apparatus 2 starts the access software stored in the storage section 131 at a predetermined time in accordance with a polling interval specifying the time of access to the server apparatus 120 to access the server apparatus 120, thereby establishing a session between the terminal apparatus 2 and server apparatus 120 (step S367). When the session has been established, the procedure goes to the next step. If the establishment of the session failed, the controller 133 sends an error message to the mobile terminal apparatus 110 (step S368).

The access software stored in the storage section 132 of the terminal apparatus 2 accesses, via HTTP, a CGI script of the WWW server 122 of the server apparatus 120 to check the operation script of the mobile terminal apparatus 110 stored in the operation log DB (step S369). If the operation information is found, the procedure goes to step S371; otherwise, the procedure goes to step S384 (step S370). An HTTP command for accessing the CGI script is “http://www.rompass.com/imode/remote/get.OpInfo.cgi?LoginID=**&PW=**&VER=**” for example, having login ID, password, and version information as arguments.

The CGI script of the WWW server 122 takes out login ID and password and compares them with those in the user information DB for user authentication (step S371). If the user is authenticated, the database server 123 of the server apparatus 120 registers the access time with the access log DB of the database 123a.

The CGI script controls the database server 123 to take out the operation script subsequent to the current time from the operation log DB of the database 123a. The access software of the terminal apparatus 2 reads only one of the operation scripts taken out by the CGI script (step S372). The operation script to be read from the operation log DB by the CGI script consists of one or more scripts. The access software reads these scripts one by one for processing.

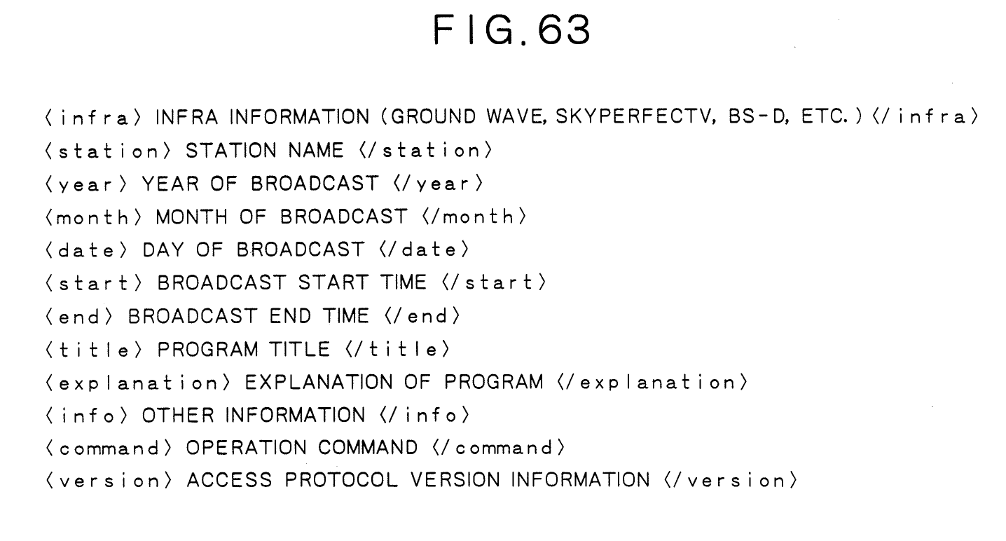

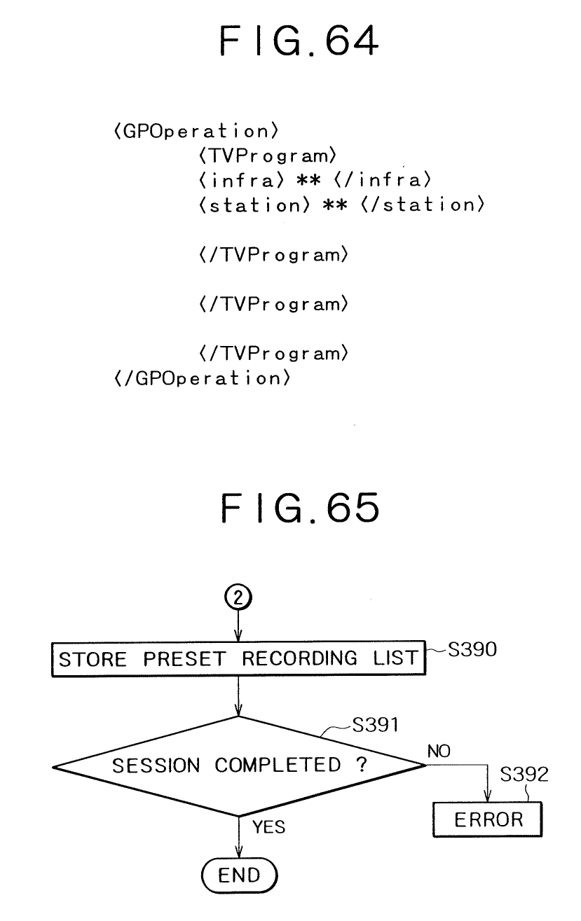

FIG. 63 shows an exemplary operation script. The operation script shown is for one program, in which plural pieces of program information are defined by tags <TVProgram> through </TVProgram> to provide one operation script. Further, if there are two or more operation scripts, these scripts are defined by tags <GPOperation> through </GPOperation> shown in FIG. 64.

The access software of the terminal apparatus 2 takes out an operation command defined by <command> through </command> of the retrieved operation script (step S373) and also takes out the program information portion other than the operation command (step S374) to determine whether the retrieved parameter is valid or not (step S375). If the parameter is found valid, the procedure goes to step S375; otherwise, the procedure returns to step S372.

The controller of the terminal apparatus 2 determines whether the operation command of the operation script found valid by the access software is a command for the setting of preset recording or a command for the cancellation of the setting of preset recording. According to the decision, the controller of the terminal apparatus 2 issues a device operation command, which is a control command for recording the program to the recording medium 131 and sends the issued command to the recording section, not shown (step S376). The controller of the terminal apparatus 2 registers the above-mentioned operational status with an operation log file, not shown (step S377).

Next, the access software of the terminal apparatus 2 determines whether there is any other operation script (step S378). If another operation script is found, the procedure goes to step S379; otherwise, the procedure returns to step S372.

When the number of times the operation results of the terminal apparatus 2 by the operation script are transmitted to the server apparatus 120 has reached N (here, N=3 for example), the transmission of operation results is stopped, upon which the procedure goes to step S382. If the number is less than N, then the procedure repeats going to step S380 until the transmission to the server apparatus 120 is successful (step S379).

The access software of the terminal apparatus 2 accesses a CGI script of the WWW server 122 of the server apparatus 120 via HTTP and transmits the operation results obtained by this operation script at the terminal apparatus 2 (step S380). At this moment, if an HTTP command for operation results transmission generated by the access software of the terminal apparatus 2 is “http://www.rompass.com/imode/remote/remoteResult.cgi?LoginID=**&PW=**&VER=**&ST=**&STA=**&COM=**&RES=**” for example, station ID, broadcast start time, operation command, and operation results being added as arguments after “ST=”, “STA=”, “COM=”, and “RES=” respectively.

In response to the status of the reception of the operation results from the terminal apparatus 2, the CGI script of the server apparatus 120 transmits a script defined by tags <Result> through </Result> for reporting the reception status to the terminal apparatus 2 as a return value.

When the reception of the operation results from the terminal apparatus 2 is successful, the server apparatus 120 transmits “0” to the terminal apparatus 2; otherwise the server apparatus 120 transmits “1” to the terminal apparatus 2. When the server apparatus 120 is successful in the reception of the operation results, the procedure goes to step S382; otherwise, the procedure returns to step S379 (step S381).

When the transmission of the operation results to the server apparatus 120 is successful, the controller 133 of the terminal apparatus 2 records the information thereof to the operation log file and the preset completion file (step S382). If there is any other operation results information, the procedure returns to step 379; otherwise, the procedure goes to step S383.

If there is any element in the status list, the controller 133 of the terminal apparatus 2 takes out one element from the status list (steps S384 and S385); otherwise, the procedure goes to step S390.

When the number of times one element taken out of the status list is transmitted to the server apparatus 120 has reached N (N=3 for example), the transmission of operation results is stopped, upon which the procedure goes to step S389. If the number is less than N, then the procedure repeats going to step S387 until the transmission to the server apparatus 120 is successful (step S386).

The access software of the terminal apparatus 2 accesses the CGI script of the WWW server 122 of the server apparatus 120 via HTTP to transmit the element taken out in step S385 (step S387). The type of HTTP command depends on the element to be transmitted. For a program of which recording has been completed, the HTTP command is “http://www.rompass.com/imode/remote/remoteRecord.cgi?LoginID=**&PW=**&STID=**&DT=**&STA=**&VER=**” for example. For a program of which preset recording has been set directly to the terminal apparatus 2 is “http://www.rompass.com/imode/remote/remoteReserved.cgi?LoginID=**&PW=**&STID=**&DT=**&STA=**&VER=**” for example.

In accordance with the reception status of the element transmitted from the terminal apparatus 2, the CGI script of the server apparatus 120 transmits a script defined by tags <Result> through </Result> for reporting the reception status as a return value. When the server apparatus 120 is successful in the reception, the server apparatus 120 transmits “0”; otherwise, the server apparatus 120 transmits “1”. If the element is successfully received by the server apparatus 120, the procedure goes to step S389; otherwise, the procedure returns to step S386 (step S388).

If the controller 133 of the terminal apparatus 2 finds another element in the status list, the procedure returns to step S385; otherwise, the procedure goes to step S390 (step S389).

Next, as shown in the flowchart of FIG. 65, the database server 123 of the server apparatus 120 stores the element taken out of the status list of the terminal apparatus 2 into the preset DB of the database 123a (step S390), upon which the session between the terminal apparatus 2 and server apparatus 120 comes to an end (step S391). If the session has not been terminated normally, an error message is transmitted to the mobile terminal apparatus 110 (step S392).

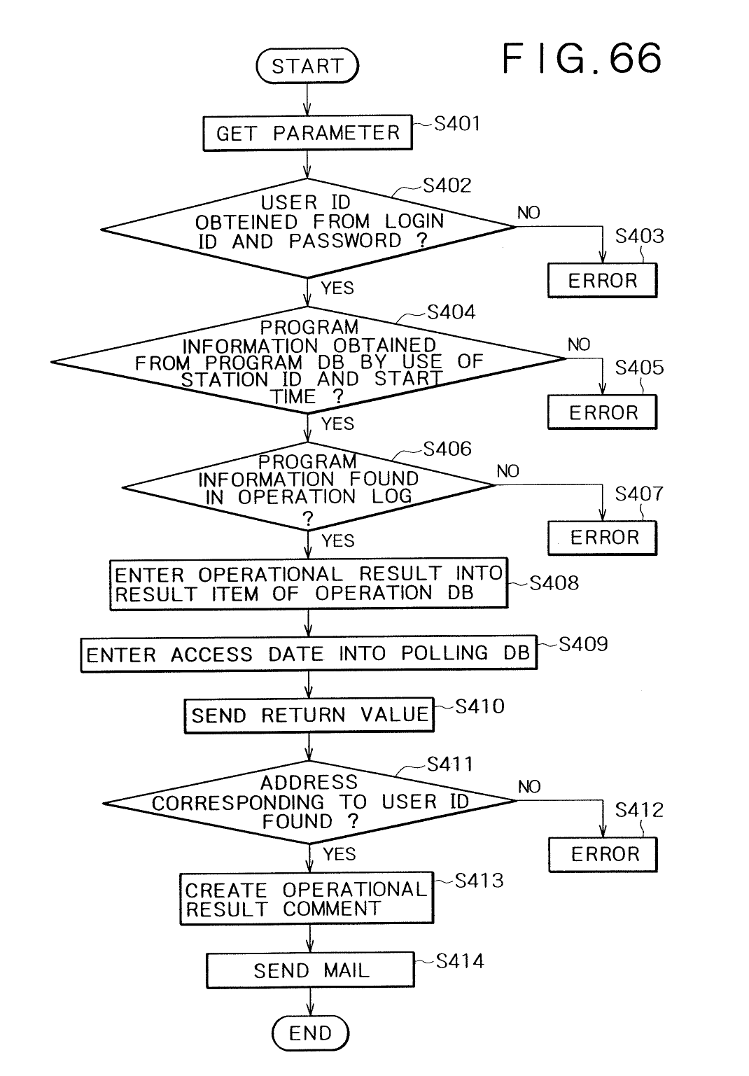

The following describes an operation of the server apparatus 120 to be executed when receiving the setting results of a script received from the terminal apparatus 2 with reference to the flowchart shown in FIG. 66.

First, the CGI script of the WWW server 122 of the server apparatus 120 gets all arguments from the HTTP command generated by the access software of the terminal apparatus 2 (step S401) and, by use of the retrieved login ID and password, searches the user information DB of the database 123a for the user ID to identity the user (step S403).

If the user identification failed, the server apparatus 120 transmits an error message to the mobile terminal apparatus 110 (step S403). If the user identification is successful, the procedure goes to step S404, in which the CGI script controls the database server 123 to get the program information by use of broadcast station ID and program start time (step S404). If the program information cannot be obtained, the CGI script transmits an error message to the terminal apparatus 2 (step S405).

The database server 123 of the server apparatus 120 searches the operation DB of the database 123a for an operation log associated with the program having the program information obtained in step S404 (step S406). If no operation log is found, the database server 123 transmits an error message to terminal apparatus 2 (step S407). If an operation log is found, the database server 123 enters the operation results received from the terminal apparatus 2 into the result item box of the operation DB (step S408) and the access date and time into the polling DB (step S409).

Next, in order to notify the terminal apparatus 2 of the success or failure of the above-mentioned reporting of the operation results, the CGI script transmits a script defined by tags <Result> through </Result> for indicating the success or failure of the reporting. If the reporting is successful, the CGI script transmits “0”; otherwise, the CGI script transmits “1” (step S410).

Further, the server apparatus 120 searches the user information DB of the database 123a for the electronic mail address of the mobile terminal apparatus 110 by use of the user ID obtained in step S202 (step S412). If the electronic mail address is found, the mail server 121 generates an electronic mail message attached with an operation result comment for notifying that the setting of the script to the terminal apparatus 2 is successful (step S413) and transmits the generated electronic mail message to the mobile terminal apparatus 110 (step S414). If the electronic mail address of the terminal apparatus 2 is not found, the mail server 121 transmits an error message to the mobile terminal apparatus 110.

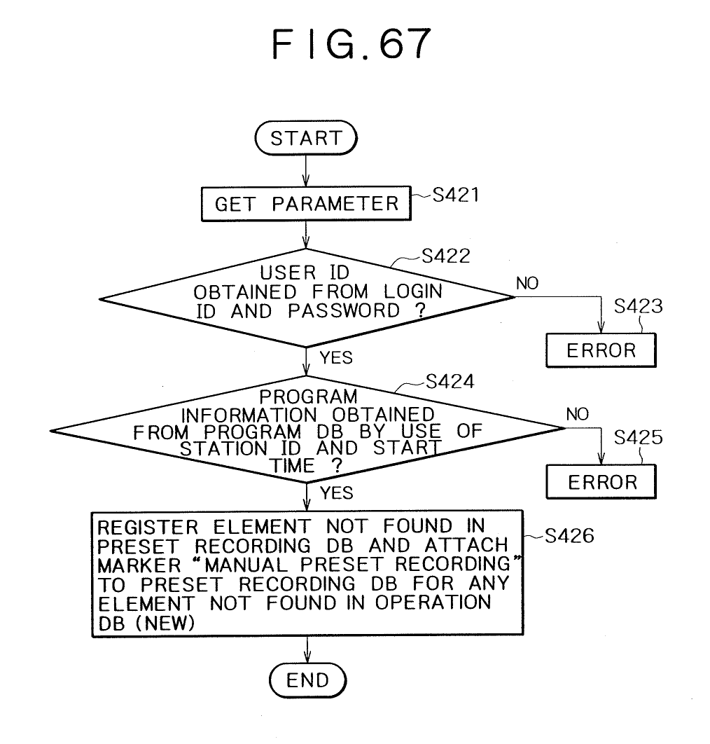

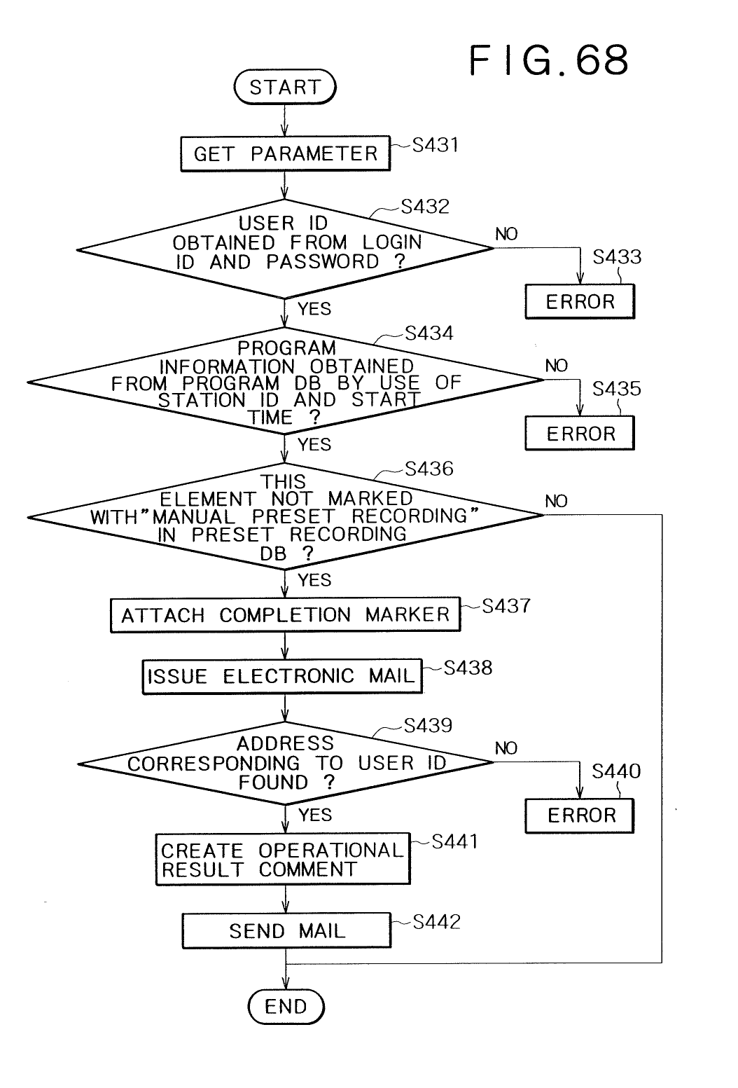

The following describes an operation of the server apparatus 120 to be executed when obtaining an element of the status list received from the terminal apparatus 2 with reference to the flowcharts shown in FIGS. 67 and 68.

First, with reference to the flowchart of FIG. 67, an example will be described in which an element indicative of the program information about a program set by the user for preset recording at the terminal apparatus 2 is received by the server apparatus 120.

The WWW server 122 of the server apparatus 120 receives an HTTP command from the terminal apparatus 2 to get all arguments from the received HTTP command (step S421).

The CGI script of the WWW server 122 searches the user information DB of the database 123a for the user ID by use of the obtained login ID and password to identify the user (step S422). If the user identification failed, the server apparatus 120 transmits an error message to the mobile terminal apparatus 110 (step 423). If the user identification is successful, the procedure goes to step S424, in which the CGI script controls the database server 123 to obtain the program information by use of the obtained station ID and program start time (step S424). If the program information cannot be obtained, the CGI script transmits an error message to the terminal apparatus 2 (step S425).

Further, the CGI script searches the preset DB and the operation DB of the database 123a for the program of which program information has been obtained from the program DB as described above. If the program is not found in the preset DB, the CGI scripts registers this program with the preset DB. Those programs registered with the preset DB which are not found in the operation DB are attached with identification marker “Manual Preset” for example in order to indicate that these programs were directly set for preset recording to the terminal apparatus 2.

The following describes, with reference to the flowchart shown in FIG. 68, an example in which the server apparatus 120 receives an element indicative of the program information of the program recorded to the recording medium of the terminal apparatus 2 to which preset recording has been set.

The WWW server 122 of the server apparatus 120 receives an HTTP command from the terminal apparatus 2 to get all arguments from the received HTTP command (step S431).

The CGI script of the WWW server 122 searches the user information DB of the database 123a for the user ID by use of the obtained arguments of login ID and passwords to identify the user (step S432). If the user cannot be identified, the server apparatus 120 transmits an error message to the mobile terminal apparatus 110 (step S433). If the user identification is successful, the procedure goes to step S434, in which the CGI script controls the database server 123 to obtain the program information by use of the obtained station ID and program start time (step S434). If the program information cannot be obtained, the CGI script transmits an error message to the terminal apparatus 2 (step S435).

On the basis of the program information retrieved by the database 123a, the CGI script searches the preset DB of the database 123a to determine whether the retrieved program is attached with marker “Manual Preset” (step S436).

If marker “Manual Preset” is not attached, the mail server 121 attaches marker “Completed” to the program information in the preset DB (step S437) and issues an electronic mail message (step S438). If marker “Manual Preset” is attached, the procedure comes to an end.

Further, the CGI script searches the user information DB for the electronic mail address of the mobile terminal apparatus 110 by use of the user ID obtained in step S432 (step S439). If the electronic mail address of the terminal apparatus 2 is not found, the CGI script transmits an error message to the terminal apparatus 2 (step S440). If the electronic mail address is found, the CGI script generates an operation result comment indicating that the program set for preset recording from the mobile terminal apparatus 110 has been recorded to the recording medium (step S441) and transmits the electronic mail message generated in step S438 with the electronic mail address retrieved in step S439 and the operation result comment generated in step S440 to the mobile terminal apparatus 110 (step S442).

As described, the program preset recording system 100 allows the user to perform, from the mobile terminal apparatus 110 at a remote location, the setting of preset recording of user-specified programs to the terminal apparatus 2 by use of an existing network, such as the Internet.

Further, if the setting for preset recording is made directly by the user at the terminal apparatus 2, predetermined management information may be transmitted to the server apparatus via the above-mentioned network to collectively manage, by the server apparatus 120, the programs set for preset recording to the terminal apparatus 2.

In addition, because an existing network is available, the cost and time required for the arrangement of communications infrastructures can be significantly saved, which in turn significantly saves the users of system usage fees.

The following describes the fee-charge processing in the program preset recording system 40 practiced as one embodiment of the invention.

The program information providing apparatus 43 of the program preset recording system 40 shown in FIG. 28 has a fee-charging apparatus, not shown. When program preset recording to the recording section of the terminal apparatus 2 or the recording apparatus 45 is set or this setting is canceled, the fee-charging apparatus charges the user accordingly. It should be noted that fee charging is made when a program is set for preset recording and fee charging is canceled when the setting of preset recording is canceled.

For example, when a program preset recording setting script generated by the program information providing apparatus 43 is transmitted to the terminal apparatus 2 and an operation of setting the preset recording to the recording section of the terminal apparatus 2 or the recording apparatus 45 by the program preset recording setting script or canceling the setting for preset recording by a program preset recording setting cancel script is successful, the program preset recording setting script pickup software stored in the storage section, not shown, of the terminal apparatus 2 accesses, by the use of the program information and user authentication information as arguments, the above-mentioned program preset recording setting result report CGI script stored in the storage section, not shown, of the program information providing apparatus 43. When accessed, the program preset recording setting result report CGI script generates an electronic mail message for notifying the mobile terminal apparatuses 42a, 42b, and 42c of the setting or the cancel of the setting for preset recording. Upon reception of this CGI script by these mobile terminal apparatuses, the controller of the program information providing apparatus 43 determines that the user who has set the preset recording or canceled the setting of preset recording is chargeable and charges the user.

Further, the amount of fee to be charged on the terminal apparatus 2 by the fee-charging apparatus depends on which of the program information providing apparatus 43 and the terminal apparatus 2 accesses the telephone line when establishing a session between them. As described with reference to step S212 of FIG. 30, if the program information providing apparatus 43 accesses the terminal apparatus 2, then an amount of fee obtained by adding the usage fee of the program preset recording system 40 to the telephone charge for this access is charged on the terminal apparatus 2 by the fee-charging apparatus. If the terminal apparatus 2 accesses the program information providing apparatus 43 as described with reference to step S213 of FIG. 30, then the telephone charge is billed directly to the terminal apparatus 2 from the telephone company, so that the terminal apparatus 2 is charged with only the usage fee of the program preset recording system 40 by the fee-charging apparatus.

As described, the program preset recording system 40 allows the user to set desired programs for preset recording from the terminal apparatus 2 to its recording section or the recording apparatus 45. At the same time, by use of the fee-charging apparatus, the program preset recording system 40 can charge its users for its usage fees.

It should be noted that, although the mobile terminal apparatuses 42a, 42b, and 42c practiced as embodiments of the invention are described as having different capabilities, these apparatuses may also be functionally identical.

In the above examples, the mobile terminal apparatuses 42a, 42b, and 42c, which are a mobile telephone, a PDA, or mobile PC, are used from which the user inputs commands for generating program preset recording setting scripts. Obviously, these mobile terminal apparatuses 42a, 42b, and 42c may be replaced by PCs having the equivalent capabilities to constitute the program preset recording system 40.

Lastly, a profit collecting method in a service for providing the information associated with programs provided by the commissioning broadcast provider 3 to users will be detailed below.

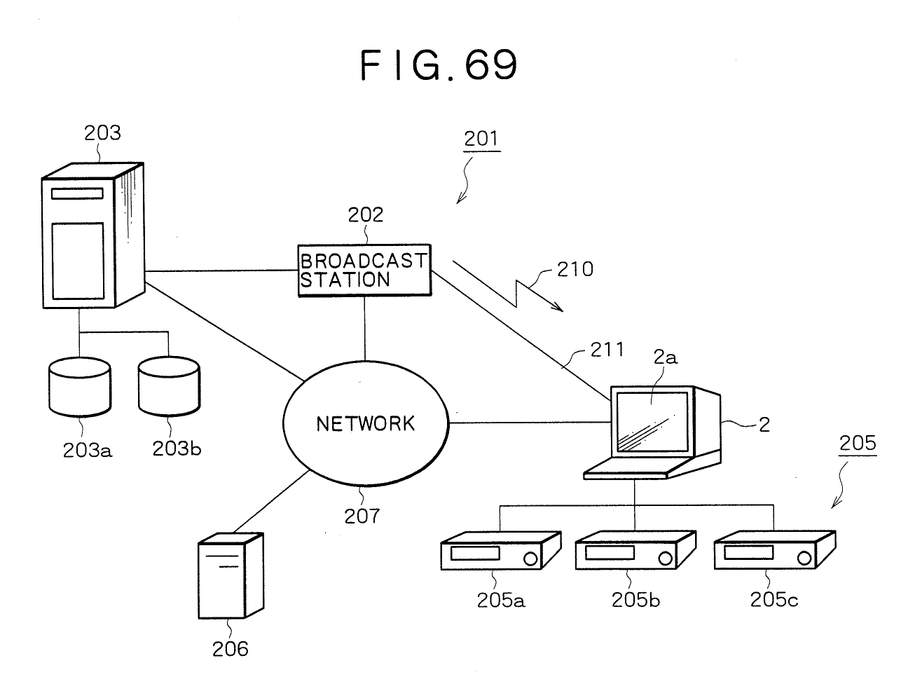

In order to provide the information associated programs provided by the commissioning broadcast provider 3 to users, the program service providing apparatus 6 has a program-associated information providing apparatus 203 shown in FIG. 69. The program-associated information providing apparatus 203, a broadcast station 202, a terminal apparatus 2, and a plurality of program-associated information providing servers 206 constitute a program-associated information providing system 201 via a network 207.

The broadcast station 202 is a contract broadcaster which is commissioned with programs created by the commissioning broadcast provider 3 and transmits these programs to the terminal apparatus 2 by a predetermined transmission means.

The broadcast station 202 transmits predetermined programs commissioned by the commissioning broadcast provider 3 to the terminal apparatus 2 by use of a predetermined television signal 210 having a predetermined frequency. The broadcast station 202 may also be connected with the terminal apparatus 2 with a dedicated cable 211 over which the broadcast station 202 transmits predetermined programs to the terminal apparatus 2. The broadcast station 202 may also be connected with a network 207 over which the broadcast station 202 transmits predetermined programs to the terminal apparatus 2.

The program-associated information providing apparatus 203, connected with the network 207, has a database 203a storing the program information, which is the attribute information, of the programs broadcast by the broadcast station 202, for example, a program introductory comment summarizing the contents of each program, and a program guide listing the programs organized by channel and a database 203b storing program preset recording setting scripts to be described later in the account for each user.

The program information and the program guide based on the program information stored in the database 203a of the program-associated information providing apparatus 203 are provided by the DMC provider 5.

The storage section, not shown, of the program-associated information providing apparatus 203 stores a Web server program for providing the program information and the program guide stored in the database on the Internet via a Web browser installed on the terminal apparatus 2.

The program-associated information providing apparatus 203 generates, upon request by the user, a program preset recording setting script, which is a control command based on the program information, for controlling the recording section of the terminal apparatus 2 or a recording apparatus 205 to automatically record a program broadcast from the broadcast station 202 at a predetermined time to a recording medium of the recording section or the recording apparatus 205 (this is referred to as a preset recording mode) and transmits the generated script to the terminal apparatus 2 over the network 207.

The program preset recording setting script generated by the program-associated information providing apparatus 203 when setting a program for preset recording is also generated to link a program with its program-associated information to be described later when the user views the program realtime at the terminal apparatus 2 (this is referred to as an on-air mode) to be transmitted to the terminal apparatus 2 over the network 207. The script generated in the on-air mode is referred to as a program-associated information script.

The terminal apparatus 2, which is a PC (Personal Computer) for example, incorporates a ground wave receiving tuner, a BS (Broadcasting Satellite) tuner, and a CS (Communications Satellite) tuner. Each of these tuners receives modulated programs transmitted by a carrier having a predetermined frequency and demodulates the received programs into programs consisting of video and audio signals. The terminal apparatus 2 may also be connected with the broadcast station 202 with the dedicated cable 211 over which the terminal apparatus 2 receives predetermined programs from the broadcast station 202. The terminal apparatus 2 is also connected with the broadcast station 202 via the network 207 over which the terminal apparatus 2 receives predetermined programs from the broadcast station 202.

The terminal apparatus 2 has a recording section for recording the received programs to a recording medium pre-installed in the recording section or a recording medium which is detachably loaded into the recording section. The recording medium is a magnetic tape, a magnetic disk, a magneto-optical disk, or an optical disk, for example. The terminal apparatus 2 receives a program preset recording setting script from the program-associated information providing apparatus 203. The controller of the terminal apparatus 2 converts the received program preset recording setting script into a control signal suitable for the processing by the recording section and controls it in accordance with the preset recording control signal to record the program to the recording medium. When transmitting the program preset recording setting script to the recording apparatus 205 specified therein, the terminal apparatus 2 converts the program preset recording setting script into a control signal suitable for the processing by each recording apparatus 205. For example, the terminal apparatus 2 converts the program preset recording setting script into an IR (Infrared) control signal, a LAN (Local Area Network) control signal, or an iLINK (trademark) control signal.

The terminal apparatus 2 has a reproducing section for reproducing a program stored in its recording medium and displays the reproduced program on a display section 2a of the terminal apparatus 2 by use of a program display browser. This configuration allows the user to view the recorded programs any time. The terminal apparatus 2 can not only reproduces and displays on the display section 2a programs recorded to the recording medium, but also directly display programs transmitted from the broadcast station 202 through the program display browser.

The terminal apparatus 2 also stores in its storage section a URL browser for displaying a program-associated information URL indicative of the location on the network 207 of the program-associated information of a program to be displayed through a program display browser and a program-associated information display browser for searching the network 207 in response to the access to the program-associated information URL for the program-associated information located at the place indicated by the above-mentioned program-associated information URL and displaying the retrieved program-associated information on the display section 2a.

The terminal apparatus 2 also stores, in its storage section, program preset recording setting script pickup software for obtaining program preset recording setting scripts stored for each account of the terminal apparatus 2 in the database 203b of the program-associated information providing apparatus 203. This program preset recording setting script pickup software starts when a session has been established between the terminal apparatus 2 and the program-associated information providing apparatus 203 to search the account of the user in the database 203b for the program preset recording setting script and downloads the retrieved script.

It should be noted that the terminal apparatus 2 may be a mobile PC or a mobile information terminal device, such as a PDA, having the capabilities of connecting with the network 207 and receiving programs.

The recording apparatus 205 incorporates a ground wave receiving tuner, a BS tuner, and a CS tuner. Each tuner receives modulated programs transmitted on a carrier having a predetermined frequency and demodulates the received programs into programs consisting of video and audio signals. The recording apparatus 205 has a recording section for recording the received programs to a recording medium pre-installed in the recording section or a recording medium which is detachably loaded into the recording section. The recording medium is a magnetic tape, a magnetic disk, a magneto-optical disk, or an optical disk, for example. The recording apparatus 205 receives a preset recording control signal based on the program preset recording setting script received from the terminal apparatus 2. The recording apparatus 205 receives the preset recording control signal from the terminal apparatus 2 and records the program to the recording medium in accordance with the received preset recording control signal. The recording apparatus 205 may have a plurality of recording devices such as a recording apparatus 205a, which is a DV (Digital Video), a recording apparatus 205b, which is a VTR (Video Tape Recorder), and a recording apparatus 205c, which is a DVD (Digital Video Disk), as shown in FIG. 69 for example.

There are two or more program-associated information providing servers 206 on the network 207, each storing plurality pieces of program-associated information received from the broadcast station 202. Each program-associated information providing server 206 provides the program-associated information in response to the specification by the terminal apparatus 2 through the URL displayed on the URL display browser.

The program-associated information includes, but not exclusively, properties such as costumes and clocks and locations if the program is a drama; additional information such as hotel information, travel plans, and travel agent information which cannot be introduced in a travel program; and detail recipe introduced in a cooking program, for example. The program-associated information may be any if associated with a program even if only slightly and therefore not limited to the additional information mentioned above.

The network 207 interconnects the broadcast station 202, the program-associated information providing apparatus 203, the terminal apparatus 2, and the program-associated information providing server 206, allowing the connected apparatuses to transfer information each other.

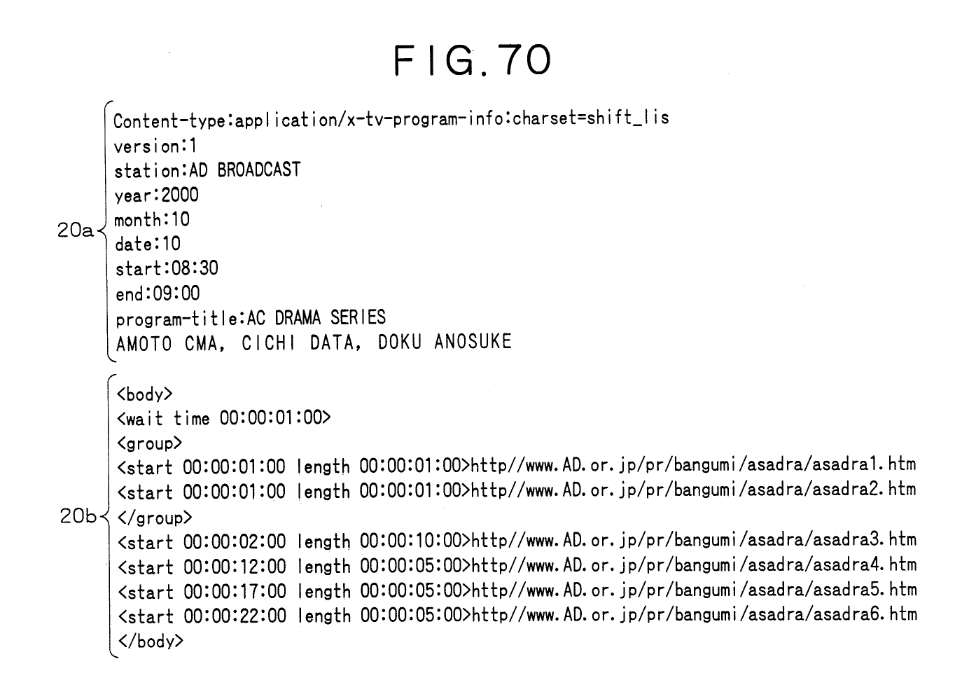

The following describes a program preset recording setting script to be generated in the preset recording mode in the program-associated information providing apparatus 203 with reference to FIG. 70.

Each program preset recording setting script has a program information area 20a in which the information about a program to be set for preset recording is written and a URL list area 20b in which the information for linking a URL list containing the location of program-associated information with the program is written.

The program information area 20a of each program preset recording setting script contains “station” indicative of the broadcast station 202 from which the program is broadcast, “year”, “month”, and “date” indicative of a program broadcast date, “start” indicative of program broadcast start time, “end” indicative of program broadcast end time, and “program-title” indicative of program title. For example, if the broadcast station 202 is “AD Broadcast”, it is written as “station:AD Broadcast”; if the broadcast date is Oct. 10, 2000, it is written as “year:2000”, “month:10”, and “date:10”; if the broadcast start time is 8:30 a.m., it is written as “start:08:30”; if the broadcast end time is 9:00 a.m., it is written as “end:09:00”; and if the title is “AC Series Drama”, it is written as “program-title:AC Series Drama”.

Also, “program-title” may be followed by a major performer such as “Amoto Cma”, “Ci Data”, or “Doku Anosuke” for example.

Moreover, each program preset recording setting script has a predetermined URL list which allows the terminal apparatus 2 to get the program-associated information associated with the above-mentioned programs via the network 207 as shown in the URL list area 20b.

The URL showing the location of the program-associated information on the network 207 is displayed on the display section 2a of the terminal apparatus 2 through the URL browser at an appropriate location in program viewing by the user (in an appropriate time zone) by a URL list defined by predetermined tags attached to the program preset recording setting script shown in FIG. 70.

The following describes the URL list area 20b defined by the predetermined tags attached to the program preset recording setting script.

Tag <body> indicates that the URL list area 20b is defined after this tag. Tag <body> is paired with a tag </body> to be described later, which ends the definition of the URL list area 20b.

Tag <wait time> specifies a wait time until a first URL list is displayed in the URL display window. For example, “<wait time 00:00:01>” indicates that the first URL is displayed one minute after the program start time.

Tag <group> is paired with tag </group> to group the URLs to be displayed in the URL display window at the same time. Tag <group> starts grouping and tag </group> ends grouping.

Tag <start˜ length˜> defines each individual piece of program-associated information, which is immediately followed by an URL indicative of the location of the program-associated information. “start” is immediately followed by a relative display start time from the start of the program to be displayed in the URL display window for displaying program-associated information. “length” is immediately followed by a length of time in which the URL indicative of the location of program-associated information is kept displayed in the URL window. For example, tag <start˜ length˜> is used as “<start 00:00:01:00 length 00:00:01:00>http://www.AD.or.jp/pr/bangumi/asadra/asadra.html” for example. The URL indicated by this tag is displayed in the URL display browser one minute after the program start time and kept displayed for one minute.

If there are two or more URLs to be displayed in the URL display browser in a same time zone, these plural URLs can be displayed in the same time zone by use of the above-mentioned tags <group> and </group> as shown below.

<group>

<start 00:00:01:00 length 00:00:01:00>http://www.AD.or.jp/pr/bangumi/asadra/asadra1.htm
<start 00:00:01:00 length 00:00:01:00>http://www.AD.or.jp/pr/bangumi/asadra/asadra2.htm

</group>

Tag “<start 00:00:02:00 length 00:00:10:00>http://www.AD.or.jp/pr/bangumi/asadra/asadra3.htm”indicates that URL “http://www.AD.or.jp/pr/bangumi/asadra/asadra3.htm” is displayed in the URL display window 2 minutes after the program start time for a length of 10 minutes. Tag “<start 00:00:12:00 length 00:00:05:00>http://www.AD.or.jp/pr/bangumi/asadra/asadra4.htm” indicates that URL “http://www.AD.or.jp/pr/bangumi/asadra/asadra4.htm” is displayed 12 minutes after the program start time for a length of 5 minutes. Tag “<start 00:00:17:00 length 00:00:05:00>http://www.AD.or.jp/pr/bangumi/asadra/asadra5.htm” indicates that URL “http://www.AD.or.jp/pr/bangumi/asadra/asadra5.htm” is displayed in the URL display window 17 minutes after the program start time for a length of 5 minutes. Tag “<start 00:00:22:00 length 00:00:05:00>http://www.AD.or.jp/pr/bangumi/asadra/asadra6.htm” indicates that URL “http://www.AD.or.jp/pr/bangumi/asadra/asadra6.htm” is displayed in the URL display window 22 minutes after the program start time for a length of 5 minutes.

The user clicks the URL displayed on the display section 2a of the terminal apparatus 2 to reference the program-associated information of a desired program.

It should be noted that a program preset recording setting script generated in the on-air mode has the same configuration of the above-mentioned program preset recording setting script. However, the program information area 20a is handled as program information, not used for program preset recording setting script generation.

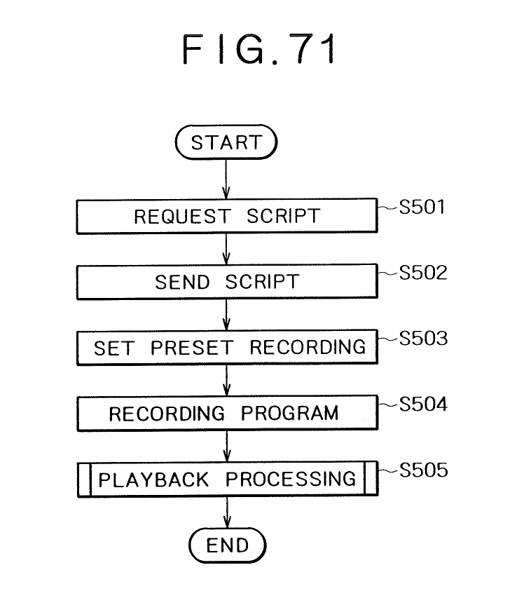

The following describes operations of recording a program to a recording medium in the preset recording mode, reproducing the recorded program, and getting the program-associated information of this program in the program-associated information providing system 201 with reference to the flowchart shown in FIG. 71.

In step S501, the user sets the preset recording of a desired predetermined program from the input section, not shown, of the terminal apparatus 2.

To set the preset recording, the user accesses the program-associated information providing apparatus 203 via the network 207 to download a program guide in which all programs to be broadcast by the broadcast station 202 are organized by channel from the database 203a, for example. Checking the downloaded program guide, the user selects a program to be set for preset recording and inputs a command for generating the above-mentioned program preset recording setting script. For example, this program preset recording setting script is as shown in FIG. 70 and has the program information area 20a written with a script providing a control command for program preset recording and the URL list area 20b written with a script providing a control command for providing the associated information of a program specified by the tag.

Each program box in the program guide downloaded to the terminal apparatus 2 has “Preset” button for generating a script for program preset recording. When the user clicks this “Preset” button, the information thereof is transmitted to the program-associated information providing apparatus 203 via the network 207. In response, the program-associated information providing apparatus 203 generates a program preset recording setting script for setting the preset recording of that program.

In step S502, the program-associated information providing apparatus 203 transmits the program preset recording setting script generated upon request by the terminal apparatus 2 to the terminal apparatus 2 via the network 207.

In step S503, the controller, not shown, of the terminal apparatus 2 passes the program preset recording setting script received from the program-associated information providing apparatus 203 to preset recording control software which controls the preset recording of the program in accordance with the program preset recording setting script stored in the storage section, not shown, of the terminal apparatus 2.

In step S504, the preset recording control software performs channel setting on the basis of the program information written in the program information area 20a of the received program preset recording setting script so as to record the program to a recording medium and generates a control signal for operating the recording section, not shown, of the terminal apparatus 2 or the recording apparatus 205 at a predetermined time. In accordance with the generated control signal, the controller of the terminal apparatus 2 controls its recording section or the recording apparatus 205 to record the program written in the program preset recording setting script to the recording medium.

At this moment, the controller of the terminal apparatus 2 records the program to the recording medium and, at the same time, stores, as a URL list file, the URL list area 20b specified by the tag information attached to the program preset recording setting script into a directory in which a program recording file is also contained, for example.

In step S505, the user reproduces, at any desired time, the program set for preset recording and recorded to the recording medium. The controller of the terminal apparatus 2 controls the reproducing section, not shown, so as to reproduce the program from the recording medium as directed by the user and displays the reproduced program on the display section 2a.

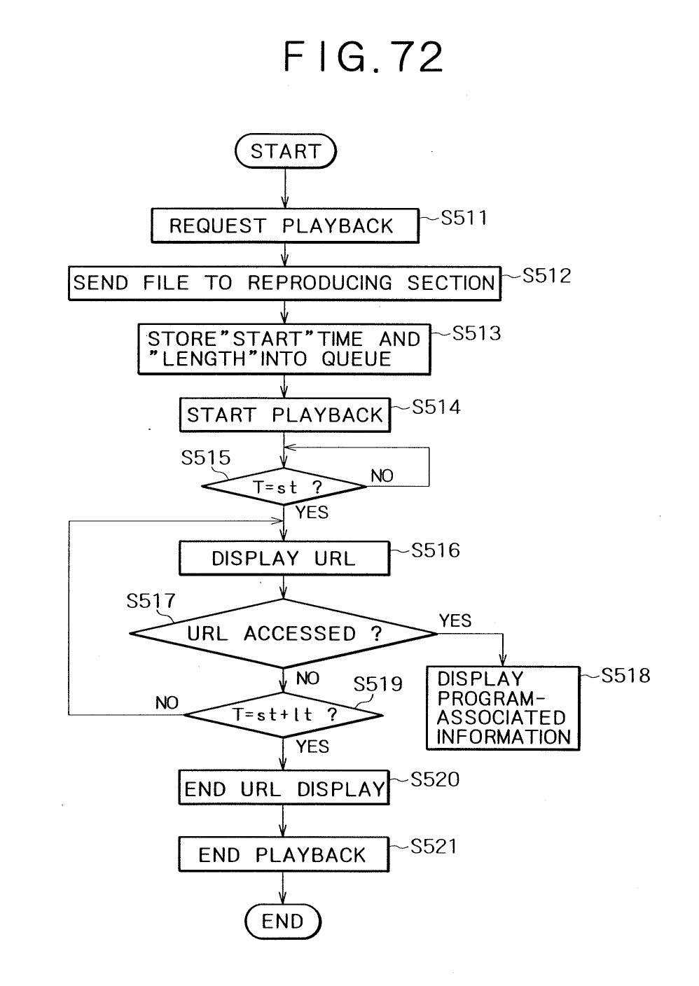

The following details the reproduction processing of step S505 of FIG. 71 with reference to the flowchart of FIG. 72.

In step S511, the user inputs a request for reproducing a program from the recording medium at the input section, not shown, of the terminal apparatus 2.

In step S512, in accordance with the request inputted at the input section of the terminal apparatus 2, the controller of the terminal apparatus 2 retrieves a program file and a URL list file recorded on the same directory on the recording medium and transmits these files to the reproducing section of the terminal apparatus 2.

In step S513, when the reproducing section receives the program file and the URL list file, the controller of the terminal apparatus 2 starts the program display browser and the URL display browser. Then, the controller of the terminal apparatus 2 stores each URL listed in the URL list file, time (ST) indicated by “start” and time (LT) indicated by “length” into a predetermined queue in the storage section of the terminal apparatus 2 for each URL sequentially.

In step S514, the reproducing section of the terminal apparatus 2 reproduces the program file under the control of the controller of terminal apparatus 2. The controller of the terminal apparatus 2 controls the reproducing operation of the program file in the reproducing section and, at the same time, starts its incorporated timer to manage program reproduction time T, a time at which the URL is displayed on the URL display browser, and a time at which the display of the URL display browser is ended.

In step S515, the controller of the terminal apparatus 2 determines whether ST of the URL stored in the queue matches program file reproduction time T. If a match is found, the procedure goes to step S516; otherwise, the status is held until a match is found. It should be noted that the process in step S515 is repeated until there is no more URL in the queue.

In step S516, the controller of the terminal apparatus 2 passes the URL having URL display start time ST to the URL display browser.

The URL display browser displays the URL received from the controller. The URL displayed in the URL display browser is linked with the program-associated information stored in the program-associated information providing server 206 on the network 207. When the user clicks this URL with a mouse for example, the program-associated information is displayed in the program information display browser.

In step S517, the controller of the terminal apparatus 2 determines whether the URL has been accessed by the user. If the URL is found accessed, the procedure goes to step S518; otherwise, the procedure goes to step S519.

In step S518, the terminal apparatus 2 downloads the program-associated information at the accessed URL on the network 207 and displays the downloaded program-associated information in the program information display browser.

In step S519, the controller of the terminal apparatus 2 determines whether a sum of URL display start time ST and URL display length of time LT matches program file reproduction time T. The sum of ST and LT indicates a URL display end time. If the sum of ST and LT matches T, the display of this URL ends. If a match is found, the procedure goes to step S520; otherwise, the procedure goes to step S516.

In step S520, the controller of the terminal apparatus 2 ends the display of the URL which is displayed in the URL display browser and has reached its display end time.

In step S521, the controller of the terminal apparatus 2 ends the reproducing operation of the reproducing section upon the end of the program file reproaching time and closes the program display browser.

As described, when reproducing a program from the recording medium in accordance with the program preset recording setting script, the program-associated information providing system 201 can display, along the URL list, the URL indicative of the location of the program-associated information of the program to be reproduced.

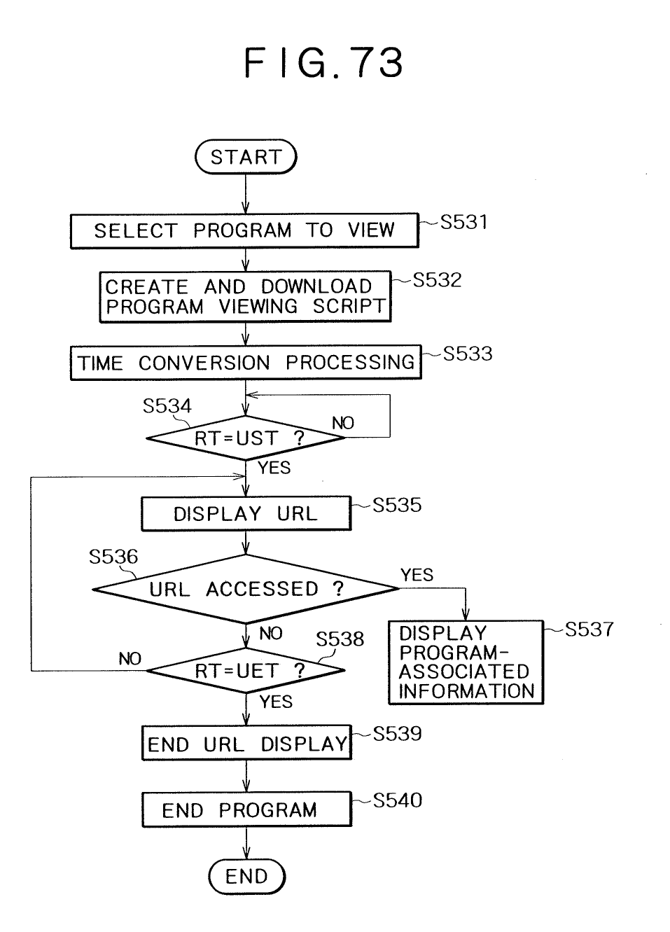

The following describes an operation of displaying program-associated information by the terminal apparatus 2 in the on-air mode of the program-associated information providing system 201 with reference to the flowchart shown in FIG. 73.

In step S531, the user selects a desired program at the input section of the terminal apparatus 2.

To select a desired program, the user accesses the program-associated information providing apparatus 203 via the network 207 and download a program list arranged with all programs to be broadcast by the broadcast station 202 for each channel on a time-dependent manner for example. Further, checking the downloaded program guide, the user selects a program to be viewed and inputs the selection.

Each program box in the program guide downloaded to the terminal apparatus 2 has “View” button for allowing the user to view that program to be broadcast from the broadcast station 202. When the user clicks “View” button, the click is transmitted to the program-associated information providing apparatus 203 via the network 207. In response, the program-associated information providing apparatus 203 allows the terminal apparatus 2 to receive the program of which “View” button has been clicked by the user. To be more specific, if the user-specified program is for pay, the program-associated information providing apparatus 203 allows the terminal apparatus 2 to decrypt the encrypted program.

In step S532, the program-associated information providing apparatus 203 generates a program-associated information script having a list of URLs indicate of the locations of program-associated information on the network 207 of the programs to be broadcast from the broadcast station 202 and transmits the generated program-associated information script to the terminal apparatus 2 via the network 207. For example, this program-associated information script is as shown in FIG. 70 having the program information area 20a writing the program information and the URL list area 20b writing the script to be used as a control command for providing tag-specified program associated information.

In step S533, the terminal apparatus 2 receives the program-associated information script via the network 207. The controller of the terminal apparatus 2 adds ST indicative of the display start time of the URL written in the URL list area 20b of the script to PT at which the program started to obtain a URL display start time (hereafter referred to as UST). Further, the controller performs time conversion processing for obtaining a URL display end time (hereafter referred to as UET) by adding a URL display time to the obtained UST. This time conversion processing is performed on all URLs listed in the script, obtaining UST and UET corresponding to real time RT.

After obtaining UST and UET, the controller of the terminal apparatus 2 transmits the obtained UST and UET along with the URL list to the reproducing section of the terminal apparatus 2 and, at the same time, starts the URL display browser to display the URL on the display section 2a of the terminal apparatus 2. Also, the controller of the terminal apparatus 2 stores the URL list transmitted to the reproducing section and time-converted UST and UET into a predetermined queue in the storage section of the terminal apparatus 2.

In step S534, the controller of the terminal apparatus 2 takes one of the URLs from the queue and compares UST of this URL with real time RT. If a match is found, it indicates that RT is the time for displaying this URL in the URL display browser. If a match is found, the procedure goes to step S535; otherwise, the procedure returns to step S534. It should be noted that the process of step S534 is repeated until there is no more URL in the queue.

In step S535, the controller of the terminal apparatus 2 passes the URL having URL display start time UST to the URL display browser. The URL display browser displays the URL received from the controller.

The URL displayed in the URL display browser is linked with the program-associated information stored in the program-associated information providing server 206 on the network 207. When the user clicks the URL with a mouse for example, the program-associated information is displayed in the program information display browser.

In step S536, the controller of the terminal apparatus 2 determines whether the URL has been accessed by the user. If the URL is found accessed, the procedure goes to step S537; otherwise, the procedure goes to step S538.

In step S537, the terminal apparatus 2 downloads the program-associated information in the URL on the network 207 and displays the downloaded program-associated information in the program information display browser.

In step S538, the controller of the terminal apparatus 2 compares URL display end time UET of the URL stored in the queue computed by the time conversion processing in step S533 with real time RT. If a match is found, it indicates that the display time of the URL ends. If a match is found, the procedure goes to step S539; otherwise, the procedure returns to step S535.

In step S539, the controller of the terminal apparatus 2 ends the display of the URL displayed in the URL display browser which has reached the end of the display time.

In step S540, the controller of the terminal apparatus 2 closes the program display browser in response to the end of the broadcasting of the program from the broadcast station 202.

As described, the terminal apparatus 2 can obtain the program-associated information during broadcasting of a program by receiving a URL indicative of the location of the program-associated information of the program to be broadcast from the broadcast station 202 as a script from the program-associated information providing apparatus 203, computing URL display start time and URL display end time by performing time conversion on the URL display start time and URL display end time written in the script, and displaying the URL in the URL display browser on the basis of the computed URL display start and end times.

Further, as described with reference to the flowchart shown in FIG. 73, the program-associated information can be provided realtime, thereby allowing the present invention to be applicable to a VOD (Video On Demand) system which allows the user to view desired programs at any desired time. In the VOD system, when the user selects a desired program and the processes of steps S521 through S530 are executed, the user can obtain realtime the URL information containing the program-associated information on the network 207, thereby obtaining the desired program-associated information at the viewing of the program.

The program-associated information providing apparatus 203 of the program-associated information providing system 201, when generating a program preset recording setting script and a program-associated information script in the preset recording mode and the on-air mode, can write the URLs to be listed in the URL list area 20b as demanded from the program-associated information providing server 206.

For example, if the program-associated information providing server 206 is operated by an organization performing sale business and this organization wants to provide predetermined products to users via the terminal apparatus 2, the products can be advertised by paying the fee to the program-associated information providing apparatus 203 to have it list the URLs in the URL list area 20b indicative of the locations of the information about these products. Since these products are strongly associated with programs in which they are advertised, the possibility for the user viewing the programs to begin to take an interest in these products significantly increases.

Since the program-associated information providing apparatus 203 manages the user information, strategic advertisements can be published for a particular patron base targeted by the program-associated information providing server 206. The program-associated information providing apparatus 203 can collect the advertisement rate derived from the URL placement from the program-associated information providing server 206 and allot the collected fee the operating fund of the program-associated information providing system 201 to discount or make free of charge the system usage fee to be paid by the terminal apparatus 2, thereby increasing the number of subscribers of the terminal apparatus 2 to the program-associated information providing system 201, which in turn enhances the advertisement effects by the program-associated information providing server 206.

On the other hand, if the user finds a desired product in a URL displayed by the program-associated information providing apparatus 203 via the network 207, the user can easily follow the buying procedure directly with the program-associated information providing server 206 by accessing the URL.

It should be noted that, if a program broadcast from the broadcast station 202 is a hit program and many users are viewing this program realtime, the number of accesses to the URL providing the program-associated information of that program extremely increases, thereby sometimes making the network 207 congested. If the network congestion can be predicted as with the above-mentioned case, the congestion can be avoided by attaching a comment specifying different access times for different users to each URL indicative of the location of the program-associated information to be displayed in the program-associated information display browser, thereby prompting each user to access that URL at the specified time.

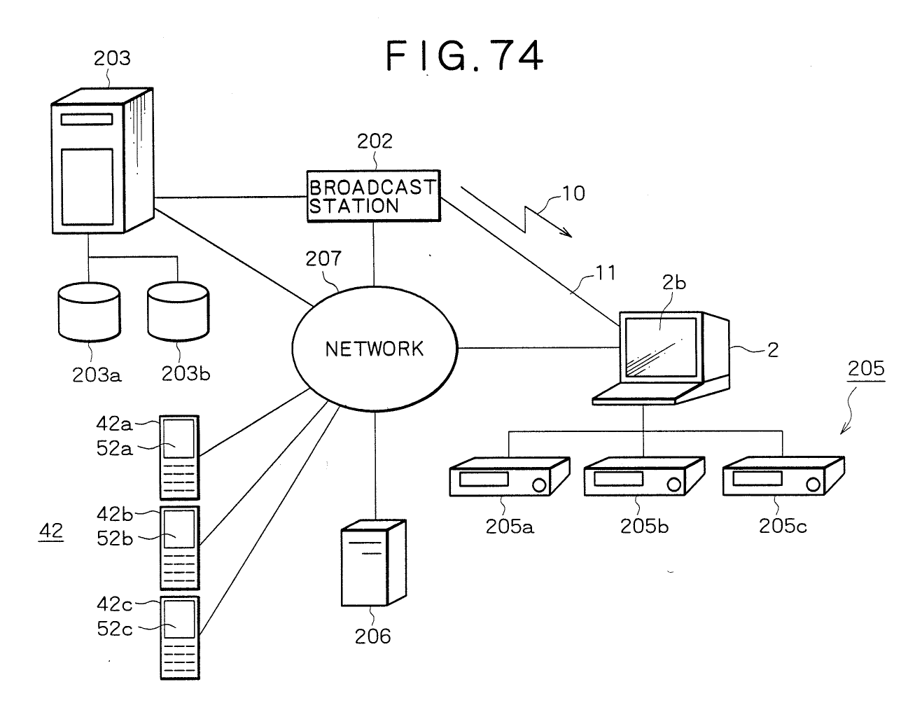

As described, in the program-associated information providing system 201, the program-associated information providing apparatus 203 generates a program preset recording setting script upon request by the terminal apparatus 2 in the preset recording mode and transmits the generated script to the terminal apparatus 2 to perform the setting of preset recording. Also, the program-associated information providing apparatus 203 may generate a program preset recording setting script upon request from any of the mobile terminal apparatuses 42a, 42b, and 42c connected to the network 207 in the program-associated information providing system 201 as shown in FIG. 74 and transmit via the network 207 the generated script to the terminal apparatus 2 for preset recording setting.

In the system configuration shown in FIG. 74, a program preset recording setting script is generated in the same manner as described with reference to FIGS. 28 through 68.

As described and according to the invention, there is provided a server operational expenses collecting method for a server which transmits via the Internet an electronic program guide to a terminal apparatus operated by a user, the above-mentioned server generating customer analysis information on the basis of personal information of the user inputted from the terminal apparatus and program viewing log information about a program viewed by the user on the terminal apparatus; generating a second electronic program guide by reorganizing a first electronic program guide in accordance with the preference of the user on the basis of the generated customer analysis information; providing the generated customer analysis information to an advertiser who practices an advertising campaign to the terminal apparatus; and in response to the provision of the customer analysis information to the advertiser, collecting the expenses, in a predetermined amount, for the provision of the customer analysis information from the advertiser. Consequently, the novel constitution can provide new services associated with the electronic program guide by the server and obtain server operating expenses.

As described and according to the invention, there is provided a server operational expenses collecting method for a server which transmits via the Internet an electronic program guide to a terminal apparatus operated by a user, the above-mentioned server generating a second electronic program guide by reorganizing a first electronic program guide in accordance with the preference of the user; generating a third electronic program guide obtained by inserting an advertisement program into the second electronic program guide; in response to a command issued by the user from the terminal apparatus via the Internet, transmitting one of the second electronic program guide and the third electronic program guide; and collecting an advertisement program insertion reject charge in a predetermined amount in accordance with the rejection of inserting the advertisement program from the user who requested the reception of the second electronic program guide. Consequently, the novel constitution can provide new services associated with the electronic program guide by the server and obtain server operating expenses.

As described and according to the invention, there is provided a server operational expenses collecting method for a server which transmits via the Internet an electronic program guide to a terminal apparatus operated by a user, the above-mentioned server generating a second electronic program guide by reorganizing a first electronic program guide in accordance with the preference of the user; setting preset recording of a program listed in the second electronic program guide to the terminal apparatus via the Internet; and in accordance with the setting of preset recording of the program, collecting preset recording setting expenses in a predetermined amount from the user. Consequently, the novel constitution can provide new services associated with the electronic program guide by the server and obtain server operating expenses.

As described and according to the invention, there is provided a server operational expenses collecting method for a server which transmits via the Internet an electronic program guide to a terminal apparatus operated by a user, the above-mentioned server generating a second electronic program guide by reorganizing a first electronic program guide in accordance with the preference of the user; generating a third electronic program guide obtained by inserting an advertisement program into the generated second electronic program guide; in response to a command issued by the user from the terminal apparatus via the Internet, setting preset recording of a program listed in one of the second electronic program guide and the third electronic program guide; and collecting an advertisement program insertion reject charge in a predetermined amount in accordance with the rejection of inserting the advertisement program from the user who requested the setting of preset recording of the program listed in the second electronic program guide. Consequently, the novel constitution can provide new services associated with the electronic program guide by the server and obtain server operating expenses.

As described and according to the invention, there is provided a server operational expenses collecting method for a server which transmits via the Internet an electronic program guide to a mobile terminal apparatus operated by a user wherein: the above-mentioned user sets via the Internet the preset recording of a program listed in the electronic program guide from the mobile terminal to a remote terminal apparatus; and the above-mentioned server, in response to the setting of preset recording of the program, collects a predetermined preset recording setting fee from the user. Consequently, the novel constitution can provide new services associated with the electronic program guide by the server and obtain server operating expenses.

As described and according to the invention, there is provided a server operational expenses collecting method for a server which transmits via the Internet an electronic program guide to a mobile terminal apparatus operated by a user, the above-mentioned server generating a second electronic program guide by inserting an advertisement program into a first electronic program guide; in response to a command issued by the user from the mobile terminal apparatus via the Internet, setting the preset recording of a program listed in one of the first electronic program guide and the second electronic program guide to a terminal apparatus; and collecting an advertisement program insertion reject charge in a predetermined amount in accordance with the rejection of inserting the advertisement program from the user who requested the setting of preset recording of the program listed in the first electronic program guide. Consequently, the novel constitution can provide new services associated with the electronic program guide by the server and obtain server operating expenses.

As described and according to the invention, there is provided a server operational expenses collecting method for a server which transmits via the Internet an electronic program guide to a mobile terminal apparatus operated by a user, the above-mentioned server generating a second electronic program guide by reorganizing a first electronic program guide in accordance with the preference of the user; generating a third electronic program guide by inserting an advertisement program into the generated second electronic program guide; in response to a command issued by the user from the mobile terminal apparatus via the Internet, setting the preset recording of a program listed in one of the second electronic program guide and the third electronic program guide to a terminal apparatus; and collecting an advertisement program insertion reject charge in a predetermined amount in accordance with the rejection of inserting the advertisement program from the user who requested the setting of preset recording of the program listed in the second electronic program guide. Consequently, the novel constitution can provide new services associated with the electronic program guide by the server and obtain server operating expenses.

As described and according to the invention, there is provided a server operational expenses collecting method for a server which transmits via the Internet an electronic program guide to a terminal apparatus operated by a user, the above-mentioned server, in response to displaying an address indicative of a location on the Internet of program-associated information, which is information associated with a program listed in the electronic program guide, collecting a predetermined address placement fee from an advertiser who provides the program-associated information and practices an advertisement campaign to the terminal apparatus. Consequently, the novel constitution can provide new services associated with the electronic program guide by the server and obtain server operating expenses.

While the preferred embodiments of the present invention have been described using specific terms, such description is for illustrative purposes only, and it is to be understood that changes and variations may be made without departing from the spirit or scope of the appended claims.

1.-2. (canceled)

3. A server operational expenses collecting method for a server which transmits via the Internet an electronic program guide to a terminal apparatus operated by a user, said server
generating a second electronic program guide by reorganizing a first electronic program guide in accordance with the preference of said user;
setting preset recording of a program listed in said second electronic program guide to said terminal apparatus via the Internet; and
in accordance with the setting of preset recording of said program, collecting preset recording setting expenses in a predetermined amount from said user.

4. (canceled)

5. A server operational expenses collecting method for a server which transmits via the Internet an electronic program guide to a mobile terminal apparatus operated by a user,
said user setting via the Internet the preset recording of a program listed in said electronic program guide from said mobile terminal to a remote terminal apparatus; and
said server, in response to the setting of preset recording of said program, collecting a predetermined preset recording setting fee from said user.

6.-7. (canceled)

8. A server operational expenses collecting method for a server which transmits via the Internet an electronic program guide to a terminal apparatus operated by a user, said server
in response to displaying an address indicative of a location on the Internet of program-associated information, which is information associated with a program listed in said electronic program guide, collecting a predetermined address placement fee from an advertiser who provides said program-associated information and practices an advertisement campaign to said terminal apparatus.

9.-10. (canceled)

11. A server operational expenses collecting apparatus for a server which transmits via the Internet an electronic program guide to a terminal apparatus operated by a user, said server
generating a second electronic program guide by reorganizing a first electronic program guide in accordance with the preference of said user;
setting preset recording of a program listed in said second electronic program guide to said terminal apparatus via the Internet; and
in accordance with the setting of preset recording of said program, collecting preset recording setting expenses in a predetermined amount from said user.

12. (canceled)

13. A server operational expenses collecting apparatus for a server which transmits via the Internet an electronic program guide to a mobile terminal apparatus operated by a user,
said user setting via the Internet the preset recording of a program listed in said electronic program guide from said mobile terminal to a remote terminal apparatus; and
said server, in response to the setting of preset recording of said program, collecting a predetermined preset recording setting fee from said user.

14.-15. (canceled)

16. A server operational expenses collecting apparatus for a server which transmits via the Internet an electronic program guide to a terminal apparatus operated by a user, said server
in response to displaying an address indicative of a location on the Internet of program-associated information, which is information associated with a program listed in said electronic program guide, collecting a predetermined address placement fee from an advertiser who provides said program-associated information and practices an advertisement campaign to said terminal apparatus.
